(19) United States
(12) Patent Application Publication
(10) Pub. No.: US 2003/0129574 A1
(43) Pub. Date: Jul. 10, 2003

(54) System, apparatus and method for maximizing effectiveness and efficiency of learning, retaining and retrieving knowledge and skills

(75) Inventors: Gabriel Ferriol, Tokyo (JP); Nicolas Schweighofer, Tokyo (JP); Andrew Smith Lewis, Tokyo (JP)

Correspondence Address: Joseph R. Keating, Esq., 1733-A South Hayes Street, Arlington, VA, 22202, US

(73) Assignee: Cerego LLC,, Tokyo (JP)

(21) Appl. No.: 10/012,521

(22) Filed: Dec. 12, 2001

Related U.S. Application Data
(63) Continuation-in-part of application No. 09/475,496, filed on Dec. 30, 1999.

(51) Int. Cl. G09B 7/00

(52) U.S. Cl. 434/362; 434/323; 434/118; 434/169

(57) ABSTRACT

A system, method and apparatus for maximizing the effectiveness and efficiency of learning, retaining and retrieving knowledge and skills includes a learning engine that includes a novel model of human learning that adaptively determines a memory indicator for each item to be learned for each user during all phases of learning, including a short active phase of learning in which items are actively recalled and a long passive phase of learning in which items are passively forgotten. The memory indicator is determined based on a user's actual memory performance during the short-term active phase of learning and is accurately predicted based on mathematical modeling during the long-term passive phase of learning. The learning model makes use of a target level and an alert level of memory performance for each item of information for each user and the learning engine schedules presentation of items for review or study based on the user's performance with respect to the target and alert levels. The learning engine operates to present to the user items to be learned by the user when a memory indicator value for an item is equal to or below the alert level and stops presenting items to the user when the memory indicator for that item is equal to or greater than the target level for that item.

This is a Continuation-in-Part Application of U.S. patent application Ser. No. 09/475,496 filed on Dec. 30, 1999, currently pending.

### BACKGROUND OF THE INVENTION

1. Field of the Invention

The present invention relates to a system, apparatus and method for learning, and more specifically, relates to a system, apparatus and method for interactively and adaptively maximizing the effectiveness and efficiency of learning, retaining and retrieving knowledge and skills including accurately determining a memory indicator for knowledge and skills being learned during all phases of learning and controlling when learning and reviewing of knowledge and skills optimally begins and ends based on the memory indicator.

2. Description of the Related Art

Previous systems and methods for learning have focused on presenting an item or items to be learned in a paired-associate format, such as a cue and response system. These prior art systems and methods have relied heavily on the motivation and metacognitive skills of the student and therefore, have varying degrees of effectiveness and efficiency. More importantly, such prior art methods and systems have very limited success in terms of a student actually acquiring knowledge or skills rapidly, ensuring that the student maintains the knowledge and skills to a high degree of retention for an extended period of time, and enabling the student to retrieve knowledge and skills automatically at some future date.

In a well known prior art method, a paired-associate learning method is embodied in a group of flashcards which may be presented manually or electronically via a computer, for example. In a typical example of such a method, a student starts by separating flashcards into two groups: known and unknown. The student studies each unknown flashcard by first viewing the question on one side of the flashcard and then formulating a response to the question. The student then turns the card over and views the answer provided. The student judges the adequacy of his response by comparing his answer to the correct answer. If the student believes he has learned or “knows” the paired-associate, that flashcard is placed in the group of known items. When the student has studied all of the flashcards in the first unknown group, and all of the flashcards have been transferred to the group of known flashcards, the student may review the group of known items in the same manner as described above. In an alternative method, the cards can be shuffled for learning. Thus, in this method, the learning and review is performed by a student simply looking at flashcards to determine correct responses and reviewing the flashcards as desired, with no fixed schedule or sequence.

In another method invented by B. F. Skinner, a method of learning and reviewing is provided. More specifically, Skinner discloses a machine which presents a number of paired-associate questions and answers. The learning machine has an area for providing questions, and an area where the user writes in an answer to these questions. At the time the question is presented, the correct answer is not visible. A student reads a question and then writes in an answer in the area provided. The user turns a handle that causes a clear plastic shield to cover his answer while revealing the correct answer. The user judges the adequacy of his response. If the user judges that his answer is adequate, he slides a lever that punches a hole in the question and answer sheet and turns a handle revealing the next question. If the answer is judged to be inadequate, the user simply turns a handle revealing the next question. After all of the questions have been answered a first time, the user can make a second pass through the questions and answers. The machine operates such that only the questions that were answered incorrectly in the first pass are viewable during the second pass so as to provide a review of questions that were answered incorrectly. Thus, this conventional method provides a crude method of enabling review of missed questions.

A slightly more advanced method was invented by Sebastian Leitner and described in “So Lernt Man Lernen.” The method involves studying flashcards as in the method described above, but in addition, involves using a specially constructed box to calculate review schedules. More specifically, the box has five compartments increasing in depth from the first compartment to the fifth compartment. According to Leitner's method, a student takes enough “unknown” flashcards to fill the first compartment and places them in the first compartment. The student begins by taking the first card out of the box and reading the question. The student then constructs an answer and compares it to the correct answer on the back of the card. If the student is correct, the student places the flashcard in the second compartment. If the student cannot construct an answer, or if the student's answer is incorrect, the student places the flashcard at the back of the group of cards in the first compartment. This process continues until all of the cards have been moved to the second compartment and the student stops the learning session. The next learning session begins by placing new “unknown” cards into the first compartment. The process of studying and sorting is performed as described above until once again, no cards remain in the first compartment. At some future date, the second compartment will be full of cards placed there during previous learning sessions. At that time, the student begins to study the cards in the second compartment, except this time, known cards are placed into the third compartment and unknown cards are placed backed into the first compartment. New cards are continually introduced into the first compartment and are moved through the compartments as they are learned and reviewed. Cards that are easily remembered or known are moved from the more shallow compartments to the deeper compartments and therefore are reviewed less and less frequently. Cards that are more difficult to learn are put back into the more shallow compartments for more frequent review. This method provides a crude form of scheduled review of learned items based on item difficulty.

A computer-based version of Leitner's method is provided in the German language computer software program entitled Lernkartei PC 7.0 and in the Spanish language computer software entitled ALICE (Automatic Learning In a Computerized Environment) 1.0. With ALICE 1.0, question and answer units are presented to a user and the number of cards and interval of time between study sessions are distributed to adapt to a user's work habits.

Other conventional methods have recognized the importance of developing a system to present items for review. For example, a computer program developed by Piotr Wozniak in Poland and referred to as “SuperMemo” uses a mathematical model of the decline of memory traces to determine spacing of repetitions to maintain long-term retention of paired-associates.

In another prior art method described in U.S. Pat. Nos. 5,545,044, 5,437,553 and 5,577,919 issued to Collins et al., paired-associates are presented to a user for learning. However, unlike the conventional methods described above, in this invention, the user is first queried as to whether a particular item is perceived to be known or unknown, not whether the user actually knows the item, or knows the correct answer to a question. That is, a user is asked to determine whether they think they know the correct response to the cue, not what the correct response actually is. Then, a sequence of perceived known items and perceived unknown items is generated and presented to the user in the form of cue and response for learning. Similar to the first conventional method described above, the question of the perceived known or unknown items is presented to a user, the user constructs a response to the presented cue and then compares the constructed response to the correct response.

The prior art methods described above have generally proven to be only marginally effective for learning, retaining and retrieving knowledge and skills. The prior art methods often require a user to schedule and manage the learn, review and test processes which consequently consumes a portion of the cognitive workload of the user thereby reducing efficiency of learning, retaining and retrieving knowledge and skills. The cognitive workload is the amount of mental work that an organism, such as a human, can produce in a specified time period. By diverting some of the cognitive workload away from learning, the organism is distracted from learning and cannot devote all of the available cognitive resources to learning.

Furthermore, because the user is making subjective judgments of perceived knowledge, they provide feedback to the method that is distorted by certain cognitive illusions inherent in self-paced study. These subjective inputs result in less effective learning than would otherwise be possible. Furthermore, even though some of the prior art methods monitor progress of learning or reviewing or testing, future learning or reviewing or testing are not modified based on a student's actual performance results.

In addition, most prior art methods seek to train or teach knowledge or skills only to a level of recall in which a person or organism must expend significant cognitive effort to attempt to remember an item previously learned. Conventional methods have not been successful in training or teaching knowledge or skills to a level of automaticity in which performance is characterized by an extremely rapid response without conscious effort or attention.

Also, there are many different theories, scientific principles, and concepts relating to learning, memory and performance that seek to explain how humans and other organisms are able to encode, store and retrieve knowledge and skills. Although these theories, principles and concepts have been studied, they have not been quantitatively measured and applied in a synergistic and effective manner to improve learning, reviewing and retrieving knowledge and skills. Furthermore, the prior art methods do not train a student to become a better learner by monitoring and improving their metacognitive skills, but merely provide a marginal improvement in the ability to encode and recall learned items.

In other more recent inventions, an attempt has been made to adaptively control the learning process based on various factors including a student's performance such as how quickly the student learns new items and how well a student performs on test questions. While these methods may provide a schedule of review for items that were previously learned, the schedules are usually not adaptive to the user and are instead, usually based on some predetermined curriculum and progress expectation guidelines or other fixed schedule. These methods do not take into account the memory strength of each item being learned during all phases of learning, especially during the passive phase of learning, described in more detail below, and do not accurately determine an estimation of memory strength for each item that has been learned or reviewed previously, during all phases of learning. Thus, these methods are nothing more than very imprecise attempts at adapting learning and reviewing processes based on the performance of a user because the user's performance is never evaluated nor determined at the item level, which results in great inefficiencies in learning, as well as causing boredom and/or frustration for the student at various times during the learning process.

With these previous methods, a student is often required to learn or review an item many, many times during a single study period. This is done based on the expectation that if the student knows an item to a high degree of certainty at one time, the student is less likely to forget that item or will forget that item more slowly. However, such methods do not take into account the fact that since the same item is presented to the student many, many times in a single study session in order to learn an item to the desired high degree of certainty, the student is likely to be extremely bored reviewing the same item over and over again, thereby decreasing the effectiveness of learning. Also, many previous methods attempt to schedule the learning of new items or review of previously learned items on the basis of where in a particular lesson the student should be, which is determined based on performance of the user measured by a correct answer or based on some previously determined schedule. This often results in the student not learning or reviewing the item or group of items that is most in need of presentation to the student, thereby further exacerbating the inefficiency and ineffectiveness of the learning process.

Furthermore, the course material that is presented using these methods has not been specifically adapted and organized according to the particular features of the method of learning. In addition, there is no effective method for adaptively and optimally scheduling review of items that have been learned and need to be reviewed while also introducing new items to be learned, such that the time spent learning or reviewing items is used in the most effective and efficient way possible. That is, previous methods have failed to determine what item or items are most in need of study or review, and have not accurately adapted to a user to enable the user to learn the most in the shortest period of time and to be able to retain what is learned over the longest period of time.

In addition to the problems described above, the prior art methods all fail to adequately address and overcome the four most significant problems with traditional learning: (1) lack of control of memory strength for each item during the active learning process which causes the learning process to be stopped based on imprecise metacognitive judgments; (2) lack of control when reviews of items are presented to the user because there is no control of the minimum memory strength for each item before a review is needed for an item; (3) lack of control of time required to reach a goal level of learning and the speed with which the goal level of learning is reached; and (4) lack of control of end points of learning to ensure that a desired level of learning has been achieved.

### SUMMARY OF THE INVENTION

To overcome the problems described above and to provide other significant and previously unattainable advantages, preferred embodiments of the present invention provide a system including various apparatuses and methods for maximizing the effectiveness and efficiency of learning, reviewing and retrieving knowledge and skills in an interactive and adaptive matter based on a unique model of human learning that is applied in a novel way to achieve accurate control of memory performance for each item during the short-term phase of learning, provide optimal schedule of reviews of each item based on a minimum level of learning or retention while preventing a user from going below a minimum level of memory performance for each item, accurately control the time required to reach a goal level of learning and the speed with which the goal level of learning is reached, and achieve accurate control of the end points of learning to achieve permastore for each item while avoiding unnecessary reviews and so as to further optimize the efficiency and effectiveness of the learning process.

In addition, preferred embodiments of the present invention provide a system in which items to be learned or reviewed, including knowledge and skills, are preferably presented in a paired associate format including a cue and response, and are presented to the user based on a current memory indicator that is determined for each item during all phases of learning including the short-term active phase and the long-term passive phase, described in more detail below, and preferably other factors. That is, items that were never studied before and items that were studied before will be introduced together in an optimal manner based on the determined current memory indicator for each item and in a manner that achieves the advantages described in the preceding paragraph.

In a specific preferred embodiment of the present invention, a method of presenting items to be learned or reviewed to a user includes the steps of presenting an item to a user, determining a value of a memory indicator for the item being presented to the user, stopping the presenting of the item to the user after a certain value of the memory indicator has been reached, determining a value of the memory indicator during the period in which the item is not being presented to the user, and determining when to present the item to the user again based on the value of the memory indicator that was determined during the period in which the item is not being presented to the user.

The step of determining a value of the memory indicator for the item being presented to the user is preferably performed based on a measurement of the user's performance with respect to that item. More preferably, the user's performance that is used to determine a value for the memory indicator may preferably include one or more of the following the result on a recall test, latency values on the recall test, and the result on a confirmation test and other suitable measurements, or a suitable combination thereof.

In preferred embodiments of the present invention, the memory indicator is based on a unique model of human learning developed by the applicants, and preferably ranges from a value of 0 to 1. The human learning model, described in more detail below, was developed in recognition of the need to accurately determine an estimation of memory strength for each item of information that an individual wants to know or retain in memory. For each item to be learned, the memory strength is the strength of the relationship between the cue and the response and is a function of the number of attended presentations. Consequently, to increase memory strength, items need to be presented in an attended fashion. Yet, it is difficult to know when to optimally present items so that memory strength increases and the user does not waste any time during the learning process. Unfortunately, it is not possible to precisely determine an actual memory strength for each item at any time without actually taking a measurement of the memory performance. Thus, a model of the human learning had to be developed to accurately determine an indication of the memory strength for each item of information being learned at times when measurements of memory strength cannot be taken.

However, such a human learning model had to take into account the fact that learning occurs in two phases. There is a short-term phase of learning in which a person is actively learning by studying, rehearsing, recalling, testing or thinking, etc. about an item one or more times during a relatively short period of time. This period is referred to as the short-term phase of learning or the active phase of learning. After the active phase of learning stops, the brain slowly begins to forget items that were previously learned and the actual memory strength in the brain for the items previously learned begins to decay over time, such as several hours, days, months, etc. This is referred to as the long-term phase of learning or the passive phase of learning. As noted above, the actual amount of decay in memory strength over time for each item cannot be actually measured.

However, the applicants determined that the memory decay can be accurately modeled using a power function or other mathematical modeling function. It is preferable that a power function be used as this has been determined to be the most accurate model of memory decay.

Since it is not possible to precisely determine memory strength for an item, measures of performance can be used to accurately reflect memory strength. For example, as described in preferred embodiments herein, measures of memory performance such as latency of recall, probability of recall and savings in relearning, test results, and other factors, alone or in combination, can be used to indicate a memory strength for an item. This representation of memory performance based on these factors is referred to hereinafter as a “memory indicator”.

It is possible to measure such memory performance only during the short-term active phase of learning. It is not possible to actively measure memory performance during the long-term passive phase of learning. Thus, prior to the development of the present invention, it was not possible to know what the memory indicator was for each item at any given time during both the active short-term phase of learning and the passive long-term phase of learning. Therefore, even with other methods that sought to accurately determine a memory indicator, this was only done during the active short-term phase of learning.

Based on the novel model of the human learning developed by the applicants, an accurate memory indicator can be determined both during the short-term active phase of learning and during the long-term passive phase of learning. This is done by measuring an actual memory performance for each item during the short-term active phase of learning and during the passive long-term phase of learning mathematically modeling the decline of memory in the brain for each item using a predictive algorithm that models the long-term passive phase of learning when the brain is forgetting an item and the memory strength for an item is declining in the brain.

More specifically, the novel human learning model developed by the applicants determines a value for the memory indicator during both the short-term active phase of learning and during the long-term passive phase of learning. This estimation is used so that at any given time, the memory indicator is constrained to be between two thresholds that are defined by a target level and an alert level of memory indicator.

The alert level is the highest minimum value before studying and the target level is the lower maximum value after studying. Thus, the target and alert levels operate such that when performance is lower than threshold memory indicator level, the learning engine or process operates to increase the memory performance, and when the performance is higher than another threshold memory indicator level, the learning engine or process operates to stop increasing memory performance.

The learning model operates using the target and alert levels and measures memory indicator during the short-term, active phase of learning and predicts memory indicator during the long-term, passive phase of learning, and then uses an error-correction feedback loop that compares predicted memory indicator to a determined actual memory indicator to ensure that future predictions of memory indicator are much more accurate for each user and each item of information being learned by the user.

Thus, based on this unique learning model, the method according to the preferred embodiment described above preferably further includes the step of determining an alert level of memory indicator and a target level of memory indicator for each item of information to be learned and for each user. The alert level is the highest minimum value before studying and the target level is the lower maximum value after studying.

The step of presenting the item to a user begins when the memory indicator for that item is determined to be equal to or less than the alert level and the step of stopping the presenting of the item to the user begins when the memory indicator for that item is determined to be equal to or greater than the target level.

In addition, the method described above preferably includes the step of measuring performance of the user to determine a value of the memory indicator during an active phase of learning and predicting a value of the memory indicator during a passive phase of learning. As noted above, the user performance that is measured to determine a value of the memory indicator may preferably include one or more of the following: latency of recall, probability of recall and savings in relearning, test results, metacognitive measurements including measurements which indicate how a user feels about each item or group of items, how the user feels about the short term learning phase and/or the long term forgetting phase, and other factors, used alone or in combination.

The step of predicting the value of the memory indictor during the passive phase of learning is preferably determined using a mathematical model such as a power function, an exponential function, any negatively accelerated function or other suitable predictive function. In the present preferred embodiment, the power function is preferably used.

Further, the method described above preferably includes the step of gradually increasing the target level and the alert level over time. The values resulting from the changes in the target level and alert level occurring over time preferably form respective curves that may be substantially parallel to each other when graphically represented. Alternatively, these target and alert curves may be arranged to be non-parallel with respect to each other or may be partially parallel for a certain period of time and non-parallel for another period of time. Furthermore, the shape of such curves representing the target level and the alert level over time are preferably determined based upon one or more of the following factors: the goal of learning based on a measurement of probability of recognition or probability of recall or other suitable factor, the difficulty of learning as determined by the time required to increase the value of the memory indicator from 0 to a minimum target value or by any other suitable method for determining item difficulty, time required to reach a goal which is also referred to as the study period, and metacognitive judgments made by the user such as a judgment of learning, or any combination thereof.

Also, the method preferably includes the step of adapting the target level and the alert level to the user and to each item of information to be learned by the user.

The step of predicting the memory indicator also preferably includes the step of determining an error between the predicted value of the memory indicator and a determined value of the memory indicator, and then correcting for the error determined based on the difference between the values of the predicted memory indicator and determined memory indicator.

There are several possible mathematical algorithms that may be used to determine the measure of the memory indicator. These mathematical algorithms will be described in more detail below. In addition, the error correction of the predicted memory indicator can be done using many different mathematical algorithms described in more details below. The error correction process can be performed based on differences between current and previous values of the memory indicator as measured by the learning method, as well as differences between time when an item is presented for the first time (birth time), the time when an item was last presented and the current time when an item is being presented. Other parameters, variables and factors may also be used to determine the error in the measured memory indicator and to correct for such error. The error correction method is based on well known adaptation methods such as the gradient descent method, the Newton method or any other suitable adaptation method.

By using the target and alert levels to determine when to start and stop studying or reviewing of items to be learned, an automatic graceful degradation feature is achieved since the user can start and stop studying or reviewing at any time, without any negative effects. This is due to the fact that each time an item is selected, a memory indicator is calculated for each item and only the most urgent item is presented to the user.

In addition to the automatic graceful degradation feature, the method of learning according to preferred embodiments of the present invention achieves workload smoothing since presentation of items is based on the schedule of reviews for each item and the user specific speed of learning, as described in more detail below.

It is also preferred that a judgment of learning is used to predict an initial value of the forgetting curve or rate of decay of human memory when predicting the initial decay amount during the long-term passive phase of learning. It is also more preferable that a delayed judgment of learning is used for this initial value of the decay rate. Other methods for initializing the first decay rate may include using a fixed initialization parameter that has been predetermined to be effective for the adaptation process, using the measure of item difficulty based on the amount of time required to move from a value of 0 of the memory indicator to some desired value or any other method to determine the measurement of item difficulty, and using a statistical linear model based on analysis of previous user data. Other suitable methods for initializing the first decay rate may also be used.

The method described above preferably is performed using any learning systems or learning engines such as those described in others of the preferred embodiments below.

In addition, in the method according to the preferred embodiment described above, new items to be presented for the first time to a user adaptively are chosen based on a unique selection and presentation process to eliminate minimum and maximum peaks of item presentations to achieve workload smoothing and optimum learning efficiency and effectiveness.

The unique method for determining which items to present to a user preferably includes the steps of grouping items in a course into lessons based on at least one of common semantical properties, likelihood of confusion and other suitable factors, dividing lessons into selections that include a smaller subset of items from a lesson, determining an appropriate session pool size of items to be presented to a user, selecting a size of a session pool that is defined as a maximum number of items to be presented to a user during a single study session, determining an urgency of presentation of each item based on a current memory indicator, and selecting the items for the session pool based on the determined urgency of each item.

Users are first presented with a preview of items that have never been presented and are scheduled to be learned in order to provide the users with an overview of what they will learn, to become familiar with what they are about to learn, and to determine similarities and differences. In addition, the user is asked whether the user already knows an item or does not want to study an item to avoid wasted study time and to prevent the user from becoming bored. However, in order to ensure that the user does in fact know the items the user has indicated as being already known, these items become “magic” items in that they are not scheduled for study but are only scheduled for test in order to make sure that the user actually knows the item that has been indicated as being known. Magic items are assigned a memory indicator value at the target level before they are scheduled for review each time their memory indicator falls below the alert level. Magic items cannot be used as items to be studied since the user has already indicated that they are known.

The magic items are assigned a very low decay rate and are not rated in a judgment of learning test. If the user misses a test of a magic item that was indicated as being already known, the item is no longer a magic item and the memory indicator for that item is reduced below an alert level so that the user must study and review that item as if it were a normal item of average difficulty.

The above description relates to a single item and how that single item is presented to the user. Although the above-described steps achieve an optimal presentation for one particular item in a study session, in order to achieve a desired expanded rehearsal series and to optimize the efficiency of learning over time, a plurality of items are grouped together and presented to the user in order to achieve more efficient review of items.

The method and learning engine according to preferred embodiments of the present invention present items in small groups because items from the same lesson should be reviewed together, the user may not have enough time to review all items in a lesson, a user has time constraints that must be accommodated, and the review schedule is much more effective for learning when small groups of items are presented because with small groups of items, the most difficult items have more opportunities to be presented to the user.

Thus, a process for grouping items together for presentation must be performed. In the present preferred embodiment, items are arranged in session pools, which are small groups of items from the same lesson. It is noted that grouping items to be presented to the user in a session pool having a size that is less than the size of a lesson provides a much more effective review schedule. Thus, depending on the size of a lesson and the number of items to be reviewed in a lesson, out of one lesson, zero, one or more session pools can be created as described in more detail below. The session pools are presented to the user sequentially during a study session.

In order to create session pools from a lesson, the urgency of presentation of each item in a lesson is preferably computed. It is preferable that the step of determining the urgency of presentation of each item is based on any combination of the alert level, the memory indicator and a derivative of the memory indicator or any suitable parameter. For example, the step of determining urgency may be performed by determining the difference between an alert level and the current memory indicator for each item. Alternatively, the urgency may be determined by taking an average, a median, standard deviation of the urgency values for the items in each lesson.

Once the urgency for each item in a lesson to be reviewed has been computed, items from a lesson compete with each other to be grouped in a session pool. This competition between items is based on the urgency of the items in a lesson for being grouped into a session pool. Thus, the items from a lesson are grouped together into session pools according the respective urgency of each item. After session pools are determined, the session pools are ranked according to the summed urgency of all of the items in the respective session pool, and the session pool having the highest summed value of urgency is preferably selected to be presented to the user next.

It is preferable to compute item urgency and have items compete with each other for presentation at the session pool level based on the computed urgency. This is because a user can stop using the learning engine or method at any time, and therefore, the user may not see all of the items that were scheduled to be presented to the user at a given time. Thus, in such cases, the learning method and engine of the present preferred embodiment of the present invention determines which lessons are most in need of presentation to the user and presents the most urgent lessons to the user based on ranking of the summed urgencies for each lesson.

In order to optimally schedule the presentation of all of the items in a session to the user, the method further comprises the steps of presenting to the user the items in the session pool repeatedly during a session loop until preferably all of the following conditions have been met: (1) the memory indicator for all items in the session pool are above the corresponding alert level; (2) progress achieved as measured by a sum of relative increase in the value of memory performance compared to the item target level for all items; and (3) a difficulty measure based on the time required to increase the memory indicator for each item to the target level was achieved for all items in the session pool. This method also preferably could include the steps of presenting the user with a test once the three conditions described above have been met and preventing a user from being presented with a subsequent session pool of items until the user achieves a perfect score on the test.

In addition, the preferred process of selecting and presenting items described above preferably follows the following rules: (1) items are presented in a manner to achieve an adaptive intra-trial spacing effect pattern; (2) do not present items which reach their respective target level; (3) present a small number of items during any study period; and (4) present items in an unpredictable manner to achieve sufficient attention and interest of the user.

After a session has been completed, the user is preferably asked to provide a judgment of learning for each of the items that was introduced during the most recent session. The judgment of learning assessment is preferably done by the user rating the difficulty of the items on a graduated scale. The values for judgment of learning are used to determine the decay of memory performance in the future.

It is preferable that the presentation of items to the user can occur in two modes including a study presentation when the user is unlikely to recall an item (when memory indicator is 0) and a recall presentation when the user is likely to recall (when memory indicator is greater than 0).

During the study presentation, the presentation of the item may also include the presentation of additional information including but not limited to audio hints and contexualization that includes information related to the item to be learned, so as to gradually increase the memory indicator from 0 to a strictly positive value that will ensure that a recall presentation for that item will be generated in the future. This additional information will assist the user in increasing the memory strength for an item so that the user will be able to actively recall the item in the future. It should be noted that the additional information such as audio hints and contexualization may also be presented during the recall presentation mode.

The study presentation is preferably presented to the user for as long as the user desires and until the user indicates that the item has been learned and the user is able to actively recall the item.

Once the user indicates an ability to recall the item, the memory indicator is higher than a value of 0 and the user is later provided with a recall presentation in which the cue for an item is shown and the user must indicate an ability to actively recall the response to the cue within a certain time period. If the user is not able to indicate an ability to recall the proper response for the cue, the user is able to study the item for an additional period of time until the user indicates an ability to actively recall the item.

In order to determine whether the user was actually able to recall an item, a confirmation test is preferably presented to the user to confirm that the user was in fact able to actively recall the item within the time provided. This confirmation test may be a multiple choice test, a jumble test or any other suitable test. These tests may be alternated to maintain the attention of the user and to prevent the user from becoming bored. When a recall presentation takes place, the information presented to the user can be the cue (direct recall) or the response (reverse recall). The confirmation test for a direct recall is preferably a recognition test. The confirmation test for a reverse recall is preferably a jumble test.

In addition, it is preferable to adapt the difficulty of the tests to the user's performance and present harder and harder tests based on the user's past performance. Also, it is preferable to adapt the difficulty of each test for each item. The degree of difficulty of a test may be increased by changing the number of possible responses in a multiple choice test, including many interfering or distracting answers in a multiple choice test, including a “none of the above” response in the test, putting time limits on tests, or other suitable ways of increasing the test difficulty.

Once the user has indicated an ability to actively recall an item within a certain time period, the next item to be learned is presented to the user, and the process described above is repeated.

In order to provide adequate feedback in the form of performance data and to determine the presentation of appropriate motivational and reward messages, the method described above preferably includes the step of recording a user's performance data and periodically providing performance reports and various motivational messages to the user. In addition, performance reports and data may also be provided to the user periodically or in response to the demand of the user.

According to another preferred embodiment of the present invention, a system includes various apparatuses and methods for maximizing the ease of use of the system and maximizing the results of learning, retaining and retrieving of knowledge and skills by allowing a user, administrator or other input information source to interactively and flexibly input information to be learned, identify confusable items to be learned, select desired levels of initial learning and final retention of knowledge or skills, and input preferences regarding scheduling of learning, reviewing and testing and other input information relating to the learning, reviewing and testing of knowledge or skills. Based on these and other input information, the system schedules operation of the learn, review and test operations in the most efficient way to guarantee that the user achieves the desired degree of learning within the desired time period.

Furthermore, preferred embodiments of the present invention provide a system including apparatuses and methods which include a Learn Module for presenting new knowledge or skills to a user, a Review Module for presenting previously learned knowledge or skills to a user in order to maintain a desired level of retention of the knowledge or skills learned previously, and a Test Module for testing of previously learned knowledge or skills. Each of the three modules are preferably adapted to interact with the other two modules and the future operation of each of the Learn, Review and Test modules and scheduling thereof can be based on previous performance in the three modules to maximize effectiveness and efficiency of operation.

The advantages achieved by basing the interaction and scheduling of the Learn, Review, and Test Modules on previous performance in the three modules include achieving much more effective and efficient combined and overall operation of each of the three main modules so that a user encodes, stores and retrieves knowledge and skills much more effectively and efficiently, while also becoming a better learner.

Also, preferred embodiments of the present invention provide a system including various methods and apparatuses which provide an extremely effective method of encoding, storing and retrieving knowledge or skills which are quantitatively based and interactively modified according to a plurality of scientific disciplines such as neuroscience (the scientific study of the nervous system and the cellular and molecular mechanisms associated with learning and memory), cognitive psychology (an approach to psychology that emphasizes internal mental processes), and behavioral psychology (an approach to psychology that emphasizes the actions or reactions produced in response to external or internal stimuli), as well as scientific principles including: active recall (the process whereby a student constructs a response to a presented cue as opposed to passive recall in which a student simply observes a cue and response paired presented), the alternative forced-choice method (a test of memory strength sensitive to the level of recognition in which a cue is presented followed by the correct response randomly arranged among several alternative choices called distracters, and in which the student must discriminate the correct response from the distracters), arousal (the student's experience of feeling more or less energetic which feeling is accompanied by physiological changes in perspiration, pupil diameter, respiration and other physiological reactions, and which influences information processing, in particular, the encoding and retrieval of information), attention (the ability or power to concentrate mentally by focusing on certain aspects of current experience to the exclusion of all others), automaticity (performance characterized by rapid response without conscious attention or effort), the auditory rehearsal loop (the process of rehearsal, usually via subvocal speech, to maintain verbal information in memory, in which the loop is capable of holding approximately 1.5 to 2.0 seconds worth of information), classical conditioning (the procedure in which an organism comes to display a conditioned response to a neutral conditioned stimulus that has been paired with a biologically significant unconditioned stimulus that evoked an unconditioned response), cognitive workload (the amount of mental work that a student produces or can produce in a specified time period), confidence (a subjective judgment made regarding the degree of certainty of the correctness of a constructed response or of a subjective evaluation), consolidation (the initial period of time in memory formation when information in a relatively transient state is transformed to a more permanent, retrievable state), consolidation period (the interval during which the transformation to the more permanent retrievable state occurs), contiguity (two items occurring or being presented close together in time), contingency (two items being presented or occurring in a manner such that the occurrence of one item increases the probability that another item will occur, which is required to form a conditioned association), discrimination (the act of distinguishing between two or more items by noting the differences between the two or more items), ease of learning (a metacognitive judgment made in advance of knowledge acquisition in the form of a prediction about what will be easy or difficult to learn), encoding specificity (the theory that memory performance is better when tested in the presence of the same cues that were present when the memory was formed), encoding variability (the theory that memory performance is better when multiple cues are available to generate a desired response), feeling of knowing (a metacognitive judgment made during or after knowledge or skill acquisition as to whether a given, currently non-recallable item is known or will be remembered on a subsequent retention test), generalization (when a response is evoked by a cue other than the one it was conditioned to), habituation (a decrease in response as a result of repeated exposed to a stimulus), instrumental conditioning (a situation in which a particular stimulus occurs and if an organism generates a response, then a particular reinforcer will occur), interference (a negative relationship between the learning of two sets of material), judgment of learning (a metacognitive judgment during or soon after knowledge acquisition which is a prediction about future test performance on currently recallable items), the labor-in-vain effect (in self-paced study, students make metacognitive judgments that determine the allocation of effort and often study beyond the point where any benefit is derived), latency of recall (a measure of time required to construct a response to a presented cue), learned helplessness (when a negative reinforcement is provided independent of a student's performance, the student behaves as though they have no control over their situation), long-term potentiation (when appropriate stimulation is provided to some areas of the brain, there is a long-term increase in the magnitude of the response of the cells to further stimulation), memory activation (the availability of an item in memory such that items which have been recalled recently have relatively higher activation than those that have not), memory strength (a property of memory which increases with repeated practice and is the degree to which a cue can activate a memory record), metacognition (the process of monitoring and controlling mental processes, particularly those associated with the acts of learning and retrieving), overlearning (learning that continues past the point where the student is first able to construct the correct response to a presented cue), paired-associate learning (a memory procedure in which the student learns to give a response when presented with a cue), performance (the observable qualities of learning; sometimes measured by the ability to discriminate a signal from noise), probability of recall (a measure of the likelihood that a student will be able to construct the correct response to a presented cue), rapid serial visual presentation (the presentation of a passage of text, one word or phrase at a time, serially, each in the same position on a display, so as to increase reading speeds and eliminate saccades required in normal reading), rehearsal (the process of repeating information to oneself in order to remember it), reinforcement (following a behavior with an especially powerful event such as a reward or punishment), the retrieval practice effect (the act of retrieving an item from memory facilitates subsequent retrieval access of that item and the act of retrieval does not simply strengthen an item's representation in memory, it also enhances the retrieval process), savings in relearning (a measure of memory strength calculated by measuring the amount of time necessary to relearn an item to the same criteria as that attained in the initial learning session), sensitization (increase in response as a result of repeated exposure to a stimulus), the serial position effect (the observation that items at the beginning and end of a list that are learned in serial order are more easily remembered than items in the middle of the list), signal detection theory (a method used to measure the criterion an observer uses in making decisions about signal existence and to measure the observer's sensitivity that is independent of his decision criteria), the spacing effect (the finding that for a given amount of study time, spaced presentations yield substantially better learned than massed presentations), the time of day effect (differences in performance on learning tasks and other factors relating to circadian rhythms depending on the time of day), transfer appropriate processing (the concept that memory performance is better when a student processes an item in the same way in which the item was processed during learning or study), vigilance (the process of paying close and continuous attention), Von Restorff effect (the observation that an item from one category that is learned as a part of a serial list of items all from a different category will be more easily recalled than items from around it in the list) and many other important factors which are applied in novel and unique ways, both individually and in combination with other factors. For the first time, the above-listed factors or phenomena are measured in a quantifiable manner and the measurements of the effects of these factors are used to interactively and adaptively modify the processes of learning, reviewing and testing knowledge and skills to achieve results never before obtainable.

While the above-listed factors have been studied in the past, and the effects thereof sometimes even measured, the measurements have not been quantified and then used in a feedback system to continuously and interactively modify future encoding, storage and retrieval of knowledge and skills to achieve maximum effectiveness and efficiency.

The system, apparatuses and methods of preferred embodiments of the present invention may be used to perform learning, reviewing and testing of any type of knowledge and skills in any format. The information including knowledge or skills to be learned, reviewed and tested, referred to as “content,” can be obtained from any source including but not limited to a text source, an image source, an audible sound source, a computer, the Internet, a mechanical device, an electrical device, an optical device, the actual physical world, etc. Also, the content may already be included in the system or may be input by a user, an administrator or other source of information. While the knowledge or skills to be learned, reviewed and tested may be presented in the form of a cue and response or question and answer in preferred embodiments of the present invention, other methods and formats for presenting items to be learned, reviewed and tested may be used.

More specifically, the content is preferably arranged in paired-associate (cue and response) format for ease of learning. The paired-associates may be presented visually, auditorily, kinesthetically or in any other manner in which knowledge or skills can be conveyed. The content may be also arranged in a serial or non-serial procedural order for skill-based learning. Any other arrangements where there is any form of a cue with an explicit or implicit paired response or responses are appropriate for use in the systems, methods and apparatuses of preferred embodiments of the present invention.

In one specific preferred embodiment, a system includes a Learn Module, a Review Module and a Test Module, each of which is arranged to interact and adapt based on the performance and user results in the other two modules and the particular module itself. That is, operation and functioning of each of the Learn, Review and Test Modules are preferably changed in accordance with how a user performed in all modules. The Learn Module, the Review Module and the Test Module preferably define a main engine of the system which enables information to be encoded, stored and retrieved with maximum efficiency and effectiveness.

A Discriminator Module may be included in the main engine to assist with the learning, reviewing and testing of confusable items.

A Schedule Module may also be included in the main engine to schedule the timing of operation of each of the Learn, Review and Test Modules. The scheduling is preferably based on a user's performance on each of the Learn, Review and Test modules, in addition to input information. The Schedule Module completely eliminates all scheduling planning and tasks which are normally the responsibility of the user, and thereby greatly increases the cognitive workload and metacognitive skills that the user can devote completely to learning, reviewing and testing of knowledge or skills.

Further, a Progress Module may be included in the main engine for monitoring a user's performance on each of the Learn, Review and Test Modules so as to provide input to the system and feedback to the user whenever desired. The Progress Module presents critical information to the user about the processes of learning, reviewing and testing in such a manner as to enable the user to increase his metacognitive skills and become a much better learner both with the system of preferred embodiments of the present invention and also outside of the system.

Also, a Help Module may be provided to allow a user to obtain further instructions and information about how the system works and each of the modules and functions thereof. The Help Module may include a help assistant that interactively determines when a user is having problems and provides information and assistance to overcome such difficulty and make the system easier to use. The Help Module may provide visual, graphical, kinesthetic or other types of help information.

It should be noted that although in the preferred embodiment of the present invention described in the preceding paragraph, the system preferably includes an interactive combination of Learn, Review and Test Modules, each module can be operated independently, and each module has unique and novel features, described below, which are independent of the novel combination of elements and the interactive and adaptive operation of the main engine described above.

In addition, other modules may be provided and used with the system described above. These other modules are preferably not included as part of the main engine, but instead are preferably arranged to interact with the main engine or various modules therein. For example, a Create Module may be provided outside of but operatively connected to the main engine to allow for input of knowledge or skills to be learned, retained or retrieved. The Create Module thus enables a user, administrator or other party to input, organize, modify and manage items to be learned so as to create customized lessons.

An Input Module may also be included and arranged similar to the Create Module. The Input Module is preferably arranged to allow a user, administrator, or other party to input any information that may affect operation of the modules of the main engine. Such input information may include information about which of the main engine modules is desired to be activated, changes in scheduling of learning, reviewing or testing, real world feed back which affect the learning, reviewing and testing and any other information that is relevant to the overall operation of the system and the modules contained in the main engine.

Also, a Connect Module may be provided outside of but operatively connected to the main engine to all external systems such as computers, the Internet, personal digital assistants, cellular telephones, and other communication or information transmission apparatuses, to be connected to the main engine. In fact, the Connect Module may be used for a variety of purposes including allowing any source of information to be input to the main engine, allowing multiple users to use the system and main engine at the same time, allowing a plurality of systems or main engines to be connected to each other so that systems can communicate. Other suitable connections may also be achieved via the connect module.

Another preferred embodiment of the present invention provides a method of learning including the steps of presenting knowledge or skills to be learned so that the knowledge or skills to be learned become learned knowledge or skills; presenting the learned knowledge or skills for review in a way that is different from the way in which the knowledge or skills are presented during learning, and presenting knowledge or skills for reviewing or testing whether the learned knowledge or skills have actually been learned. The method includes a step of monitoring each of the above steps and changing scheduling of each step based on progress in each step without the user knowing that monitoring or scheduling changes are occurring.

As noted above, with respect to the Input Module, the main engine and the methods performed thereby, can communicate with the real world allowing for feedback, information exchange and modification of the operation of the modules of the main engine based on real world information. All of these modules are preferably interactive with the Schedule Module and scheduling process which determines sequence of operation of the three modules and responds to the input information from the various input sources and optimizes the schedule of operation of the learn, review, and test processes.

The system, including the various methods and apparatuses of preferred embodiments of the present invention, is constructed to have a highly adaptive interface that makes the system extremely streamlined and progressively easier to use each time a user operates any of the modules of the system. The system preferably prompts a new user for identification information such as a password or other textual, graphical, physiological or other identifying data that identifies each user. Then, the adaptive interface determines the pattern of usage, and with what level of skill that particular user has operated the system. Based on this information, the system adapts to the user's familiarity level with the system and changes the presentation of information to the user to make it easier and quicker to use the system. For example, cues, instructions, help messages and other steps may be skipped if a particular user has operated the system many times successfully. Preferably, the Help module is preferably available should an advanced user forget how to operate the system.

The various systems, methods and apparatuses of preferred embodiments of the present invention may take various forms including a signal carrier wave format to be used on an Internet-based system, computer software or machine-executable or computer-executable code for operation on a processor-based system such as a computer, a telephone, a personal digital assistant or other information transmission device. Also, the systems, methods and apparatuses of preferred embodiments of the present invention may be applied to non-processor based systems which include but are not limited audio tapes, video tapes, paper-based systems including calendars, books, and any other documents.

The items to be learned, reviewed and tested using the systems, methods and apparatuses of preferred embodiments of the present invention are not limited. That is, items to be learned, reviewed and tested can be any knowledge, skill, or other item of information or training element which is desired to be learned initially and retrieved at a later date, or used to improve or build a knowledge base or skill base, to change behavior or thought processes, and to increase the ability to learn, review and test other items. For example, the systems, methods and apparatuses of preferred embodiments of the present invention may be used for all types of educational teaching and instruction, test preparation for educational institutions and various certifications such as CPA, bar exams, etc., corporate training, military and armed forces training, training of police offices and fire/rescue personnel, advertising and creating consumer preferences and purchasing patterns, mastering languages, learning to play musical instruments, learning to type, and any other applications involving various knowledge or skills. That is, the real-world applications of the systems, methods and apparatuses of preferred embodiments of the present invention are not limited in any sense.

Other features, characteristics, advantages, steps, elements and modifications of preferred embodiments of the present invention will become more apparent from the detailed description of the present invention below.

### BRIEF DESCRIPTION OF THE DRAWINGS

A more complete appreciation of the present invention and many of the attendant advantages thereof will be readily obtained as the same becomes better understood by reference to the following detailed description of preferred embodiments when considered in connection with the accompanying drawings, wherein:

FIG. 1 is a schematic view of a system for learning, reviewing and testing knowledge or skills according to a preferred embodiment of the present invention;

FIG. 2 is a graph of memory conditioning versus the CS-US interval related to preferred embodiments of the present invention;

FIG. 3 is a graph showing memory strength versus time indicative of the forgetting/retention function related to preferred embodiments of the present invention;

FIG. 4 is a graph of memory strength versus time showing an expanded rehearsal series used to maintain a desired level of retention in the system shown in FIG. 1;

FIG. 5 is graph of frequency versus memory strength indicative of the signal detection theory with multiple distracters related to preferred embodiments of the present invention;

FIG. 6 is a matrix indicative of the signal detection theory shown graphically in FIG. 5;

FIG. 7 is a flowchart showing operation of a preferred embodiment of the Learn Module of the system of FIG. 1;

FIG. 8 is a flowchart showing a Quick Review operation of a preferred embodiment of the Learn Module of the system of FIG. 1;

FIG. 9 is a flowchart showing operation of a preferred embodiment of the Review Module of the system of FIG. 1;

FIG. 10 is a flowchart showing operation of a preferred embodiment of the Test Module of the system of FIG. 1;

FIG. 11 is a flowchart showing operation of a preferred embodiment of the Schedule Module of the system of FIG. 1;

FIG. 12 is a flowchart showing operation of a preferred embodiment of the Discriminator Module of the system of FIG. 1;

FIG. 13 is a flowchart showing further operation of a preferred embodiment of the Discriminator Module of the system of FIG. 1;

FIG. 14 is a graph of memory strength versus time indicative of the various levels of learning which can be achieved using the system shown in FIG. 1;

FIG. 15 is a graph of the memory strength versus time that is indicative of the benefits of overlearning used in the system shown in FIG. 1;

FIG. 16 is a table showing a learn presentation sequence in which cues and responses are presented in a certain sequence in the system of FIG. 1;

FIG. 17 is a table showing a learn presentation pattern indicative of the order of presenting items to be learned as shown in FIG. 16;

FIG. 18 is a table illustrating the learn presentation timing indicative of the timing of the presentation of the items shown in FIGS. 16 and 17;

FIG. 19 is a graph of a the probability of recall according to the serial input position indicative of the serial position effect used in the system shown in FIG. 1;

FIG. 20 is a graph of the mean number of rehearsals as a function of the serial input position used in the system shown in FIG. 1;

FIG. 21 is a graph of memory comparison time versus memory span used in the system of FIG. 1;

FIG. 22 is a table showing a modality pairing matrix including various combinations of cues and responses used in the system of FIG. 1;

FIG. 23 is a Review Curve Table which models curves indicative of the forgetting rate for each item learned in the system of FIG. 1;

FIG. 24 is a Review Hopping Table that is a set of instructions for informing the system of FIG. 1 how to switch between review curves for each item to be reviewed;

FIG. 25 is a graph of memory strength versus time that includes a family of review curves for illustrating hopping between review curves;

FIG. 26 is a table showing various combinations of cues and responses showing the forms for discrimination of two items used in the system of FIG. 1;

FIG. 27 is a graph of latency of response versus the number of trials used in the system of FIG. 1;

FIG. 28 is a graph of workload versus time indicative of schedule zones and workload used in the system of FIG. 1;

FIG. 29 is an illustration of a main window display for a preferred embodiment of the system shown in FIG. 1;

FIG. 30 is an illustration of a preview window display for a preferred embodiment of the system shown in FIG. 1;

FIG. 31 is an illustration of a learn sequence including the presentation of a cue for a preferred embodiment of the system shown in FIG. 1;

FIG. 32 is an illustration of a learn sequence including the presentation of a cue and response for a preferred embodiment of the system shown in FIG. 1;

FIG. 33 is an illustration of a learn sequence including a request for faster or slower presentation of cues for a preferred embodiment of the system shown in FIG. 1;

FIG. 34 is an illustration of a learn sequence including a completion indication for a preferred embodiment of the system shown in FIG. 1;

FIG. 35 is an illustration of a learn sequence including a new item learn prompt for a preferred embodiment of the system shown in FIG. 1;

FIG. 36 is an illustration of a learn sequence indicating a Quick Review operation for a preferred embodiment of the present invention;

FIG. 37 is an illustration of a main window display with a review notification for a preferred embodiment of the present invention;

FIG. 38 is an illustration of a review sequence including a presentation of review options for a preferred embodiment of the present invention;

FIG. 39 is an illustration of a review sequence including an indication of an end of a review round for a preferred embodiment of the present invention;

FIG. 40 is an illustration of a review sequence including a presentation of a cue to be reviewed for a preferred embodiment of the present invention;

FIG. 41 is an illustration of a review sequence including a user rating the quality of response for a preferred embodiment of the present invention;

FIG. 42 is an illustration of a test sequence including a five alternative forced-choice for a preferred embodiment of the present invention;

FIG. 43 is an illustration of a test sequence including a presentation of a cue and a feeling of knowing rating for a preferred embodiment of the present invention;

FIG. 44 is an illustration of a test sequence including a cue and correct response for a preferred embodiment of the present invention;

FIG. 45 is an illustration of a test sequence including scores of performance in the test sequence for a preferred embodiment of the present invention;

FIG. 46 is an illustration of a schedule main window display for a preferred embodiment of the present invention;

FIG. 47 is an illustration of a connect main window display for a preferred embodiment of the present invention;

FIG. 48 is an illustration of a create control window display for a preferred embodiment of the present invention;

FIG. 49 is an illustration of a create main window display for a preferred embodiment of the present invention;

FIG. 50 is an illustration of a progress main window display for a preferred embodiment of the present invention; and

FIG. 51 is an illustration of a help main window display for a preferred embodiment of the present invention.

FIG. 52 is a schematic illustration of a preferred embodiment of the present invention in which the system of FIG. 1 is applied to a paper-based system; and

FIG. 53 is an illustration of a review expansion series for the paper-based embodiment shown in FIG. 52.

FIG. 54 is a schematic illustration of a unique learning model relating to another preferred embodiment of the present invention.

FIG. 55 is a graph illustrating memory performance versus time using a target level and alert level of a memory indicator using the learning model according to the preferred embodiment shown in FIG. 54.

FIG. 56 is a graph illustrating error adaptation and automatic graceful degradation achieved with the preferred embodiment of FIG. 54.

FIG. 57 is an illustration of a content tree used for adapting information to be learned to method and learning engine of the preferred embodiment shown in FIG. 54.

FIG. 58 is graphical illustration of the process for introducing items over time using the learning method and engine of the preferred embodiment shown in FIG. 54.

FIG. 59 is an example of a multiple filter process for selecting items to be presented to a user in a preferred embodiment of the present invention.

FIG. 60 is a flowchart illustrating the steps of a learning process according to another preferred embodiment of the present invention making use of the learning model shown in FIG. 54.

### DETAILED DESCRIPTION OF PREFERRED EMBODIMENTS

Hereinbelow, a plurality of preferred embodiments of the present invention are explained referring to the several drawings. Hereinafter, like reference numerals indicate identical or corresponding elements throughout several views.

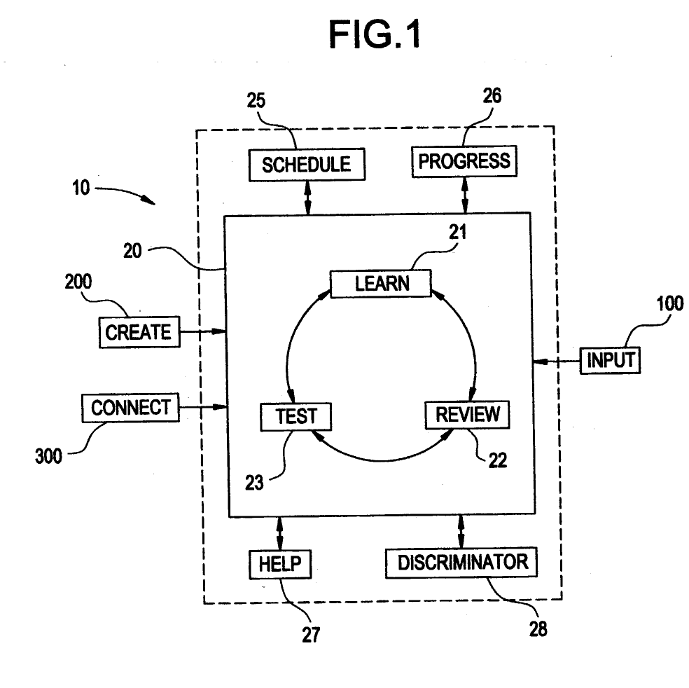

FIG. 1 shows in a schematic form a system 10 according to a preferred embodiment of the present invention. The system 10 is arranged and operative to maximize the effectiveness and efficiency of learning, retaining and retrieving knowledge and skills. Knowledge in this system 10 preferably refers to declarative knowledge such as the knowledge of factual information. Skills in this system 10 preferably refer to procedural knowledge such as the knowledge of how to perform a task. Of course, other types of knowledge can be readily adapted for use in the system 10.

The system 10 preferably includes a main engine 20. The main engine 20 preferably includes a Learn Module 21, a Review Module 22 and a Test Module 23. The Learn Module 21 is adapted to encode knowledge or skills via a process for creating a memory record. The Review Module 22 is adapted to store knowledge or skills via a process of maintaining a memory record over time through rehearsal. The Test Module 23 is adapted to retrieve knowledge or skills via a process of producing a response to a presented cue automatically or through active recall.

The Learn Module 21, the Review Module 22 and the Test Module 23 preferably operate together and interact with each other to improve the learning, memory and performance of a user of the system 10. To this end, the cooperation between the Learn Module 21, the Review Module 22 and the Test Module 23 allows a user to learn via a process by which relatively permanent changes occur in the behavioral potential as a result of interaction of these modules, to achieve memory for each item which is the relatively permanent record of the experience that underlies the learning, and to achieve high levels of performance including various observable qualities of learning.

As shown in FIG. 1, the Learn Module 21, the Review Module 22 and the Test Module 23 are preferably interactive with each other as shown by the arrows connecting adjacent ones of the modules 21-23. As will be described in more detail below, the three modules 21-23 are preferably arranged such that the future operation of each of the modules 21-23 is based on the past performance in each of the other modules.

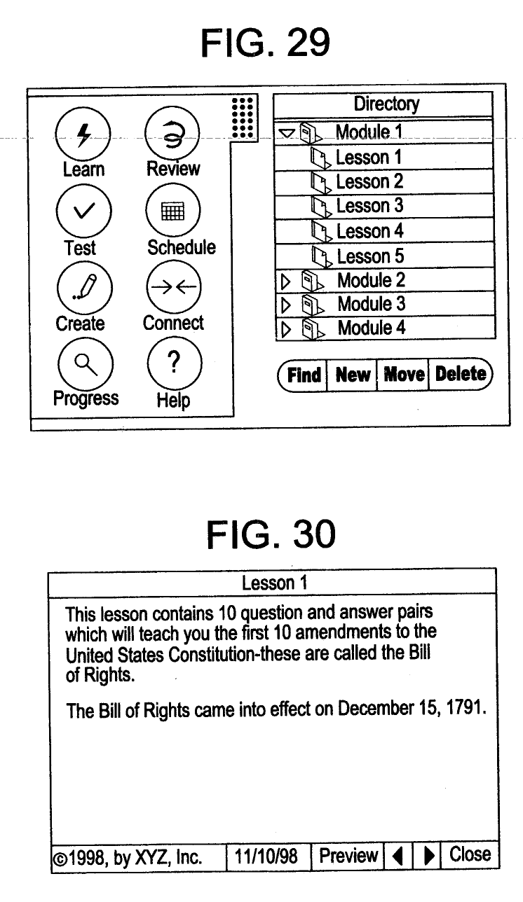

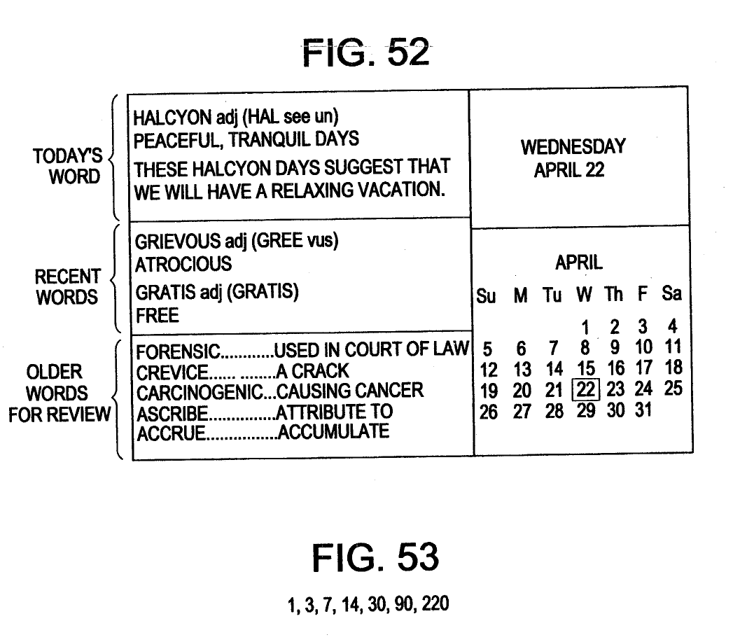

The system 10 and the methods thereof can be implemented on any platform and with any type of system including a paper-based system, a computer-based system, a human-based system, and on any system that presents information to a person or organism, for learning and future retrieval of that information. For example, the system 10 may be a non-processor based system including but not limited to audio tapes, video tapes, paper-based systems such as a word-a-day calendar described later with respect to FIGS. 52 and 53, learning books such as workbooks, a processor-based system, such as that shown in FIGS. 29-51, in which the main engine 22 is implemented in a processor, microprocessor, central processing unit (CPU), or other system in which functions are executed via processing of machine readable code, computer software, computer executable code or a signal carrier wave transmitted via the Internet.

As will be described in more detail below, the main engine 20 may also include a Schedule Module 25, a Progress Module 26, a Help Module 27 and a Discriminator Module 28.

The system 10 may also be adapted to interact with various elements or modules external to the system, such as an Input Module 100, a Create Module 200 and a Connect Module 300 shown in FIG. 1.

It should be noted that the modules 21, 22, 23, 25, 26, 27, 28, 100, 200, 300 and other modules described herein are preferably processes or algorithms including a sequential series of steps to be performed. The steps may be performed via a plurality of different devices, apparatuses or systems. For example, the steps to be performed by the main engine 20 including modules 21, 22, 23, 25, 26, 27, 28 may be performed by various devices including as a computer, any type of processor, a central processing unit (CPU), a personal digital assistant, a hand-held electronic device, a telephone including a cellular telephone, digital data/information transmission device or other device which performs the steps via processing of instructions embodied in machine readable code or computer executable code such as computer software.

Each of the modules external to the main engine 20 will be described and then each of the modules of the main engine 20 will be described.

The processes or steps to be performed by the Input Module 100, the Create Module 200 and the Connect Module 300 may be performed by various devices including a keyboard, microphone, mouse, touchscreen, musical keyboard or other musical instrument, telephone, Internet or other suitable information transmitting device.

The Input Module 100 may be adapted to receive information that is transmitted overtly or covertly from the user. The Input Module 100 can also be used by an administrator of the system such as a teacher. The Input Module 100 can also receive input information from objects or any other source of information existing in the real world. The Input Module 100 is configured to allow a user, administrator, or other party or source of information to input any information that may affect operation of the modules of the main engine 20 or other modules in the system 10. Such input information may include information about which of the main engine modules is desired to be operated, changes in scheduling of learning, reviewing or testing, user performance with the system 10, the type and difficulty of the items to be learned, reviewed and tested, real world feed back which affect the learning, reviewing and testing, and any other information that is relevant to the overall operation of the system 10 and the modules contained in the main engine 20 and outside of the main engine.

Furthermore, the Input Module 100 can be configured to receive information as to the performance of the user of the system 10 through quantitative measurements such as time required to input various responses requested, ability of user to meet and adhere to schedule set up by the system 10, and the user's level of interest and arousal in learning which can be measured by such physiological characteristics as perspiration, pupil diameter, respiration, and other physiological reactions.

As will be described in more detail below, the system 10 accepts and obtains various input information through the Input Module 100 and the future operation of the various modules of the system 10 modified based on this input information. In this way, the system is adaptive to the user's abilities and performance, and other input information so as to constantly and continuously adapt to provide maximum effectiveness and efficiency of learning, retaining and retrieving of knowledge or skills.

The manner in which the information is input to the system 10 via the Input Module 100 is not limited, and may include any information transmission methods, processes, apparatuses and systems. Examples of input devices and processes include electronic data transmission and interchange via computer processors, the Internet, optical scanning, auditory input, graphical input, kinesthetic input and other known information transmission methods and devices.

The Create Module 200 may be provided outside of, but operatively connected to, the main engine 10 to allow for input of knowledge or skills to be learned, retained, and retrieved. The Create Module 200 thus enables a user, administrator or other party to create new customized lessons by inputting items to be learned and by providing additional information about each item that will affect how each item or groups of items will be learned, reviewed and tested to maximize effectiveness and efficiency of the learning system 10.

The Connect Module 300 may be provided outside of, but operatively connected to, the main engine 20 so as to connect all types of external systems and devices such as computers, the Internet, personal digital assistants, telephones, and other communication or information transmission apparatuses, to be connected to the main engine 10. In fact, the Connect Module 300 may be used for a variety of purposes including allowing any source of information to be input to the main engine, allowing multiple users to connect to and use the system 10 and the main engine 20 at the same time, and allowing a plurality of systems 10 or main engines 20 to be connected to each other so that systems 10 and main engines 20 can communicate and share information such as lessons to be learned, performance by an individual in any of the modules, changes in schedule and many other factors, data and information pertaining to operation of the system 10. Other suitable connections may also be achieved via the Connect Module 300.

The Help Module 27 may be provided to allow a user to obtain further instructions and information about how the system 10 works and the operation of each of the modules and functions thereof. The Help Module 27 may include a help assistant that interactively determines when a user is having problems in operating the system 10 and provides information and assistance to overcome such difficulty and make the system 10 easier to use. The Help Module 27 may provide visual, graphical, kinesthetic or other types of help information to the user, either in response to a request from the user or when the system 10 has detected that the user is having difficulty using the system 10. The Help Module 27 may also provide feedback, preferably through the Connect Module 300, to an administrator such as a teacher or some of other third party so as to indicate problems that various users of the system 10 are having.

The Progress Module 26, the Schedule Module 25 and the Discriminator Module 28 will be described after the Learn Module 21, the Review Module 22 and the Test Module 23 are described.

The arrangement and operation of the system 10 of FIG. 1 and all of the elements thereof are based on several scientific principles and phenomena that are related to learning systems having memory with a fixed storage space for storing knowledge or skills.

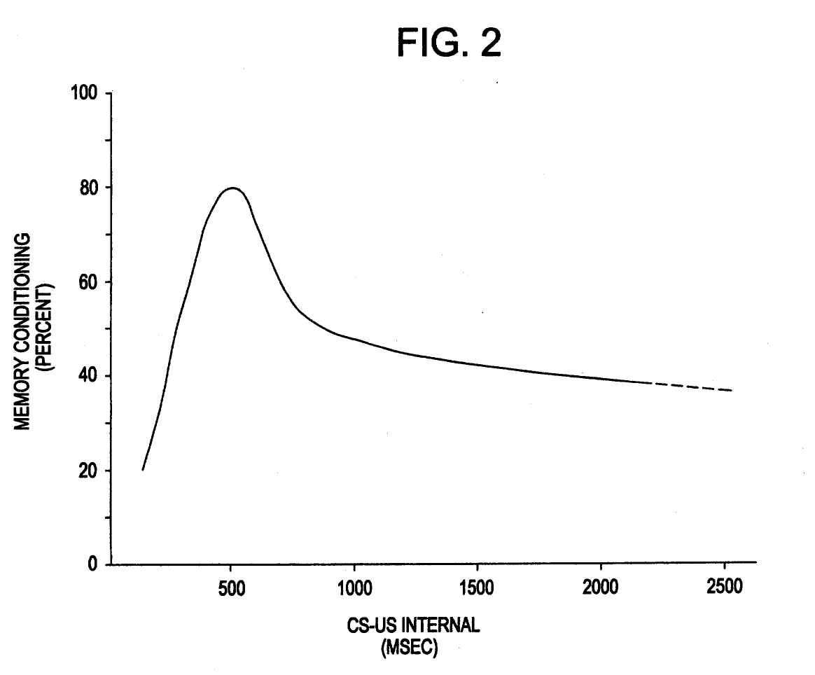

FIG. 2 is a graph of the degree of memory conditioning versus the CS-US Interval, which is a known characteristic of temporal aspects of classical conditioning. Classical conditioning is the procedure in which an organism comes to display a conditioned response to a neutral conditioned stimulus that has been paired with a biologically significant unconditioned stimulus that evoked an unconditioned response. For example, in the well known experiment by Pavlov, a dog comes to display the conditioned response of salivating upon hearing a bell. In this example, the ringing of the bell is the neutral conditioned stimulus, which is paired with the biologically significant unconditioned stimulus of presentation of food which causes the biological reaction of the dog salivating.

Similar biological principles apply to operant conditioning or instrumental conditioning which is the procedure in which a particular stimulus condition occurs and if an organism voluntarily emits a response to the stimulus, then a particular reinforcer will occur. For example, a student wishes to learn that the Spanish word for dog is “perro.” The stimulus can be thought of as “dog” and the response “perro”, and the reinforcer may be the teacher's approval.

As seen in FIG. 2, ideally, when information is initially encoded, or is strengthened through reviewing or testing, a cue is presented and a response is actively recalled. It is this process of active recall that strengthens memories. One critical aspect of the process of achieving active recall of knowledge or skills is the timing of the presentation of the cue and the presentation of the response. FIG. 2 shows that maximum conditioning occurs when the response follows the cue by about 250 milliseconds to about 750 milliseconds.

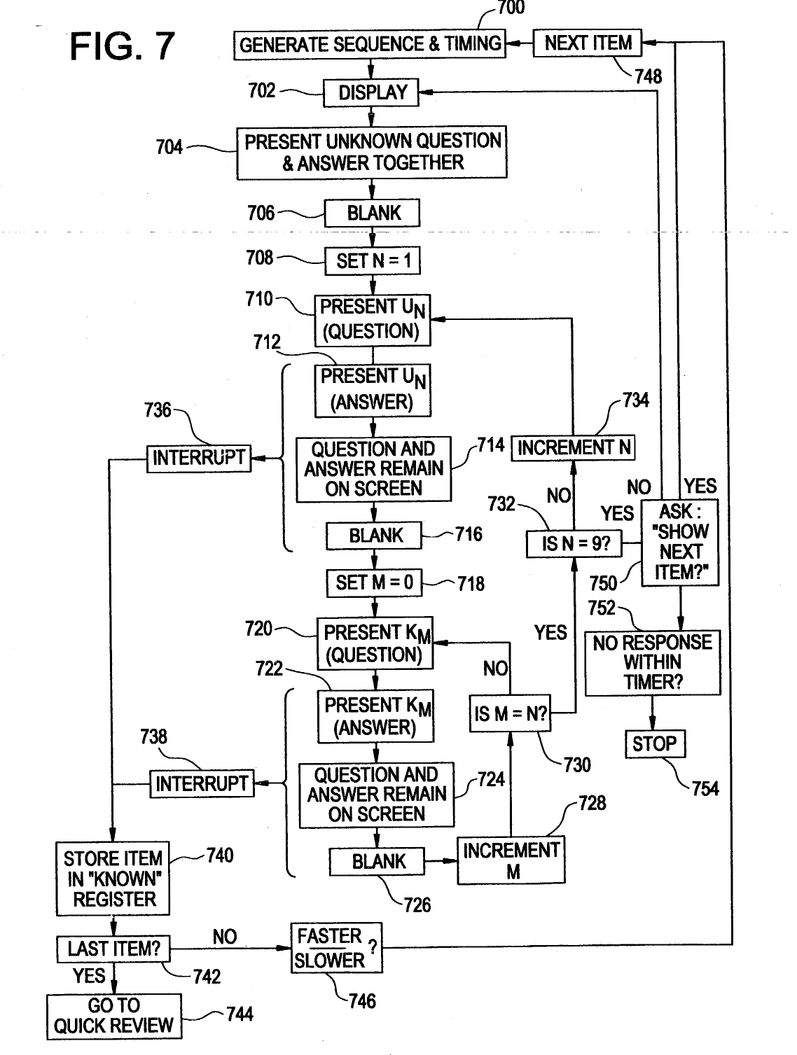

While classical conditioning and operant conditioning have been used in the past for various training and teaching methods, these methods have not been quantitatively measured and then had the resulting quantitative measurements used to modify various timing parameters and steps of a learning process as in preferred embodiments of the present invention as will be described later with respect to FIGS. 7-13. One of the advantageous results of this novel process is maximizing the effectiveness and efficiency of encoding for retrieval such that a paired-associate or item to be learned is encoded to a level of automaticity and can be recalled automatically with no significant cognitive effort being expended. A real world example of this novel process is in the advertising context in which a paired-associate might include “sneaker” as the cue and “Brand X sneakers” as the response. With the novel process of preferred embodiments of the present invention, the system adaptively and interactively encodes for retrieval such that when a consumer is presented, in any form, with the cue “sneaker”, the consumer automatically thinks of the response “Brand X sneakers.” As will be described below in preferred embodiments of the present invention, the presentation of cues and responses in the Learn Module 21, the Review Module 22 and the Test Module 23 interactively adapts the CS-US interval shown in FIG. 2 based on various factors such as the type and difficulty of the knowledge or skills, the user's performance in each of the modules of the system 10, the measured arousal and attention of the user, the measured confidence of the user in responding to the presentation of cues and responses and providing responses to cues, the number of times a paired-associated has been seen by a user to take into account the effects of habituation and sensitization, the user's feeling of knowing and judgment of knowing as quantitatively rated by the user, the measured latency of response of the user, the measured memory strength for a particular item, the measured probability of recall and user's performance, and many other quantitatively measured factors and effects.

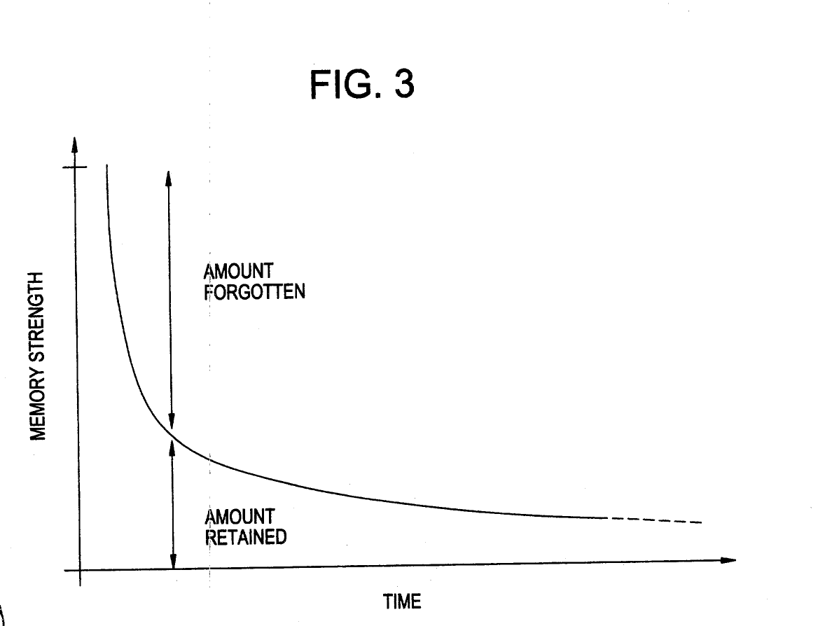

FIG. 3 shows a graph of memory strength versus time that indicates how human memory decays over time, which is an important phenomenon in a learning system. The graph of FIG. 3 is often referred to as the forgetting function because the vertical distance between the curve and the horizontal line marking the maximum memory strength represents the amount of previously learned material that has been forgotten. Conversely, the graph of FIG. 3 is also referred to as the retention function because the vertical distance between the curve and horizontal line marking the minimum memory strength represents the amount of previously learned material that has been retained or remembered. As seen in FIG. 3, the curve is a negatively accelerated function, which means that initially, material is forgotten quickly and over time, the rate at which material is forgotten slows. The curve shown in the graph of FIG. 3 is measured by a test of memory at a fixed degree of sensitivity.

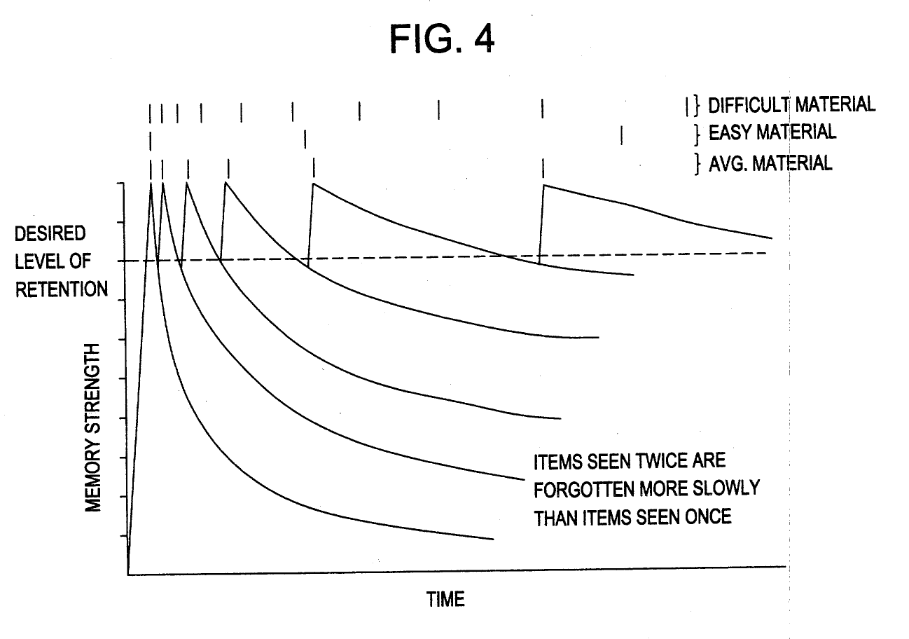

FIG. 4 is a graph similar to FIG. 3. The axes of FIG. 4 are memory strength and time as in FIG. 3. Stating from t=0, the trace proceeds quickly to a local maximum, indicating the desired degree of initial learning of previously unlearned material. Following an initial learning session, the trace declines in the form of a negatively accelerated function indicating the normal loss of memory strength over time. It is desirable, however, to maintain a certain level of retention for learned material over some period of time.

Conventional methods of learning have recognized the effects of the decay of memory over time as shown in FIGS. 3 and 4 and have used an expanded rehearsal series, whereby items previously learned are later reviewed according to a schedule which is not modified and is identical for all items and individuals. The expanded rehearsal series shown in FIG. 4 is a random and crude attempt at minimizing the effects of forgetting due to the decay of memory over time.

In contrast to the conventional methods, preferred embodiments of the present invention quantitatively measure the memory strength for each item and for each user, since there are significant differences in memory strength over time for various types of knowledge or skills and for various users which have vast differences in how they encode, store and retrieve knowledge or skills, (i.e. dyslexic, learning disabled, low IQ, etc.). The memory strength over time is quantitatively measured using overt and covert information gathered during the user's operation and activity in the Learn Module 21, the Review Module 22 and the Test Module 23, as well as other modules. The information input to the system 10 to determine memory strength over time include, but are not limited to: rate of initial learning, degree of initial learning, probability of recall, latency of recall and savings in relearning. The quantitative measurement of the memory strength for each item is used to adaptively modify the operation of one or more of the Learn Module 21, the Review Module 22 and the Test Module 23, as well as other modules included in the system 10.

More specifically, the system 10 determines that the memory strength for a particular item has decreased to the minimum retention level by making calculated projections based on the mathematical characteristics of the decline of human memory, the type and difficulty of the item being learned, the recency, the frequency, the pattern of prior exposure, and the user's particular history of past use of the system 10. As can be seen in FIG. 4, items seen twice are forgotten more slowly than items seen once and furthermore, items seen three times are forgotten more slowly than items seen twice or once. This must be taken into account when making the calculated projections as to when the memory strength for each particular item will fall below the minimum retention level. The system 10 schedules the item for review in the Review Module 22 based on the calculated projections. The climb of the trace of FIG. 4 back to the local maximum memory strength indicates the change that occurs as a result of a review session in which a previously learned item is reviewed in the Review Module 22. Following the Review Module 22 session, the trace of memory strength of FIG. 4 declines once again in the form of a negatively accelerated function. This time, however, the curve function is shallower than the forgetting curve following the initial learning session. The shallower curve indicates that the item is forgotten more slowly for items seen twice than for items only seen once. Once again, when the system 10 has determined that the memory strength for each particular item has decreased to the minimum retention level, the system schedules the item for review. This process of forgetting and review continues for as long as the user or administrator desires the learned material to be retained to a desired level.

Because all learners are not alike, and not all items are equally easy to learn, to maintain in memory and to retrieve, the system 10 preferably constantly monitors the memory strength for each item for each learner to determine the most effective and efficient schedule of Review.

FIG. 4 illustrates the schedule of review for items that a model learner finds are of average difficulty. The small vertical hash marks above the curves in FIG. 4 indicate the end of each Review session. The spacing of the hash marks in FIG. 4 is indicative of an expanded rehearsal series. Above these hash marks are another series of hash marks that indicate the spacing of review sessions for items a model learner finds are easy to learn, to maintain in memory or to retrieve. Above these hash marks is a third set of hash marks that indicate the spacing of review sessions for items that are relatively difficult.

In the system 10 of preferred embodiments of the present invention, there is no single review schedule in the Review Module 22 that is the most effective and efficient to maintain a desired level of retention for each user for each item. Accordingly, the system 10 monitors the users as he learns, reviews and tests himself on each item. Based on measured quantitative results gathered overtly and covertly as described above, the system 10 quantitatively determines when the next review session must occur to maintain the desired level of retention. Thus, the system 10 is adapted to the individual needs of each user.

Eventually, review sessions are scheduled so far apart in time, that the item can be considered to have entered a state of permastore. That is, the item will have been learned and reviewed such that the item is known for the lifetime of the learner. Although memory strength will not decay to a point where the item is lost due to storage failure, the item may be forgotten as a result of low memory activation and the user may experience a retrieval failure. This problem can be reduced or eliminated by scheduling review sessions for particularly important items to maintain a minimum desired level of activation.

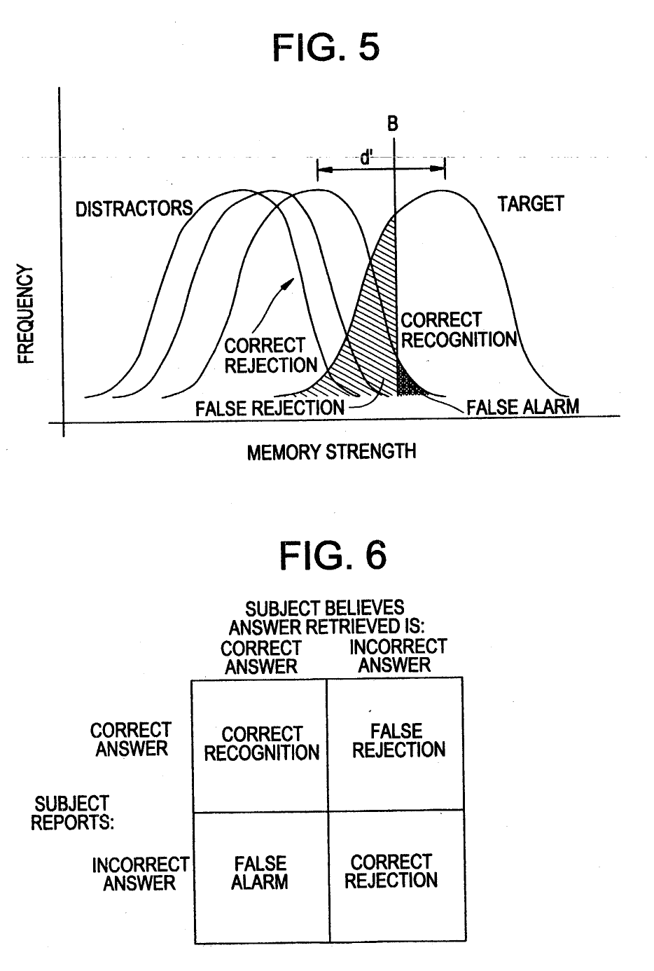

FIG. 5 illustrates the concept of Signal Detection Theory, a branch of psychophysics. Signal Detection Theory is based on the phenomenon that a living organism such as a human or other animal, perceives stimuli and makes decisions based upon those perceptions. This two-part process is integral to many memory related tasks and is quantitatively incorporated into the performance of various modules of the system 10 of a preferred embodiment of the present invention.

In FIG. 5, a target, or correct response to a cue, is perceived as differing in memory strength from a number of distracters. The user's ability to perceive the difference between the target and the distracter(s) is measured by d′, also known as performance. In the signal detection paradigm, the user must be able to discriminate the target from the distracters. The criterion a user uses in making decisions about signal existence is known as Beta. If the user is extremely lax in their criteria for reporting, Beta shifts to the left of the graph of FIG. 5. If the user is extremely cautious in their criteria for reporting, Beta shifts to the right of the graph of FIG. 5.

FIG. 6 is related to FIG. 5 and shows a signal detection theory matrix. When there is overlap between the target and the distracters, the position of Beta on the graph of FIG. 5 creates a possibility of four outcomes. In memory experiments where a user is trying to retrieve a correct response to a presented cue, the user must select a response stored in his memory from a number of alternative incorrect responses and distracters. Four outcomes are possible in the simplest case: in the first case, the user believes that he has retrieved a response that is correct, and he turns out to indeed be correct—a correct recognition. In the second case, the user believes that he has identified an incorrect response, and he is correct in his assessment and reporting—a correct rejection. In the third case, the user believes that he has identified a correct response and reports it as such. Unfortunately, the chosen response is incorrect—a false alarm. In the fourth case, the user believes that he has identified an incorrect response and reports it as such, but it turns out that it was actually the correct response—a false rejection.

The system 10 according to preferred embodiments of the present invention monitors not only the correctness of the user's response but also the user's performance, which is the ability to evaluate accurately whether they know the correct response and the incorrect responses. The system 10 according to preferred embodiments of the present invention also measures the time required for the user to make such evaluation about the correct response and incorrect responses.

Instead of using the measured performance to generate sequences of perceived known and unknown items which is not done in any of the preferred embodiments of the present invention, the quantitatively measured performance is fed back and presented, either graphically, auditorily, kinesthetically, or otherwise, to the user, preferably along with the score of accuracy of recall, to provide information to the user about his metacognitive skills in this learning environment and other learning environments, enabling the user to improve how he monitors and controls how he learns and to become a better learner. Because a significant part of learning and retrieval is the ability to discriminate between correct and incorrect answers, the system 10 according to preferred embodiments of the present invention not only teaches the user knowledge or skills, but also trains the user to become a more effective learner by improving the metacognitive skills required for self-paced learning. These are skills necessary to monitor performance during learning, reviewing, and testing. Metacognitive skills include subjective measurements of feeling of knowing, confidence, and judgment of learning, which are measured quantitatively in preferred embodiments of the present invention and then used to modify the future use of the system 10 and the future operation of the various modules therein, including especially the Learn Module 21, the Review Module 22 and the Test Module 23.

For example, the system 10 of preferred embodiments of the present invention preferably uses the measured probability of recall, latency of response, and savings in relearning in the future operation of the Learn Module, the Review Module and the Test Module to further increase the effectiveness and efficiency of learning and performance achieved by the system of the present invention.

Each of the modules including the Learn module 21, the Review Module 22 and the Test Module 23 are preferably arranged and adapted to function either together with the other two of these three modules or to function independently as a stand-alone module.

In addition, other modules such as the Schedule Module 25, the Progress Module 26 and the Help Module 27 may be added to any combination of the Learn Module 21, the Review Module 22 or the Test Module 23 in a system.

It should be noted that each of the Learn Module 21, the Review Module 22 and the Test Module 23 contain many novel aspects, processes, elements and features thereof and can be used independently of the system shown in FIG. 1 and independently of the other modules of the main engine 20 and the system 10 shown in FIG. 1. The novel features of each of the Learn Module 21, the Review Module 22 and the Test Module 23 will be described now.

Now, each of the various modules will be described.

I. The Learn Module:

The Learn or Encode Module 21 is used to present items to be learned to a user. Learning methods have been known such as the Skinner method described above. The method and system according to the preferred embodiments of the present invention is based on the Skinner method but is modified and greatly improved so as to be adaptive and interactive in response to various factors.

The Learn Module 21 uses the Skinner method of learning through presenting paired-associates of cues and responses. The timing, order of presentation and sequence of each cue and response for the Learn Module 21 is interactively determined based on covert and overt input from the user and may also may be based on information received from various other input sources. Such cover or overt input may relate to the content of knowledge or skills to be learned, timing of presentation of knowledge or skills to be learned including timing between each cue and response in each of the plurality of cue and response items, timing between presentation of groups of cue and response items (time between presentation of one cue and response pair and the next cue and response pair), sequence of presentation of knowledge or skills to be learned and the format of presentation of knowledge or skills to be learned and other factors.

The inputs upon which the presentation of the items in the Learn Module 21 may be from one or more of the user, the administrator, the system 10 including other modules included therein, and any other input source that is relevant to the learning process and operation of the Learn Module 21.

For example, other input sources could be sensed environmental conditions such as time of day. Time of day has an effect on learning for people of various ages and therefore may be input to change the presentation of items in the Learn Module 21. The inputs to the Learn Module 21 may further include various personal and physiological information such as age, gender, physiological activity such as galvanic skin response, information obtained through non-invasive monitoring of brain activity, and other personal factors.

The overt and covert inputs from the various input sources may include information concerning rate of presentation of items, format of presentation of items, sequence of presentation of items, and other information that would affect operation of the Learn Module 21. The method of inputting the overt information is based on a purposeful, conscious decision on the part of a user, administrator, or other source to input information to the system. In contrast, the covert information is input based on physiological information obtained by various sensors obtaining data regarding factors such as a galvanic skin response, pupil diameter, respiration, blood pressure, heart rate, brain activity, and other personal conditions. This information can be obtained by such known sensors including an electromyogram, electroencephalogram, thermometer, and electrocardiogram among others. The covert information is analyzed to determine many factors including a user's attention and vigilance so as to determine to what degree a user is attending to the presentation of information in the Learn Module 21.

The actual cue and response items may be modified in format according to the desires of a user, administrator or based on other input information. In addition, the cue and response items may be supplemented by information such as a facility for pronunciation hints, and other helpful facts or information related to the items being presented for learning in the Learn Module 21. Such additional related information is not part of the cue and response items but is presented with the cue and response items to assist in the learning process.

In addition, items to be learned in the Learn Module 21 may be confusable items and may be presented differently from other items to be learned. This process will be described in more detail in the description of the Discriminator Module 28 below.

The Learn Module 21 operates and is controlled based on many factors including desired degree of initial learning and desired degree of retention over time. A desired degree of initial learning may be input by a user, administrator, or other input source to indicate what degree of memory strength is desired for each item or group of items to be learned. The desired degree of retention is based on the rate of forgetting predicted (FIGS. 3 and 4) and measured by probability of recall, latency of recall, savings in relearning, and other factors, in Review and Test sessions conducted over time.

As a general rule, the system, apparatus, and method of preferred embodiments of the present invention seek to provide a level of retrieval that is known as automaticity. Automaticity means that a person knows the knowledge or skills and does not have to expend great effort to remember it. Automaticity decreases the latency of response as well as the cognitive workload during retrieval.

Therefore, the preferred embodiments of the present invention perform encoding for automaticity to achieve “knowing rather remembering.” The prior art assumes mastery is achieved at the time that the first correct answer is provided on a test of recall. Recall, however, is not automaticity. Automaticity can be distinguished from recall because it allows extremely fast retrieval of knowledge or skills. The difference between automaticity and recall is latency of response or how long it takes to respond to a cue or perform a desired skill. Also, simple recall requires relatively more cognitive effort on the part of the person responding to the cue or performing the skill, but automaticity requires far less cognitive effort thereby reducing overall cognitive workload. The net result is that knowledge or skills encoded, retained and retrieved using the method are retrieved quickly and effortlessly.

In order to reduce cognitive workload during learning and thereby reduce fatigue, the pattern, sequence and timing of presentation of items is continuously adjusted in the Learn Module 21 based on quantitative inputs thereto. Items to be learned are preferably presented one item at a time to avoid requiring the user to retain multiple items in short-term memory. In addition, the pattern, sequence and timing of items to be learned is determined by the system 10 and therefore, the cognitive effort required for monitoring and controlling the study session is reduced so that a person can learn for a longer period of time and is not distracted from the learning process.

The Learn Module 21 also operates to capture and maintain the user's attention based on psychological phenomenon of habituation and sensitization. One example of sensitization is a person becoming aware of something, such as the sound of a car alarm, which initially captures that person's attention. However, if those stimuli are repeated over and over, the person becomes oblivious or habituated to it—their brain tunes it out. Accordingly, the presentation pattern, sequence, or timing of items to be learned may be preferably varied so as to vary stimulation in such a way as to avoid habituation or the disengagement from attending to this particular stimuli. The difficulty is that this variation in the above-identified factors should not be done overtly but should be done in a manner that is not so obvious that it becomes a distraction in and of itself, but rather should be done in a more subtle manner, using variations in the presentation pattern, sequence, and timing at the “just noticeable difference” threshold whereby a person notices unconsciously but not actually consciously. In a preferred embodiment of the Learn Module 21, attention that is declining is recaptured through various means such as the use of obligatory attention cues and then by varying the presentation pattern, sequence, and timing of the items presented.

Obligatory attention cues include such sensory events as a blinking light, a tone, object movement or other stimulation that attracts the attention of the user.

In addition, the serial position affect is preferably taken into consideration in the Learn Module 21 and the presentation of items to be learned in the Learn Module 21 is changed in order to eliminate the serial position effect. Providing a non-serial presentation to avoid the serial position effect may be accomplished by reordering the presentation of the cue and response items. For example, the non-serial presentation of items in the Learn Module 21 can be achieved by spacing apart unknown items to be learned by inserting between the unknown items, a number of items which are randomly selected from a pool of previously learned items.

The Learn Module 21 takes advantage of the psychological phenomenon known as the spacing effect. The spacing effect states that for an equal number of presentations of an item to be learned, distributing the presentations over time yields significantly greater long-term retention than does massed presentations. Furthermore, the spacing of presentations in the Learn Module 21 preferably takes the form of an expanded rehearsal series where items are reviewed at increasingly longer intervals for the greatest effectiveness and efficiency of learning.

Also, the sequence in which the cue and response items are presented in the Learn Module 21 may be changed to present more difficult items more times than easier items allowing the user to concentrate their effort where it is most needed.

The Learn Module 21 is preferably designed to promote self-motivated learning. One factor in motivating learning is the rate of success and failure. Too much success or failure is not motivating to a person seeking to learn. Thus, the Learn Module 21 maintains a challenging learning environment by sequencing the presentation of paired-associate items to balance items that a user is successful at providing a correct response to with items the user is less successful at providing a correct response to.

The Learn Module 21 also takes into consideration a physiological phenomenon known as consolidation in the presentation of items to be learned. Consolidation is the period of time immediately following learning where memories are most vulnerable to loss due to decay and interference. In first stage of memory formation, process oriented changes take place at the cellular level of the brain resulting in short-term memory. During consolidation, additional changes occur and result in actual structural modifications in the brain. This is prerequisite for long-term memory formation. Taking this into consideration, the Learn Module 21 presents items as many times as is necessary to achieve the desired degree of overlearning. In contrast, in the prior art, learning is judged to be completed when the user is able to recall the correct response to a cue the first time.

Overlearning suggests that the user can derive additional benefit from continuing to study an item learned to this level. One measure of overlearning is latency of recall. An item that is overlearned will be recalled not only correctly, but also quickly, indicating automaticity. Overlearning, however, is subject to the law of diminishing returns, which means that at some point the effort expended does not provide a justifiable benefit. Overlearning in the Learn Module 21 reduces the likelihood that memories will be lost during consolidation and that if no review were to follow, the likelihood of successful retrieval at some future date would be higher than if the items were not overlearned, as shown in FIG. 15, which will be described in more detail below.

As will be described in more detail below, all of the modules of the main engine 20 are preferably adapted to enable users to become better learners by training them to make more accurate metacognitive judgments. Judgment of learning, for instance, is a subjective evaluation made after a learning session in which a person judges whether an item was learned or not learned. In self-paced study, the decision as to whether to continue studying a particular item is often made based on the user's judgment of learning of that item. An inaccurate judgment will lead to either too much time, or too little time spent on an item resulting in less effective and efficient learning than would otherwise be possible if an accurate judgment were made.

In addition, in the Learn Module 21, it is preferable to provide a preview of knowledge or skills to be learned. In the preview, a background description or related information is provided before the actual cue and response items to be learned are presented. Such background information can include general information about a topic that is the subject of the cue and response items so as to provide some basis or context for learning, or what a user should keep in mind while learning, hints about the upcoming lesson itself or any other relevant information. The preview information can be text-based, graphics-based, auditory, or any other format. In addition, the preview can teach a user how to learn more effectively and efficiently before he learns, for example, by providing learning tools (pronunciation hints, study tips, what to pay attention to, etc.).

The Learn Module 21 preferably includes a Quick Review, which is presented at the end of lesson. Quick Review provides the user one or more opportunities to review difficult or unlearned items before that particular session of the Learn Module 21 is completed. Quick Review preferably reorders the presentation of items so as to eliminate the serial position effects of primary, recency, Von Restorff and other well known effects. In addition, it is possible in Quick Review to rearrange the cue and response items such that for each item, the cue becomes response and the response becomes the cue.

Preferably, items presented during Quick Review are sorted using the drop-out method. That is, if the user quickly indicates he is able to retrieve a correct response to presented cue, as measured by accuracy of recall and latency of response, the item is dropped out of the list of items being presented because the item is determined to be well known. The remaining items are then re-ordered and lesser known items are presented again. This continues until no items remain, or until some other criteria is met such as the completion of four rounds of Quick Review.

The re-ordering done during Quick Review is preferably based on an inside-out ordering to reduce the serial position effect. Primacy and recency effects cause items presented first and last to be learned better than items in the middle of the sequence. By turning the sequence inside-out in terms of presentation, the effects of primacy and recency are minimized ensuring that items originally presented in the middle of the sequence are learned to the level of items originally presented at the beginning or end of the sequence.

In the Learn Module 21, the ease of initial learning of each item can be determined by analyzing the drop-out scores. This is done by measuring how many times an item was presented and determining from this the relative difficulty of learning each item. This information is then used to place the item on the appropriate review curve (described later) which determines the initial schedule of review.

The Learn Module 21 is preferably interactive with the Review Module 22 and Test Module 23. More specifically, the ease of initial learning in the Learn Module 21 as described above is used to determine how to present items in the Review Module 22.

More specifically, preferred embodiments of the present invention use hopping tables, prediction curves and other mathematical correlations to accurately control interaction between the modules of the main engine 20. For example, a Learn hopping table is preferably provided and used to determine the initial schedule of presentation of items in the Review Module 22. Using the Learn hopping table, if an item was presented once in Quick Review, it is placed on an easy curve—one that schedules the review relatively infrequently. If an item was presented twice in Quick Review, it is placed on a medium curve. If an item was presented three times in Quick Review, it is placed on a hard curve—one which schedules review frequently. As will be described below, as a user begins reviewing the learned items using the Review Module 22, items will hop from curve to curve; the curves determine the items to present during each review session of the Review Module 22. The Review Module 22 has a hopping detect function which feeds back into a rule set used to determine which review curve the item is on and is used to reconfigure the hopping table rules in the Learn Module 21 for improving the effectiveness and efficiency of learning, reviewing, and testing in the future.

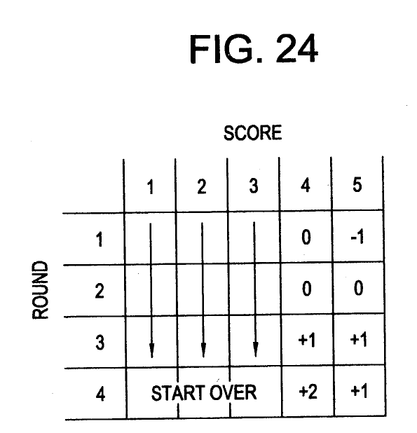

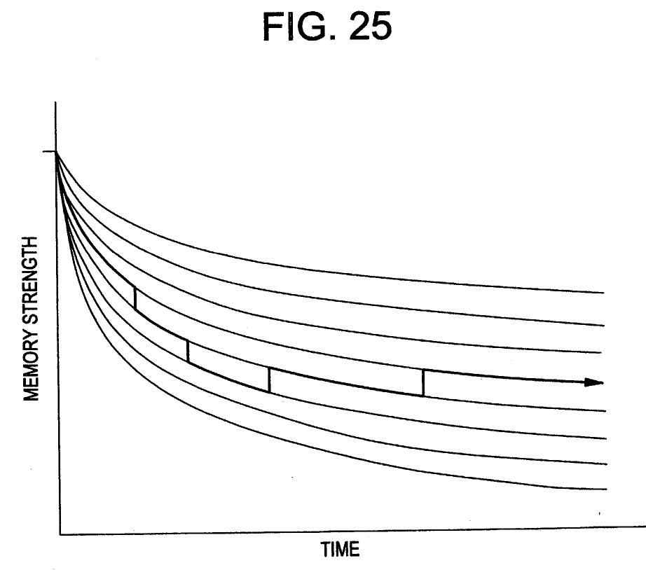

Since human memory decays differently for words, pictures, sounds, smells, skills and other types of information and depends on degree of difficulty in learning, retaining, and retrieving items, it is preferable to modify the curves to reduce hopping to more efficiently predict the decline of memory strength as a result of decay and interference. A plurality of families of curves may be used and arranged according to the characteristics of the curves. Such hopping tables and families of curves for review are shown in FIGS. 24 and 25 and will be described later. There are preferably several sets of hopping rules associated with each curve. The system 10 determines how many times an item has hopped between curves and will determine which curve included in which curve family minimizes hopping because too much hopping indicates poor prediction of decline of memory strength for that user and that item.

The function of the system 10 relating to the hopping rules and curves depends on the rate or level of retention chosen by the user or administrator. Different families of curves may be better at predicting items based on primary sensory modality or other factors. Also, the curves or families of curves may be chosen for use based on subject matter of content, gender, age, or each individual user since information about each user may be made available each time the system starts up. This information about how the user learns is then used by the system in each of the Learn Module 21, the Review Module 22, and Test Module 23.

With such data, it is possible to determine which items are more difficult to learn, retain and retrieve than other items based on data from many other users and to share that data with each specific user so as to affect how the Learn Module 21, the Review Module 22 and the Test Module 23 perform for that user.

II. The Review/Store Module:

The Review Module 22 preferably includes many different types of review formats including Normal Review, Ad Hoc Review, and Scheduled Review.

In a preferred method of the Normal Review of the Review Module 22, after a lesson has been presented by the Learn Module 21 and has been learned by a user, the system 10 prompts the user to indicate whether the lesson is to be reviewed in the future. If so, the system 10 places the lesson on a review schedule of the Review Module 22 for maintaining default retention rate for an indefinite period of time. If not, then no review schedule is created for that lesson. The user or administrator may change from “never reviewed” to “indefinite review,” or vice versa, at any time in the future. The user or administrator may also change the retention level from the default level to any other level at any time in the future for lessons or individual items.

The Schedule Module 25 schedules the appropriate time of learning, reviewing and testing of items based on a previously input desired date of completion as well as many other factors. The desired date of completion is the date by which the user desires all of the items to be known to a predetermined level of memory strength and activation, preferably to a level of automaticity. At the appropriate times, the system will indicate that the items scheduled for review are due to be reviewed and review proceeds as will be described below in more detail.

Scheduled Review of the Schedule Module 22 takes into account problems such as items learned later in the schedule have relatively higher activation and relatively lower strength than items learned early in the schedule which have relatively higher strength and relatively lower activation. Items that are more difficult to learn may be scheduled to be learned early in the overall schedule to provide them with the greatest number of review sessions to develop the desired degree of memory strength.

With Ad Hoc Review of the Review Module 22, a user can select a particular item or group of items to be reviewed at that moment. If the user conducts this review on an ad hoc basis instead of waiting for the review of the item or group of items scheduled for Normal Review, feedback based on Ad Hoc Review performance is used by the system 10 to reschedule future Normal Review, Scheduled Review and testing of this item in the Test Module 23.

Scheduled Review of the Review Module 22 arranges the presentation of items to be reviewed so as to increase memory strength of items learned later in the schedule and increase memory activation of items learned early in the schedule just prior to the date when the knowledge or skills are required.

Other factors which might be used by the Scheduled Review of the Review Module 22 to arrange presentation of items for review may include degree of difficulty, degree of importance, strength, activation and how user has interacted with the system 10 in the past.

In addition, Scheduled Review and Normal Review of the Review Module 22 preferably take into account graceful degradation and workload smoothing when arranging the presentation of items to be reviewed. Graceful degradation and workload smoothing are used if a schedule originally set is altered, for example, by a user missing a review session or moving ahead of the schedule set forth by the Review Module 22.

Because learning, reviewing and testing will be less effective and less efficient if a user simply doubles up on items to be learned, reviewed or tested because the user has missed a scheduled session, the system re-schedules Normal and Scheduled Review by re-ranking all items which still must be reviewed according to item importance, strength, activation, and other factors. This re-ordering can be done preferably using an Nth degree polynomial smoothing function. This re-ordering can also be conducted if the user, administrator, or system determines that the workload of any particular session is significantly greater or less than the sessions before or after it. It is desirable that the workload from session to session be as equal and uniform as possible to maintain the user's motivation, and to ensure the most effective and efficient learning, review and retrieval of knowledge and skills.

In each of Normal Review, Ad Hoc Review and Scheduled Review of the Review Module 22, items are presented for review in a manner that is similar to the presentation of items in the Learn Module 21 to the extent that latency of recall is measured and calculated. Based on the measured latency of recall and the user's quantitative judgment of the adequacy of his response to the presented cue, an item to be reviewed will either be maintained in the presentation group or dropped out of the review group in the Review Module 22. The process of sorting items continues until all items are reviewed to a level that is desired.

The time between presentation of a cue and presentation of a response in the Review Module 22 is preferably controlled according to user input, position of item within sequence of items to be reviewed, primary sensory modality, and other factors such as covert data taken from user, such as galvanic skin response, pupil diameter, blink rate etc. and other measured characteristics. The system, method and apparatus of preferred embodiments of the present invention also control the time between the presentation of one cue and one response pair and the next cue and response pair.

In addition, the presentation of each cue and response pair in the Review Module 22 relative to other cue and response pairs is controlled according to timing, sequence, and format of material to be presented. All of these factors vary over time based on user input, both overt and covert, to determine which items will be presented, as well as the sequence, pattern and timing of presentation.

III. The Test Module:

The Test Module 23 preferably includes several different types of tests of varying sensitivity including a test of familiarity, a test of recognition, a test of recall, and a test of automaticity. Through testing and the use of different types of tests in the Test Module 23, the system can determine whether an item is known to a user and to what degree an item is known (familiarity, recognition, recall, automaticity).

In the prior art, a typical test is a test of recall in which latency of response is not measured and is unimportant. In contrast, in the present preferred embodiment, latency of response is important and is measured and used to modify future operations of the various modules of the system 10.

The preferred test format is to use an alternative forced-choice test, preferably a five alternative forced-choice test in which a user must select one of the five alternatives presented in response to a presented cue. Although a five alternative forced-choice test is preferred, it is possible to change the number of forced-choice responses and type of test according to various factors such as what level of memory strength is being measured or for what purpose the test is being presented.

The Test Module 23 is important not only as a traditional measure of knowledge or measure of memory strength, but also because the testing in the Test Module 23 functions as another form of review. Test taking is another way for the user to learn, review, and to maintain motivation and interest in using the system 10.

In a preferred embodiment of the Test Module 23, an item to be tested is presented. First the cue is presented along with a question, “Do you know the answer?”. The user constructs a response, and then indicates his quantitative “feeling of knowing” by choosing one of a plurality of choices. In the preferred embodiment of the Test Module 23, a scale from 1 to 5 is presented, whereby 1 indicates that the user has no idea of the correct response and 5 indicates that the user is absolutely certain that he knows what the correct response is. Scores of 2, 3, and 4 are gradated between these two extremes. The time period from the presentation of the scale of 1 to 5 until the time that the user makes his choice is measured.

Then, a plurality of forced-choice responses (preferably five) are presented for the user to choose from. Only one of the presented responses is the correct response. The time period from the presentation of the plurality of responses to the time when the user selects a response is measured.

This time period is referred to as a measurement of latency of response. However, absolute latency is not an accurate indicator of the cognitive functioning of the user. Instead, relative latency is measured for each user by taking into account many difference latency periods, the order of presentation of alternative responses, the primary sensor modality of the items and other factors.

After the user has selected one of the alternative choices as his response, the user is required to rate his response by choosing one of a plurality of choices in response to a question “How confident are you in your response?” The time between the presentation of this question and the user's response is measured. The incorrect responses are removed from the screen, leaving the correct response and the cue displayed. If the correct response was selected, the cue and response remain for a period of time which is shorter than the period of time in which the cue and response remain if the user chose the incorrect response.

In addition to knowing whether a response was correct or incorrect, the user is provided with information about their metacognitive judgments of “feeling of knowing” and “confidence of response.” This information about metacognitive performance is only used to assist the user in improving his metacognitive abilities thus improving self-paced study skills and thereby making the user a better learner.

According to preferred embodiments of the present invention, items to be learned, reviewed or tested are presented in a sequence which is not determined by the user's metacognitive performance and perceived knowledge of those items, as is done in some conventional methods. That is, the sequence of the items in each group are presented to the user in each of the Learn Module 21, the Review Module and the Test Module 23 without ever querying the user as to whether the user thinks or perceives he knows the correct response or answer. Thus, the items to be learned, reviewed and tested are presented based on the predetermined grouping and sequencing of those items and the grouping and sequencing is not based on the user's perception as to whether the items are known or unknown.

It is preferred that the conditions of retrieval in the Test Module 23 most closely model the actual real world test or retrieval situations that the user is preparing for. Thus, the Test Module 23 is preferably configured to the form of the actual anticipated test or retrieval situations to enhance the retrieval practice effect. The act of retrieving an item from memory facilitates subsequent retrieval access of that item. The act of retrieval does not simply strengthen an item's representation in memory, it also enhances the retrieval process.

In terms of the presentation or sequence of items in the Test Module 23, it is preferred that the presentation of test items is based so as to reduce the process of elimination effect. This effect describes a method used by students to “learn” information early in a test that assists them in responding to items later in the test. In order to reduce or eliminate this effect, the most difficult and confusable items, for instance, are presented early in the test in the Test Module 23. Ordering of items is preferably based on difficulty, confusability and other suitable factors in the Test Module 23.

The measurements of latency of response for the feeling of knowing judgments and the confidence in response judgments, not the actual scores of feeling of knowing and confidence of response, are used for scheduling future learn, review and test activities in the Learn Module 21 and the Review Module 22.

The Test Module 23 is preferably adapted to modify or normalize the feeling of knowing and confidence of response choices. If a user selects only 3s, 4s and 5s, for instance, the system 10 will normalize such responses into a 1, 2, 3, 4, 5 scale. The absolute judgment is important, however, and valuable information can be obtained by measuring and calculating the relative values of the judgments as well.

For the review of missed items presented in the Test Module 23, the sequence is determined by the relative degree of difficulty of items. Degree of difficulty is determined by the correctness of the user's response, the latency of response in providing feeling of knowing and confidence of response judgments and is not based on the actual scores of feeling of knowing and confidence of response. Ordering the sequence of missed items on this basis creates higher memory strengths of items missed in the testing.

The system 10 can determine the user's motivation by monitoring the user's performance data in the Learn Module 21, the Review Module 22 and the Test Module 23, as well as system usage including a user's ability to adhere to a set schedule, how many sessions or days a user has missed, and other factors.

Based on relative motivation, determined as described above, the Test Module 23 preferably selects an item to be tested so as to increase a user's motivation and confidence. The Test Module 23 is also arranged to allow for use of testing as a form of motivation, to break up monotony, and to use test as form of review.

The date of tests in the Test Module 23, including using testing as a form of review, can be determined by the user, the system 10, the administrator, or other input sources. For example, a teacher may want to use a test in the Test Module 23 as a form of review when an actual classroom test will occur soon.

Test as a form of review is preferably done when the strength of items is relatively high and the activation is relatively low. A test as a form of review breaks up monotony, maintains a review schedule, allows a different form of retrieval practice, closely mirrors the conditions of an actual test, and may have a motivational influence. In addition, the scheduling of testing in the Test Module 23 as a form of review may be influenced by a user's performance in the Learn Module 21 or the Review Module 22. For example, if the user's performance in the Learn Module 21 and the Review Module 22 are less than desired, a test may be scheduled as an alternative form of review and also to increase motivation.

In addition, in the Test Module 23, the user, the administrator or the system can determine when a test should be administered. The Test Module 23 preferably takes into account all testing factors like time of day, gender, age, other personal factors including physiological measures, measures of attentiveness or other brain states and other environmental conditions. The Test Module 23 also takes into account the material to be tested, its difficulty, and other factors such as recency, frequency and pattern of prior exposure to material in the past.

After testing in the Test Module 23 further review and testing may be scheduled based on the performance in the Test Module 23. For example, items that were determined to be well known are tested and reviewed less in the future. Further, the system changes hopping tables for items to be reviewed and tested in the future based on latency of response, actual knowledge and other factors observed during the test.

Many different forms of tests may be used in the Test Module 23 including a test of recall, an alternative forced-choice test, and other types of tests. Latency of response is preferably measured when using a test of recall or alternative forced-choice test.

Also, items can be tested backwards and forwards in the Test Module 23. That is, the cue becomes the response and the response becomes the cue. Further, a distracter, which is an alternative forced-choice that is incorrect, may be used to increase testing difficulty. A distracter should be chosen from a group of similar items although not necessarily from the same lesson.

Also, confusable items are tested consecutively and may be used as reciprocal distracters. The Test Module 23 determines whether users are still confusing these items by analyzing latency of response, confidence, and by the user choosing the incorrect confusable response, rather than the correct response itself. Other factors may also be considered in determining whether items are confusable.

IV. The Schedule Module:

The Schedule Module 25 is preferably provided to interactively and flexibly schedule the operation of the Learn Module 21, the Review Module 22 and the Test Module 23. The preferred embodiments of the present invention are set up such that a user's performance in the Learn Module 21, the Review Module 22 and the Test Module 23 may affect operation of any of the others of the Learn Module 21, the Review Module 22 and the Test Module 23 to make learning, reviewing and testing more efficient and effective.

Furthermore, the Schedule Module 25 may schedule presentation of items in any of the Learn Module 21, the Review Module 22 and the Test Module 23 based on input information from the user, the administrator, the system or other input sources and other input information, including date of test or date that knowledge or skills are required, the current date, the start date, what knowledge or skills need to be learned between the start date and the test date, desired degree of initial learning and retention, days that study or learning cannot be done, how closely a person follows the schedule already created by the system, and many other factors.

That is, the system 10, and the Schedule Module 25 in particular, is responsive to user performance and user activity both within the system and in the real world.

The Schedule Module 25 schedules the presentation of items in the Learn Module 21, the Review Module 22 and the Test Module 23 by spreading the material out to reduce cognitive workload on a micro level and a macro level to maximize strength and activation of all items or skills on the predetermined date. In addition, the most significant way to drastically reduce the cognitive workload on the user or student is to eliminate the burden of scheduling, determining the pattern, sequencing, and timing of presentation, and presenting cues and monitoring responses in the Learn Module 21, the Review Module 22 and the Test Module 23, which the Schedule Module 25 does.

In one example of a preferred embodiment of the present invention, a user or administrator identifies content that is either already in the system or input thereto. The user or administrator, or system, may identify and input to the Schedule Module 25 the date of test or date that knowledge or skills are required, the desired level of retention, the starting date, dates where no activity will be done, time available during each study session, whether or not a Final Review is desired, how well the user can perform according to a schedule, how much time is required by the user to learn, review and test an item based on past performance, and other factors.

The system and more particularly, the Schedule Module 25 generates a customized schedule based on inputs from the user or administrator as noted above and any of the following factors: the spacing effect, strength, activation, when a lesson was initially learned, the degree of difficulty of items, the confusability of items or other factors upon which the Learn Module 21, the Review Module 22 and the Test Module 23 are based.

The Schedule Module 25 also preferably determines whether items are being scheduled for presentation during a Normal Zone, a Compression Zone or a Final Review Zone. In the Normal Zone, an average or normal schedule of learn, review and test is conducted since there is enough time remaining before the test date or the date that the knowledge or skills are required to achieve the desired degree of strength and activation. However, during the Compression Zone, the Schedule Module 25 must provide more opportunities to review items than in the Normal Zone. That is, the Schedule Module 25 treats items learned in the Compression Zone as though they are more difficult, increasing the number and type of reviews, so as to increase the strength of those items before the Final Review.

In addition, the Schedule Module 25 preferably uses workload smoothing to avoid any relative busy or easy study sessions for learning, reviewing and testing items. Graceful degradation also takes into account the user's actual use of the system 10. For instance, if the user skips one or more study sessions, or gets ahead of the schedule, or changes the date of the test, or makes other modification to the input factors, the Schedule Module 25 will recalculate the learning, reviewing and testing that must be conducted in the future to ensure the most effective and efficient use of time to develop the desired degree of strength and activation of knowledge or skills by the predetermined date.

V. The Progress Module:

The Progress Module 26 is preferably provided in the main engine to quantitatively monitor performance of other modules, most notably, the Learn Module 21, the Review Module 22 and the Test Module 23. As noted above, the progress in any one of the Learn Module 21, the Review Module 22 and the Test Module 23 may affect the scheduling and operations of any of the others of the Learn Module 21, the Review Module 22 and the Test Module 23.

In addition, it is important to give the user or student proper motivation and feedback regarding their metacognitive skills as described above, as well as their usage of the system. Thus, the Progress Module 26 evaluates in any of the Learn Module 21, the Review Module 23, the Test Module 23, and the Schedule Module 25 and other elements of the system such as the Discriminator Module 28.

VI. The Discriminator Module:

The Discriminator Module 28 is preferably provided in the main engine 20 and interacts with at least one and possibly each of the Learn Module 21, the Review Module 22 and the Test Module 23. The Discriminator Module 28 is designed to teach confusable items. Confusable items are two or more items that are somehow similar or easily confused by the user, particularly in retrieval.

Confusable items may be previously determined by the system or may be identified by the user, the administrator or the system during use of the system.

According to a preferred method of the Discriminator Module 28, confusable items are arranged in the Learn Module 21 such that a user learns the first and second confusable items and practices the ability to discriminate between the two.

If two items are confusable or difficult to discriminate, an aspect or feature of that item or items which increases discriminability should be identified and used to practice discriminating between the confusable items. Preferably the user, the administrator or system identifies the aspect or feature that allows the confusable items to be differentiated from each other using the Discriminator Module 28.

The Discriminator Module 28 is preferably set up to make the discrimination between the two confusable items as easy as possible. For example, visually similar items may be differentiated using a blink comparator which overlays and alternatively displays two items in the same position using different colors, shades, or graphical information to show clear differences between the two confusable items.

It should be noted that confusable items can be a pair of items to be learned or an item to be learned and another item that is not scheduled to be learned but is confusable with the item to be learned. In addition, there may be more than two confusable items which are identified and controlled by the Discriminator Module 28. However, it is preferred that the number of confusable items to be learned , reviewed and tested is two.

It is also preferred that the confusable pair is presented always in the same lesson set, review set and test set.

In addition to its applications to the Learn Module 21, the Discriminator Module 28 also preferably interacts with the Review Module 22 and the Test Module 23. For example, in the Review Module 22, confusable items may be reviewed together using the blink comparator. This may also be true at the end of a test in the Test Module 23.

Confusable items to be learned, reviewed or tested can be presented using a blink comparator or other suitable ways. For example, if items are visually similar, the cues and responses are shown together allowing the user a period of time to compare the two items which are confusable. A “blink” button is provided to initiate the presentation. The presentation includes displaying the first response for a period of time, then replacing the first response with the second response for a period of time, and then repeating this process. In this way, the images seem to “blink,” highlighting the most significant difference between the two. Further, it is preferred to change the rate of presentation of overlays, order of overlays, or other aspects of the blink comparator.

In addition, to further develop and retain the ability to discriminate between the confusable items, tests may be also be provided. When testing, a single cue is selected from one of the confusable items. All of the confusable responses are then presented. The user must choose the correct response to the presented cue. The correct response is then highlighted while the wrong responses disappear. This testing of each of the cues individually with the entire set of responses continues until the latency of responses and accuracy of responses reaches the desired criteria as shown in FIG. 27, which will be described in more detail below.

It is also possible in any of the Learn Module 21, the Review Module 22 or the Test Module 23 to change the presentation of confusable pairs by reversing the cue and response for each confusable pair until the user achieves a desired number of correct responses with a stable latency of response. Latency of response is preferably measured during use of the Discriminator Module 28 to determine relative latency and whether the actual relative latency is within desired limits. Also, alternative confusable pairs may randomly be dropped out of the sequence using criteria of performance and latency of response factors.

It is possible to use known confusable items as known items to take advantage of the spacing affect to schedule presentation of unknown confusable items. The unknown confusable items can be spaced out for presentation of these items for better learning of differences between the two confusable items and to practice how to discriminate between the two confusable items.

It is preferred that confusable items are presented together in each of the Learn Module 21, the Review Module 22 and the Test Module 23. That is, it is preferred that if the user, administrator or system identifies confusable items, the confusable items will always be learned, reviewed and tested together even if the confusable items are not part of the same lesson, review group, or test group. Confusable items are bound together until it has been determined by the user, the administrator or the system that the items are no longer confusable.

Now preferred embodiments of various applications and operation of the various modules of the system of FIG. 1 will be described.

FIG. 7 is a flowchart showing a preferred operation of the Learn Module 21 included in the system of FIG. 1.

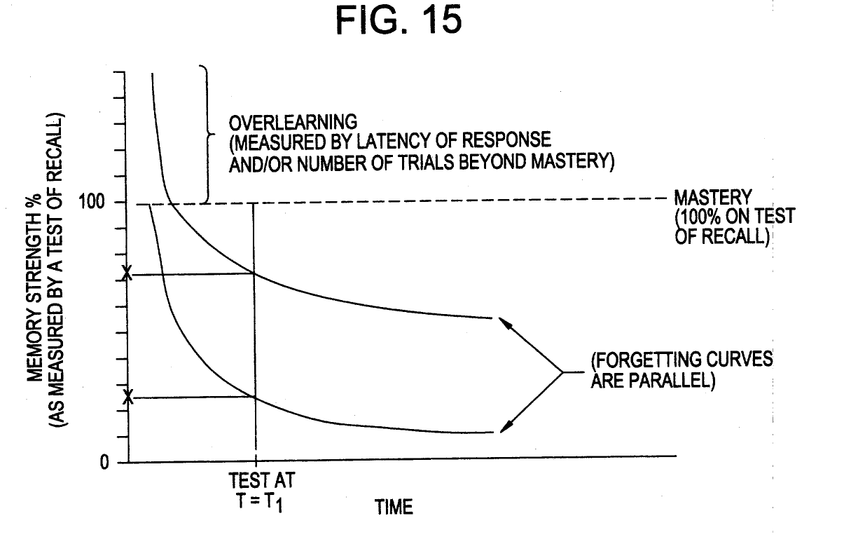

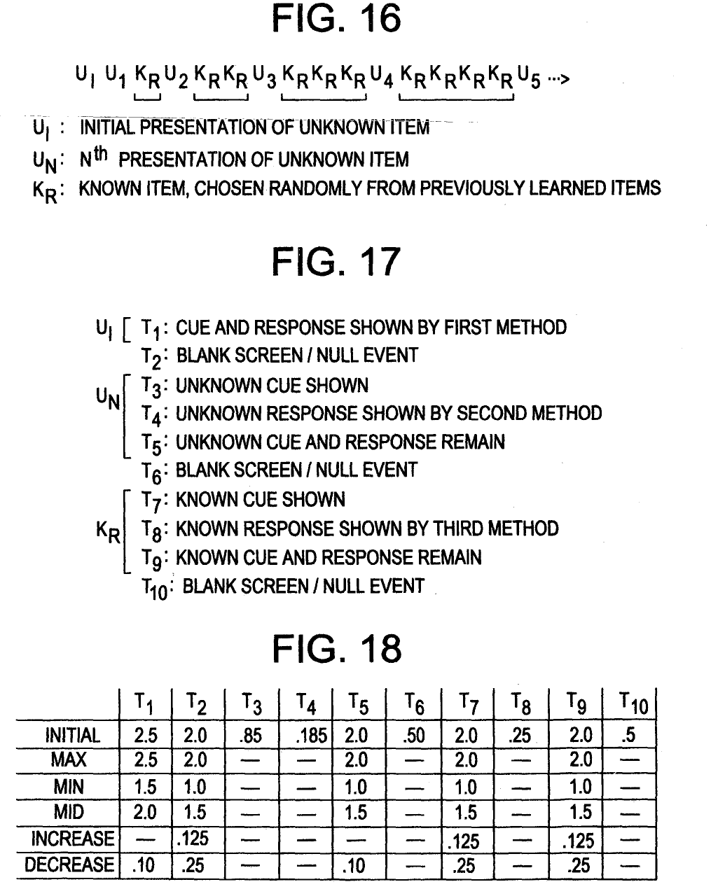

As seen in FIG. 7, a preferred embodiment of the Learn Module is operated such that a sequence of items to be learned, such as the sequence shown in FIG. 16, is generated at step 700. The Learn Module 21 begins at step 700 with the generation of a sequence of items to be learned and various timing parameters of presentation of those items. The timing between presentation of a cue and a response is determined for each of a plurality of paired-associates consisting of a cue and a response. In addition, the timing between the presentation of sets of paired-associates is determined at step 700. Other timing parameters such as those shown in FIGS. 17 and 18, described below, may also be determined at step 700.

After the sequence and timing of items to learned are generated at step 700, the display of items to be learned begins at step 702. First, an unknown cue and response are displayed or presented to the user at the same time, step 704. Then the display is cleared of the cue and response or nothing is presented to the user, step 706. A value of N is then set equal to 1, step 708. Then the cue of an unknown item U_{N} to be learned is presented or displayed, step 710. The response corresponding to the cue of the unknown item U_{N} is displayed or presented to the user, step 712. Then the cue and response of the unknown item U_{N} remain on the screen or are continued to be presented to the user, step 714. After this step, the screen is then cleared or nothing is presented to the user, step 716. A value of M is then set to 0, step 718. Then, a cue of a known item K_{M} is presented to the user or displayed, step 720, followed by the presentation of the corresponding response of the known item K_{M}, step 722. Then the cue and response for the unknown item K_{M} remain or are continued to be presented to the user, step 724. Then the screen is cleared or nothing is presented to the user, step 726.

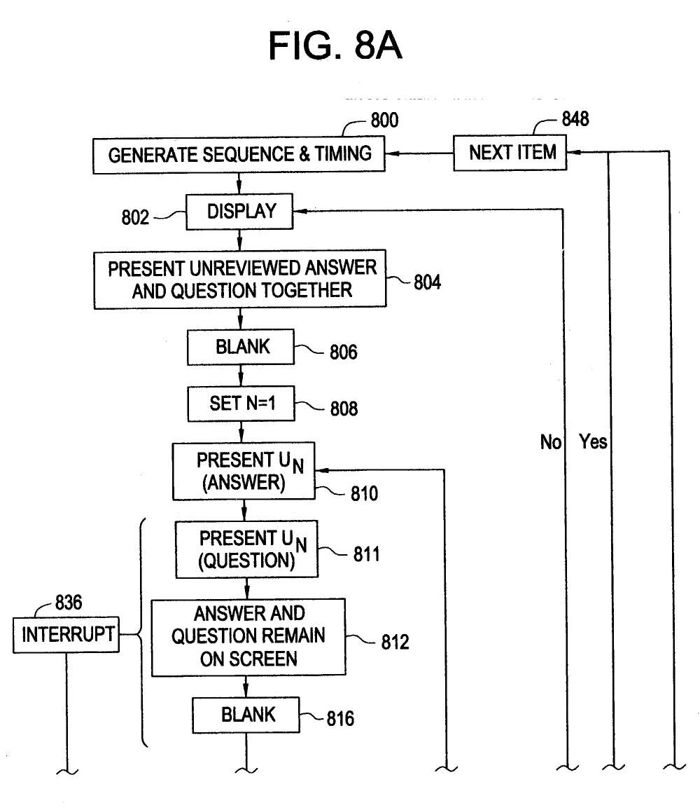

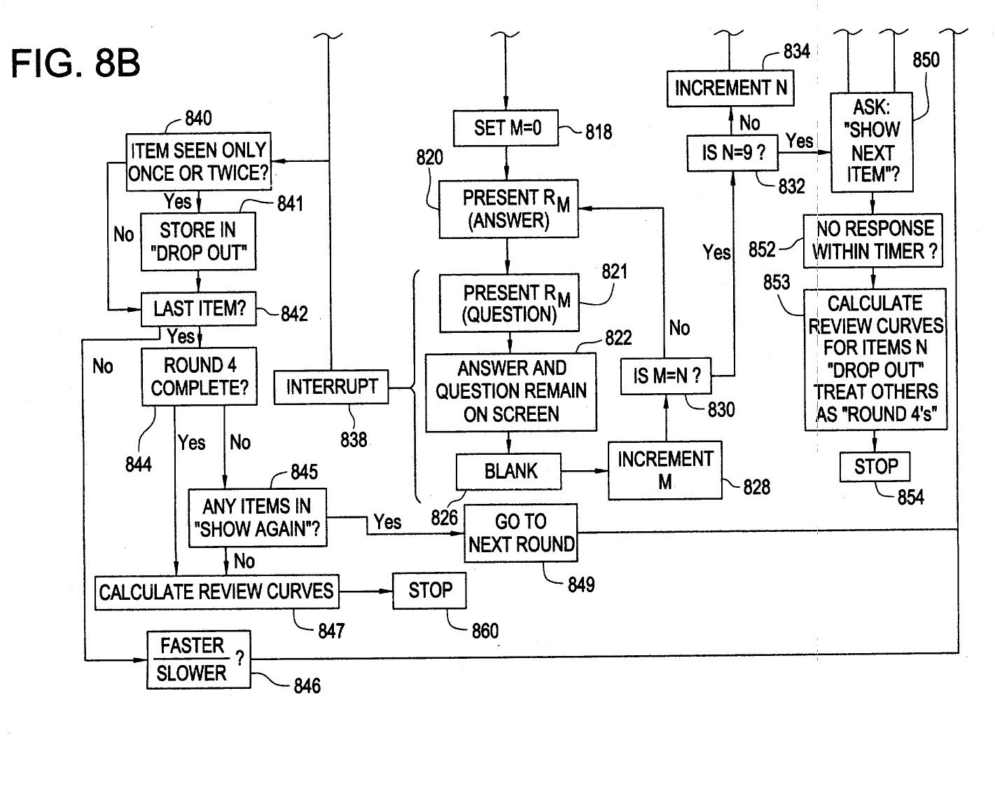

As shown by the interrupts at steps 736 and 738, the user can interrupt the flow from steps 712 to 716 and from steps 722 to 726, at any time. More specifically, if the user interrupts the process at any time between steps 712 to 716 or interrupts the process at any time between steps 722 to 726, the flow proceeds to step 740 at which an item is designated as having been learned and therefore, that item is stored as a known item in a “known” register. After the known item is stored, at step 740, a determination is made as to whether the last item has been learned, step 742. If the last item has been learned, the process flows to Quick Review, step 744, which is described in more detail with respect to FIG. 8. If it is not the last item to be learned at step 742, the user is queried as to whether they want to proceed more slowly or quickly, step 746, and then the process flows to step 748 where the next item to be learned is obtained and the flow returns to step 700 for generation of a new sequence for the next item to be learned.

If there is no user interrupt at steps 736 or 738, the process flows normally from step 726 where the display is cleared or nothing is presented to the user, to step 728 where the value of M is increased by 1. Then a determination is made whether M is equal to a value of N, step 730. If M is not equal to N, the flow returns to step 720 at which another known item K_{M} is presented to the user. If M is equal to N, a determination is made whether N is equal to some predetermined number, such as, for example, 9, step 732. If N is not equal to the predetermined number, the value of N is increased by 1, step 734, and the flow returns to step 712 for presentation of another unknown item to be learned U_{N}. If N is equal to this predetermined number, a user is asked whether he wants to see the next item, step 750. If a user chooses to see the next item to be learned, the flow returns to step 748 and 700 for presentation of more items to be learned. If a user chooses not to see the next item to be learned, the flow returns to step 702. If there is no response within a certain period of time, step 752, the process stops at step 754.

FIG. 8 shows a preferred embodiment of Quick Review that is part of the Learn Module 21 of the system 10 shown in FIG. 1.

As seen in FIG. 8, a preferred embodiment of Quick Review of the Learn Module 21 is operated such that a sequence of items to be Quick Reviewed is generated at step 800. The Quick Review of the Learn Module 21 begins at step 800 with the generation of a sequence of items that have just been learned and are to be Quick Reviewed, and the generation of various timing parameters of presentation of those items. The timing between presentation of a cue and a response is determined for each of a plurality of paired-associates consisting of a cue and a response. In addition, the timing between presentation of paired-associates is determined at step 800. Other timing parameters different from but similar to those shown in FIGS. 17 and 18, described below, may also be determined at step 800.

After the sequence and timing of items to Quick Reviewed are generated at step 800, the display of items to be Quick Reviewed begins at step 802. First, an unreviewed cue and response are displayed or presented to the user at the same time, step 804. Then the display is cleared of the cue and response or nothing is presented to the user, step 806. A value of N is then set equal to 1, step 808. Then the cue of an unreviewed item U_{N} to be learned is presented or displayed, step 810. The response corresponding to the cue of the unreviewed item U_{N} is displayed or presented to the user, step 811. After this step, the cue and response remain on the screen or are continued to be presented to the user, step 816. A value of M is then set to 0, step 818. Then, a cue of a reviewed item RM is presented to the user or displayed, step 820, followed by the presentation of the corresponding response of the reviewed item R_{M}, step 821. The cue and response remain on the screen or are continued to be presented to the user, step 822. Then the display is cleared or nothing is presented to the user, step 826.

As shown by the interrupts at steps 836 and 838, the user can interrupt the flow at any time between steps 811 to 816, and between steps 821 to 826. More specifically, if the user interrupts the process at any time between steps 811 to 816 or interrupts the process at any time between steps 821 to 826, the flow proceeds to step 840 at which a determination is made as to whether an item has been seen or reviewed only one or twice. If the item has only been reviewed one or two times, the flow proceeds to step 842, described later. If the item has been reviewed more than two times, the item is stored in the drop-out register, step 841, and then a determination is made whether the last item has been Quick Reviewed, step 842. If the last item has been Quick Reviewed, a determination is made whether four rounds of Quick Review have been completed, step 844. If four rounds of Quick Review have been completed, review curves, described later, are calculated, step 847 and the process stops at step 860. If four rounds of Quick Review have not been completed, a determination is made whether there are any items which have been stored in a “show again” register, step 845. If there are no items to be shown or reviewed again, the process flows to step 847 where review curves are calculated and then the process stops at step 860. If there are items to be shown or reviewed again, the process begins the next round of Quick Review, step 849, and the process flows to step 848 where the next item to be Quick Reviewed is selected. The sequence and timing of presentation for the next item to be Quick Reviewed is then generated, step 800.

If there is no user interrupt at steps 836 or 838, the process flows normally from step 826 where the display is cleared or nothing is presented to the user, to step 828 where the value of M is increased by 1. Then a determination is made if M is equal to a value of N, step 830. If M is not equal to N, the flow returns to step 820 at which another known item R_{M} is presented to the user. If M is equal to N, a determination is made whether N is equal to some predetermined number, such as, for example, 9, step 832. If N is not equal to the predetermined number, the value of N is increased by 1, step 834, and the flow returns to step 811 for presentation of another unknown item to be learned U_{N}. If N is equal to this predetermined number, a user is asked whether he wants to see the next item, step 850. If a user chooses to see the next item to be learned, the flow returns to step 848 and 800 for presentation of more items to be learned. If a user chooses not to see the next item to be learned, the flow returns to step 802. If there is no response within a certain period of time, step 852, the review curves are calculated for items in the “drop-out” register and other items are treated as if those items have been Quick Reviewed through all four rounds of Quick Review without dropping out and then the process stops at step 854.

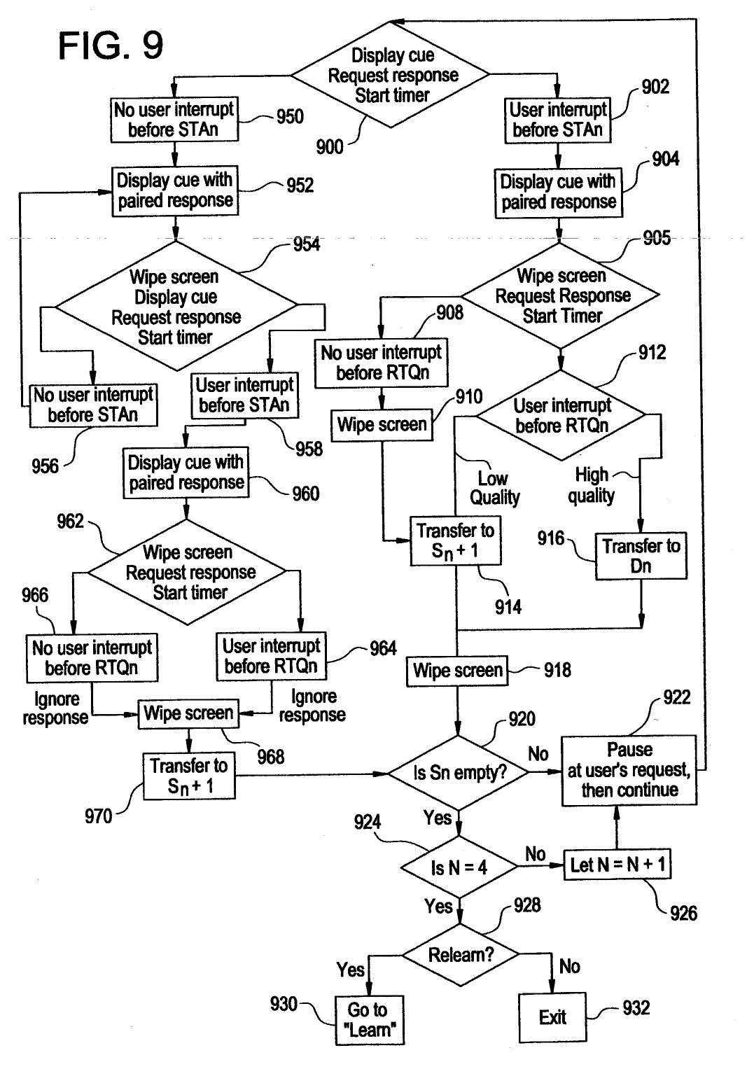

FIG. 9 is a flowchart for illustrating an operation of the Review Module 22 according to a preferred embodiment of the present invention. As seen in FIG. 9, the Review Module 22 begins by displaying a cue and asking a user whether he wants to see the answer yet, while also beginning a timer, as shown in step 900. During this time, the user is expected to construct or formulate a correct response to the cue presented in step 900. The user is expected to construct or formulate the correct response within a certain period of time, STAₙ. If a user interrupts the operation of the Review Module before the period of time STAₙ lapses, step 902, the cue is displayed with a paired response, step 904. Then the screen is made blank and a response to a query asking the user to quantitatively rate the quality of his response is requested while the timer is started, step 905. The user is expected to rate the quality of his response within a certain time period RTQₙ. If a user does not interrupt operation before the time period RTQₙ has lapsed by providing the rating of quality of response, step 908, the screen is made blank, step 910, and that particular item is transferred to a storage register Sₙ+1 and flow proceeds to step 920. Sₙ or Sₙ₊₁ represents a storage register where items for which the user either could not identify the correct response or had trouble in identifying the correct response as indicated by a low rating of the quality of his response, are stored for additional review in the future. The variable n in Sₙ or Sₙ₊₁ indicates the number of the pass or round of Review. If the user does interrupt the operation of the Review Module 22 after step 905, before the period of time RTQₙ has lapsed, by providing the response to the request for rating his response, step 912, a determination is then made whether the user has rated his response to be high quality (e.g. a value of 4 or 5) or low quality (e.g. a value of 1, 2 or 3). If a low quality response is provided, the control proceeds to step 914 described above so that the item receiving a low quality rating is stored for future review in the register Sₙ₊₁. If the user rates his response as high quality, the control proceeds to transfer to Dₙ at step 916 and then the screen is made blank at step 918 and flow proceeds to step 920. Dₙ represents a discard register where items that are well known to the user, as indicated by the high quality response, are stored and are not reviewed again in another round of the Review Module 22. At step 920, the determination is made whether Sₙ , the storage register with the items receiving low quality performance ratings, is empty. If Sₙ is not empty, meaning there are more items to be reviewed, the presentation may be paused at the user's request, step 922, and then control returns to step 900 for further operation. If Sₙ is empty meaning there are no more items to be reviewed, it is determined at step 924 whether N is 4. N is a value indicative of the number of rounds of Review, or can be thought of as the number of times a user has reviewed all of the items in the storage register Sₙ. If N is not 4, N is increased by one at step 926 and the flow returns to step 922 to return to the beginning at step 900 after a brief pause at step 922. If N is equal to 4 meaning the user has made four passes through Review, the user is asked if he wants to relearn all items that remain in the Sₙ register, step 928. If a user chooses to relearn a particular item, the flow is transferred to the Learn Module 21 at step 930. If a user chooses not to relearn an item, the control exits out of the Review Module 22 at step 932.

If the user fails to interrupt the Review Module 21 before the time period STAₙ has lapsed by failing to request that the answer or response be shown, step 950, the cue is displayed with the paired response at step 952. Then the screen is made blank, the cue is again displayed by itself, a response is requested and a timer is started, step 954, which is similar to step 900. If the user does not interrupt before the time period STAₙ lapses, that is the user did not request that the answer be shown, at step 956, the flow returns to step 952 in which the response is shown with the cue. If the user does interrupt before the time period STAₙ lapses, step 958, the cue is displayed with the paired response, step 960, and the flow proceeds to step 962 at which point the screen is made blank, a response for rating the quality of response is requested and the timer for timing the time period RTQₙ is started. If a user interrupts before the time period RTQₙ lapses, that is before the user rates the quality of his response, step 964, the response is ignored and the screen is wiped blank at step 968. If the user does not interrupt before the question is repeated at step 966, the response is ignored and the flow proceeds to step 968. The response is ignored in both cases because it has already been determined that this particular item should be reviewed again. Then the item is placed in the register Sₙ₊₁ at step 970 and flow proceeds to step 920, and further processing occurs as described above.

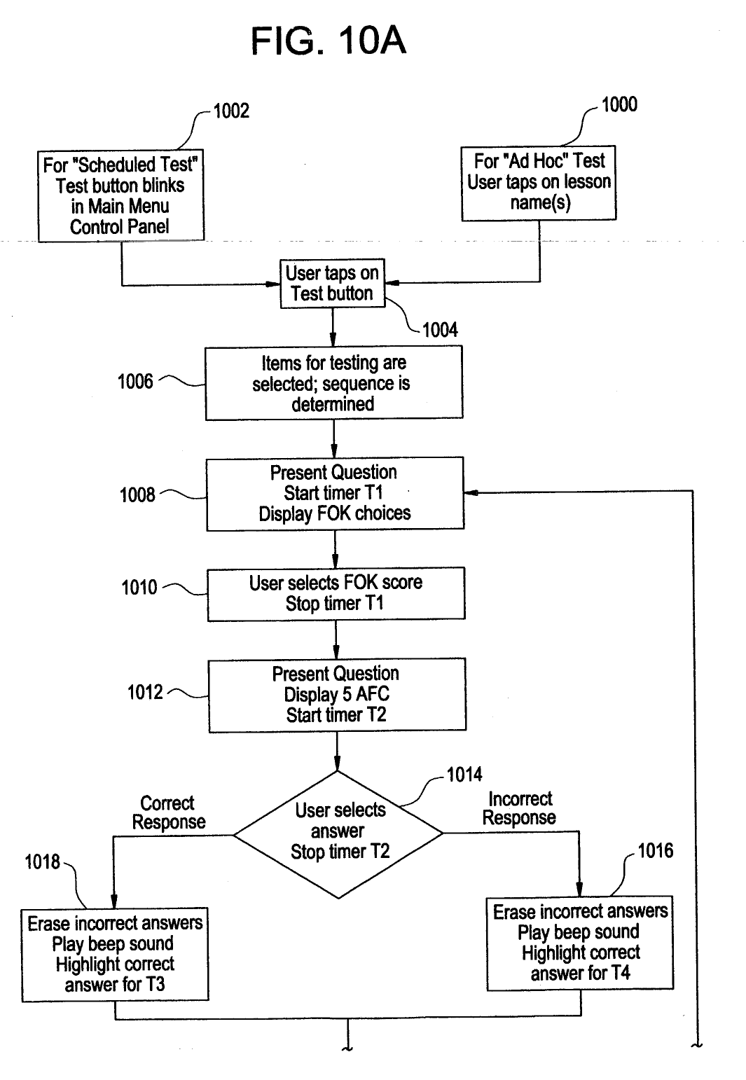

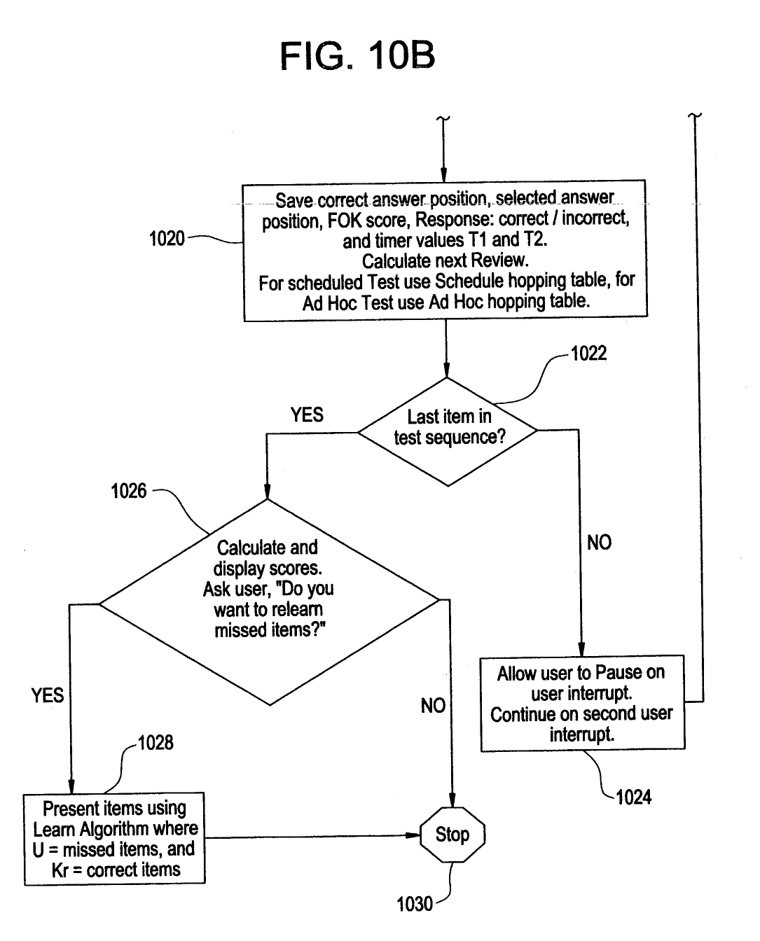

FIG. 10 is a flowchart for illustrating an operation of the Test Module 23 according to a preferred embodiment of the present invention. As seen in FIG. 1 0, the Test Module 23 begins by the user selecting an Ad Hoc Test, step 1000 or by the system 10 displaying a test button in the main menu display, step 1002, for a Scheduled Test. Then the user selects or taps on the test button on the display, step 1004, and the items for testing are selected and a sequence of items to be tested is generated, step 1006. The first cue of the items to be tested is then presented and a timer is started, step 1008. In this preferred embodiment, the user is asked to select a “feeling of knowing” score, for example, by indicating on a scale of 1 to 5 how confident the user is that he knows the correct response to the cue. The user selects the feeling of knowing score and the timer is stopped at step 1010. Then the cue is displayed with preferably 5 alternative forced-choices and a second timer is started, step 1012. The user then selects one of the 5 alternative forced-choices and the second timer is stopped, step 1014. If the response selected by the user is correct, the incorrect answers are eliminated from the display and an audible signal is produced and then the correct response is highlighted and shown for a time T3, step 1018. If the response selected by the user is not correct, the incorrect answers are eliminated from the display and an audible signal is produced and then the correct response is highlighted and shown for a time T4, which is longer than time T3, step 1016. Then the correct answer position and the selected answer position are saved as are the feeling of knowing score and the accuracy of response, step 1020. Then it is determined whether the item just tested was the last in the sequence of items to be tested, step 1022. If there are more items to be tested, the user is allowed to pause and then the operation returns to step 1008 for testing of more items, step 1024. If there are no more items to be tested, the test scores are calculated and displayed, and a user is asked if he wants to relearn the items that for which the user selected the incorrect response, step 1026. If a user chooses to relearn missed items, the missed items are relearned using the Learn Module 21, step 1028, as described above. If the user chooses to not relearn missed items, the Test Module stops, step 1030.

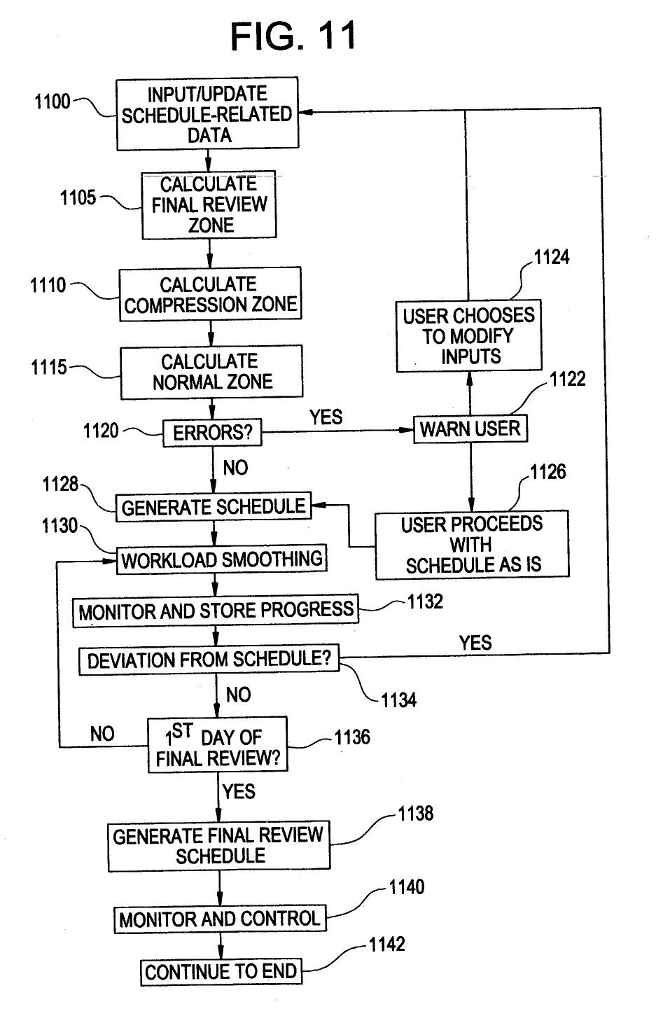

FIG. 11 is a flowchart of an operation of a preferred embodiment of the Schedule Module 25 preferably provided in the system of FIG. 1. The Schedule Module 25 begins at step 1100 at which information relating to the Schedule Module 25 is input or updated. The information to be input at step 1100 may preferably include the start date, the end date, the lessons to be learned, reviewed and tested, the types of lessons, the desired level of retention, the amount of time each day that the user is available to use the system, the number of final reviews, the time available for final reviews, the user's history of system usage, black out days when use of the system is not possible, and other factors and information. After this information is input at step 1100, the final review zone is calculated at step 1105 so as to determine the start date and end date of the final review period. Then the compression zone is calculated at step 1110 to determine when the compression period begins and ends. After this, the normal zone is calculated at step 1115 to determine the start and end dates of the normal period. Then the system 10 checks for the presence of scheduling errors at Step 1120. Scheduling errors include the scheduling of too many items within too short of a time period based upon the demonstrated ability of the user or other input. Other errors may also be checked for. If scheduling errors are detected at step 1120, a warning is issued to the user at step 1122. If a user chooses to modify the input information to avoid such scheduling errors at step 1124, the flow returns to step 1100 to begin the Schedule Module 25 again and re-calculate the schedule. If a user chooses to proceed with the Schedule Module 25 despite the presence of scheduling errors at Step 1120, the flow proceeds to generate a schedule at step 1128. As described above, the schedule is generated based on the input information including the user's past history and usage of the system 10 and ability to comply with previously generated schedules. After a schedule is generated at step 1128, the schedule is checked for workload smoothing at step 1130 to avoid any session or day in which too much work or not enough work is scheduled relative to the preceding or following days. The schedule may be modified at step 1130 to achieve sufficient workload smoothing. Then, the user's progress with the system and specifically, the user's ability to comply with the generated schedule is monitored and stored in the system at step 1132. The system detects at step 1134 whether there is any deviation from the schedule generated at step 1128. If there is any deviation from the schedule, the control returns to step 1100 for re-calculation of the schedule to accommodate and compensate for such deviations. If there is no deviation from the schedule, the flow proceeds to step 1136 in order to determine if the final review start date has arrived. If the final review start date has not arrived, the flow returns to step 1130 to further monitor progress and to detect any deviations from the schedule. If the final review start date has arrived, the Schedule Module 25 generates a final review schedule based on relative difficulty of the items, the recency, the frequency, the pattern of prior exposure and other factors, step 1138. The user's performance in final review is monitored and controlled at step 1140 until the end date at which time the Schedule Module 25 ends, step 1142.

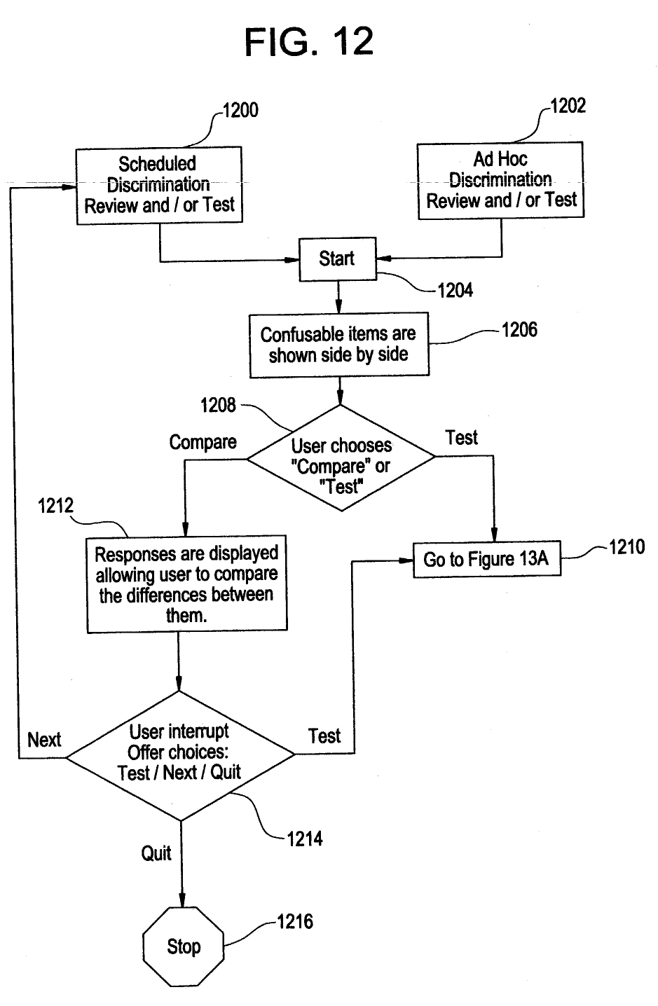

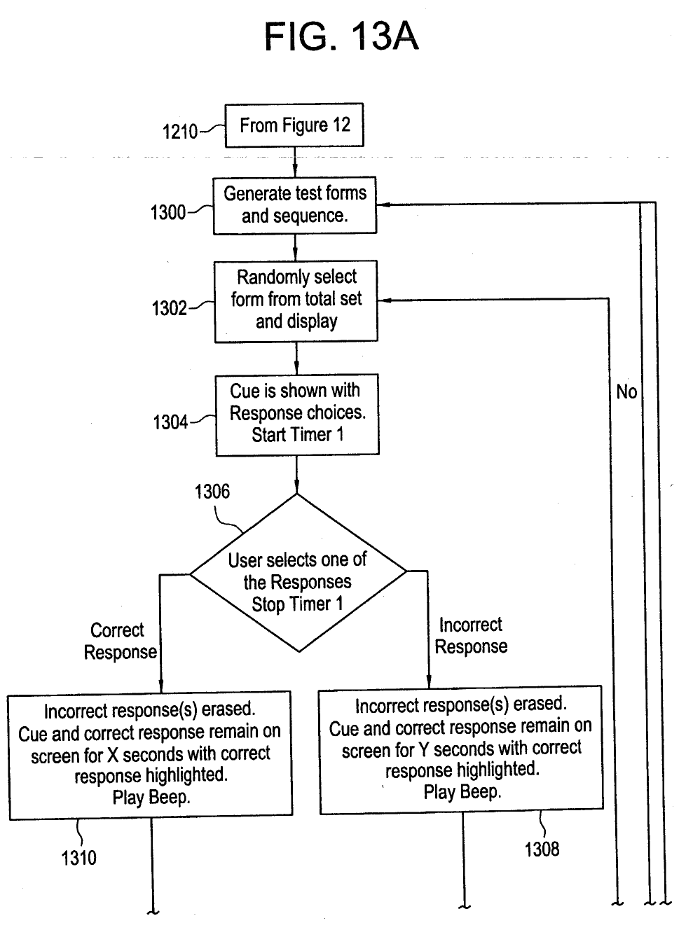

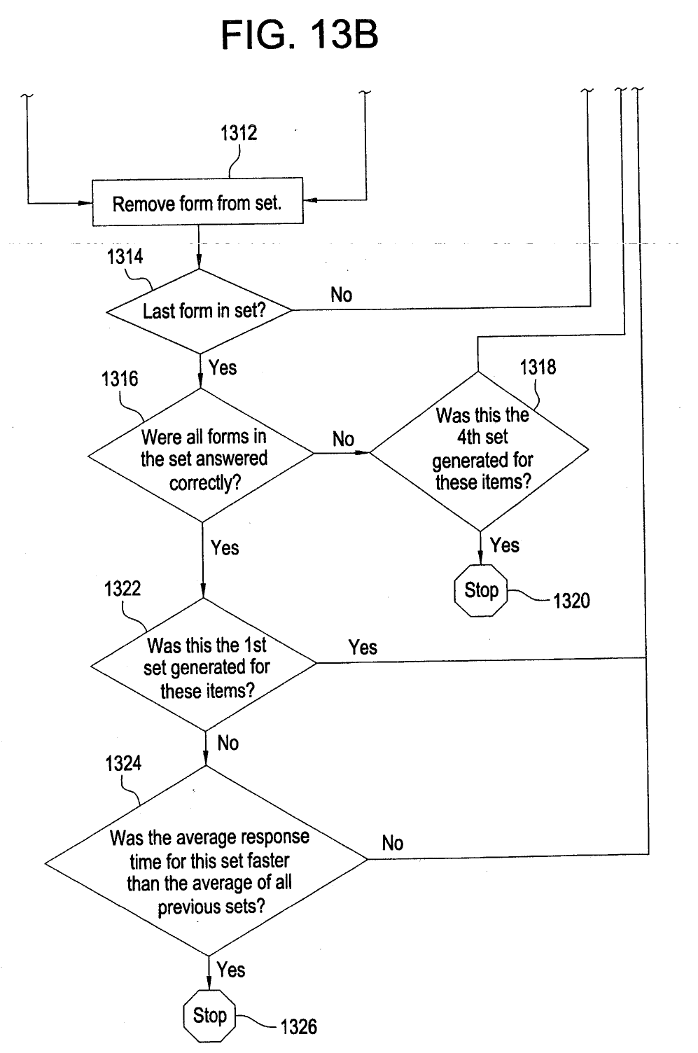

FIGS. 12 and 13 show a flowchart of an operation of a preferred embodiment of the Discriminator Module 28 preferably provided in the system 10 of FIG. 1. The Discriminator Module 28 begins with either a Scheduled Discrimination review or test, step 1200, or with an Ad Hoc Discrimination review or test, step 1202. The process then begins at step 1204 and confusable items are displayed or presented to a user in a side-by-side or closely associated presentation, step 1206. The user then decides whether to compare the confusable item or to be tested on their knowledge of the confusable items, step 1208. If the user chooses to compare the confusable items, the responses of the confusable items are displayed or otherwise presented to the user to allow the user to compare and discriminate differences between the confusable items, step 1212. If a user interrupts this process, step 1214, the user is provided the choice of being tested, moving to the next item or quitting operation of the Discriminator Module 28. If a user chooses a test at step 1214, the flow proceeds to step 1210. If the user chooses to end operation of the Discriminator Module 28 at step 1214, the operation of the Discriminator Module 28 stops at step 1216. If a user chooses to move to the next confusable item, the flow returns to steps 1200, 1204 and the next group of confusable items is presented at step 1206.

At step 1208, if the user chooses to be tested on the confusable items, the flow proceeds to step 1210 and the process shown in FIG. 13.

As shown in FIG. 13, if a user chooses to be tested on confusable items, test forms and sequences are generated at step 1300. Then various test forms are selected from the total set of test forms for use in presentation to the user, step 1302. Then a cue is presented to the user with various response choices and a first timer is started, step 1304. Then a user selects the response he believes to be the correct one and the first timer is stopped, step 1306. If the response is correct, the incorrect responses are removed from the display and the cue and correct response remain displayed for a certain period of time X with the correct response being highlighted and an audible signal is presented, step 1310. If the response is not correct, the incorrect responses are removed from the display and the cue and correct response remain displayed for a certain period of time Y, longer than the period of time X, with the correct response being highlighted and an audible signal is presented, step 1308. Then the test form is erased or removed from the display, step 1312. A determination is then made if the last test form has been presented to the user, step 1314. If there are more test forms to be presented to the user, the control returns to step 1302 for presentation of more test forms for testing confusable items. If there are no more test forms to be presented to the user, a determination is made whether all of the test forms were answered correctly, step 1316. If not all of test forms were answered correctly, a determination is made whether it is the fourth set generated for the particular items being tested, or the fourth time that those particular confusable items were tested, step 1318. If it is not the fourth set or fourth time, the control returns to step 1300 for generation of another set of test forms. If it is the fourth set or fourth time, the process stops at step 1320. If all of the test forms were answered correctly as determined at step 1316, a determination is made whether it is the first set or first time that the set of test forms was generated for this particular group of confusable items, step 1322. If it is the first set or first time, the control returns to step 1300 for generation of another set of test forms. If it is not the first set or first time, a determination is made as to whether the average time for response for the current set of test forms is shorter or less than previous time for response, step 1324, and if so, the process ends at step 1326. If the average time for response for the current set of test forms is greater than or equal to the previous time for response, the flow returns to step 1300 for generation of another set of test forms.

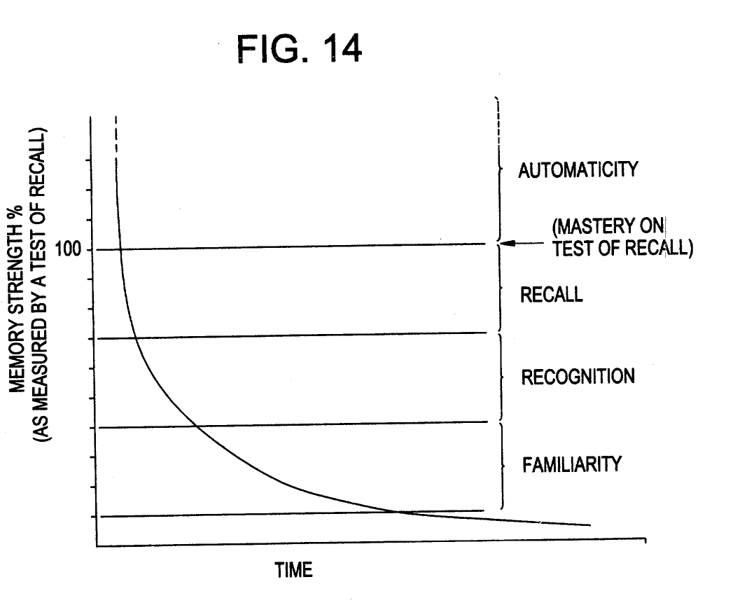

The sequence of items to be learned in the Learn Module 21 generated in step 700 of FIG. 7 may be generated based on the input desired degree of initial learning or level of learning. FIG. 14 shows various levels of learning possible in the system 10 of preferred embodiments of the present invention, along with a graph of memory strength versus time that includes the forgetting/retention curve shown in FIG. 3. As seen in FIG. 14, four levels of learning are located at various points along the forgetting/retention curve shown in FIG. 3. In the order of lowest learning level to highest learning level, the four levels of learning are: familiarity, recognition, recall and automaticity.

Information learned or remembered to the level of familiarity is information that the user has the feeling that they knew at one time, but can no longer remember.

Information learned or remembered to the level of recognition is information that the user can separate from other distracting choices or distracters. When presented with a cue, the user can choose the appropriate response from a number of alternatives. For example, the user may be asked select the correct answer on a multiple-choice test.

Information learned or remembered to the level of recall is information that the user can retrieve when only a cue is presented. For example, the user may be asked o provide the correct response to a provided cue on a “fill in the blank” test.

Information learned or known to the level of automaticity is information that the user can retrieve instantly, with little or no cognitive effort, when only a cue is presented. The user “knows” the information as opposed to “remembers” the information. Automaticity can be measured by a test of recall where accuracy is required and latency of response is the key variable.

As shown in FIG. 3 and described above, previously learned items such as knowledge or skills, are gradually forgotten over time. The higher the level of initial learning, the longer the information is available for retrieval. Learned information passes down through the various levels until it is only familiar.

Different types of tests have varying degrees of sensitivity. A student could answer a question correctly on a multiple-choice test, but miss the same question on a test of recall. Therefore, a test of recognition is less sensitive test of memory strength than a test of recall. Similarly, a test of recall is a less sensitive measure of memory strength than a test of automaticity.

In preferred embodiments of the present invention, the items to be learned are presented in the sequence generated in step 700 of FIG. 7 in such a way that the user learns to a level of automaticity. The benefits and processes for learning to a level of automaticity will be described below.

In order to have a user learn to a level of automaticity as shown in FIG. 14, the system 10 presents items to be learned by taking advantage of the principle of overlearning as shown in FIG. 15. More specifically, FIG. 15 shows the benefits of overlearning. The degree of initial learning affects future performance as described above. The decay rate for memory is approximately parallel for various degrees of initial learning as shown by the parallel curves in FIG. 15. Material learned to a level of mastery (100% correct on a test of recall) is forgotten at the same rate as overlearned material (100% correct on a test of recall, with low latency of response and low cognitive effort). Since both curves in FIG. 15 are substantially parallel, however, at any point in the future, retrieval performance is higher for overlearned material. Additionally, material that is initially overlearned to a level of automaticity is more likely to survive the initial, fragile period of consolidation where most memories are lost due to decay and interference.

The parallel nature of the curves in FIG. 15 is independent of the time schedule. Material learned to a higher degree of initial learning has a higher memory strength than material learned to a lower degree of initial learning even when measured decades later.

For generating the sequence of items to be learned at step 700 of FIG. 7, the system 10 preferably determines a sequence of items to be learned and a time period between a presentation of a cue and a response of a paired-associate and a time period between presentation of successive paired-associates to achieve learning to a level of automaticity shown in FIG. 14 by using overlearning shown in FIG. 15. More specifically, the items to be learned in the system 10 are preferably arranged according to a learn presentation sequence shown in FIG. 16. As seen in FIG. 16, Items (cues and responses) presented in the Learn Module 21 of the system 10 are sequenced according to whether they are items to be learned or are items that have already been learned. In FIG. 16, items being presented for the first time are designated as U_{I} where I indicates that it is the initial presentation of the unknown item. That same item seen again and again is designated as U_{N}, where N is the number of times that the item has been previously seen within the sequence. Items which have already been presented during previous Learning Module 21 operation are considered to be “known” for the purposes of sequencing and are designated as K_{R}, where the R indicates that they are items chosen randomly from the pool of known items.

By creating a sequence of known and unknown items as shown in FIG. 16, a form of expanded rehearsal for the unknown item is created. As mentioned previously, the expanded rehearsal series is the most effective and efficient schedule of review to build memory strength. In experimental psychology, this is known as the spacing effect. The sequence shown in FIG. 16 creates an intra-trial spacing effect. The schedule of review described in FIG. 4 creates an inter-trial spacing effect.

At some point during the presentation of the sequence shown in FIG. 16, the user will determine that they have learned the previously unknown material by comparing the adequacy of their response to the cue with the correct response provided by the system 10. When the user judges that their response is adequate, the user interrupts the presentation sequence. This interrupt will take the user to the next unknown item to be learned if any remain in the lesson, or to a Quick Review session if all items within the lesson have been seen.

FIG. 17 illustrates a learn presentation pattern for the presentation of the items described in FIG. 16 which is broken down and described in further detail in FIG. 17.

At the beginning of the sequence, the unknown item to be learned within the sequence is presented as U_{I}. Both the cue and the response are presented at the same time (T₁).

The cue and response disappear leaving a blank screen, or depending upon the modality of presentation of the information, a null event—one where nothing happens (T₂).

Now the unknown item is displayed or presented by itself. At this time, the user absorbs the cue and attempts to actively recall the appropriate response (T₃).

Whether the user is successful in retrieving the response or not, the correct response is presented using a method that may be the same as the method of presenting the known response, but preferably is unique to the presentation of the response to be learned. The method of presentation could involve color, sound, motion or any other method that differentiates it from the presentation of the randomly-chosen known response. The time that it takes to present the response using the defined method is called T₄.

Both the cue and response continue to be presented. The user uses this time (T₅) and the time available in T₄ to compare the response that the user retrieved to the correct response. If their response is judged adequate, the user can interrupt the sequence and move on to the next unknown item to be learned.

Following T₅, both the cue and response are eliminated leaving a blank screen or null event (T₆).

Now a known item is selected from the group of previously learned items. It is presented by first displaying the cue for a short period of time (T₇) allowing the user to attempt to actively recall the correct response, then the correct response is shown according to a method that may be the same as the method of showing the unknown response, but preferably is unique to the presentation of known responses (T₈). Both the known cue and known response remain presented for a period of time (T₉), and then both are eliminated for another period of time or a null event (T₁₀).

The presentation pattern of showing unknown cues and responses and known cues and responses separated by null events preferably follows the sequence described with respect to FIG. 17 until the user interrupts the sequence at allowable times as described in FIG. 7 or some other event occurs such as predefined time or number of presentations is reached.

FIG. 18 shows a table indicating the presentation timing preferably used in the Learn Module 21. There are preferably ten separate timing variables used as shown in FIG. 18, which preferably vary according to the position of the unknown or known cue or response within the sequence of items shown in FIG. 16. The timing parameters are set at an initial value and then are changed according to overt and covert responses input to or sensed by the system 10. One overt response to the system 10 occurs when the user interrupts the presentation sequence because he wishes to learn a new item. At this point the question is asked, “Do you wish to go faster or slower?” in order to maintain the attention and arousal of the user. If the user responds by choosing “faster” the timing values are decreased by the amount defined within the table for that timing parameter. If the user responds by choosing “slower”, the timing values are increased by the amount defined within the table for that timing parameter.

The purpose of varying the timing values is to maintain the user's attention and arousal. Timing sequences where there is little or no variation in the stimulation can become habituating. That is, the stimulus is no longer novel and the brain tunes it out.

Additionally, each user has a desired rate of learning determined by the rate of presentation of each item as well as the rate at which new items are presented. In the classroom, when the teacher is lecturing, all students are presented information at the same rate. Some students find this boring because the presentation is too slow, and others find it frustrating because the presentation is too fast—they are left behind.

In the system 10 described above, the pattern, sequence, and timing of items are varied to maintain the user's interest, and provide each individual user with a rate of learning that each user finds challenging. Thus, the system 10 adapts to each user.

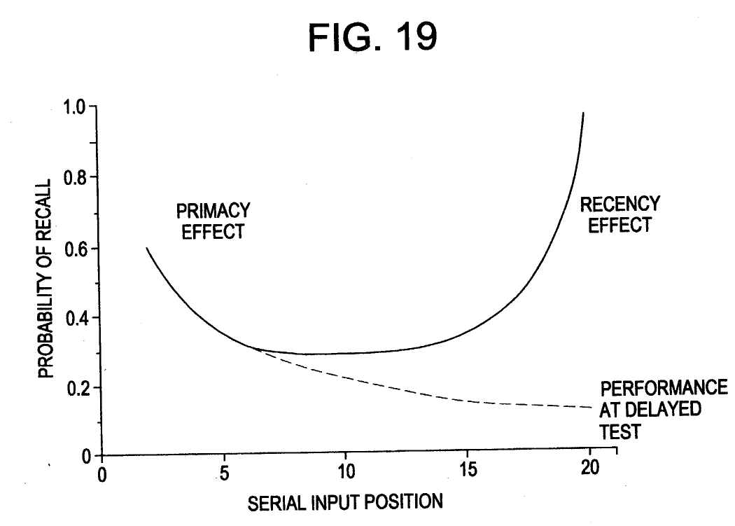

Also related to the sequencing of the items to be learned is a phenomenon knows as the serial position effect. FIG. 19 illustrates the serial position effect that is a well understood phenomenon of psychology and involves the learning of items presented in a list. FIG. 19 shows that when items are presented in a list, the probability of successful recall varies based on the item's position within the list. If the recall test is administered immediately prior to the learning session, a recency effect is shown. That is, items presented later in the list are more likely to be recalled than previously presented items because the later presented items are still in the user's short-term memory. If the recall test is administered after a delay of several minutes, the recency effect disappears because the items cannot be maintained in short-term memory for that period of time without rehearsal. This effect contributes to judgment of learning errors that detrimentally affect self-paced learning.

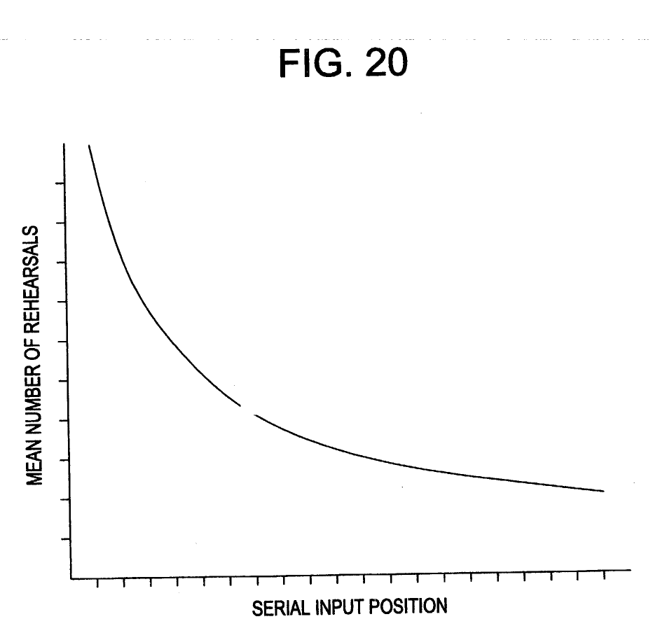

Items appearing early in the list are more likely to be recalled because of the primacy effect. Items appearing early in the list are more likely to be rehearsed a greater number of times than items later in the list as shown in FIG. 20. The success in recalling items from the list is dependent upon the number of times the item was rehearsed.

More specifically, FIG. 20 shows a graph of the number of Rehearsals vs. Input Position of an item to be learned. FIG. 20 illustrates the veracity of the statements made in the description of FIG. 19 regarding the primacy effect. Items presented early in a list are rehearsed more times than items presented later in the list and are therefore more likely to be recalled at the time of the test.

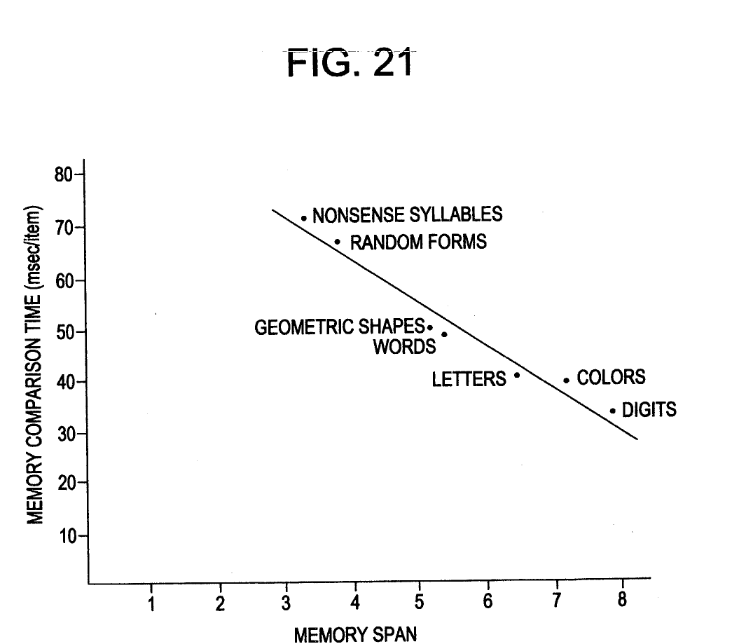

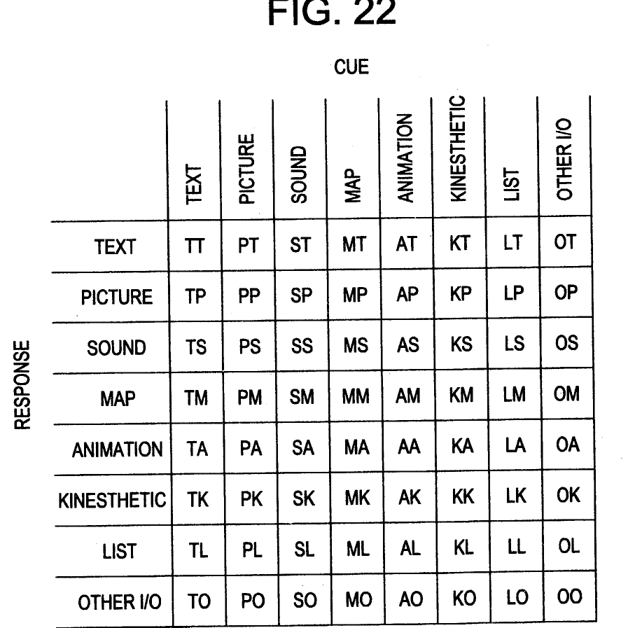

FIG. 21 shows a graph of memory comparison time versus memory span. FIG. 21 indicates that the memory span for information varies by the type of information. Memory span for digits is approximately seven plus or minus two digits. That is, most people can keep seven plus or minus two digits in their short-term memory through the process of maintenance rehearsal—they repeat them over and over. The rate at which a person can repeat a particular type of information directly affects their span for that type of information. This rehearsal rate varies from person to person. Generally speaking, adults can maintain more items in short-term memory than children because their rehearsal rates are faster. Also, the language that a verbal item is rehearsed in affects the memory span. For example, when rehearsing digits, speakers of Chinese can maintain more items in memory than speakers of Welsh. Likewise, memory span for images, sounds, and graphical information will vary from person to person. This phenomenon and those shown in FIGS. 19-21 are taken into account within the system 10 by the use of the modality pairing matrix shown in FIG. 22 which is used to define parameters associated with the sequence and pattern, and in particular, the timing of presentation.

FIG. 22 shows a modality pairing matrix in which the response follows the cue preferably by about 250 milliseconds to about 750 milliseconds is a general guide for maximum conditioning. Some information takes more time to be absorbed than others. The differences in time for encoding and storage of information are a result of the input channel or the primary sensory modality, the complexity of the material, the familiarity of the material, distractions to the use of the system by outside conditions, and many other factors. FIG. 22 describes the flexibility of the system 10 in handling materials presented in any combination of sensory modalities and information formats in both the cue and the response. The system 10 has predefined parameters for the presentation pattern, rate, and sequence for each combination of cue and response described in FIG. 22. These parameters may be modified by the user, administrator, or system 10 in order to create maximum conditioning adaptive to each user for each item learned.

Now preferred embodiments of the Review Module shall be discussed. As described with respect to FIGS. 3 and 4, the Review Module operates based on the forgetting/retention function and spaced rehearsal series shown in FIG. 4.

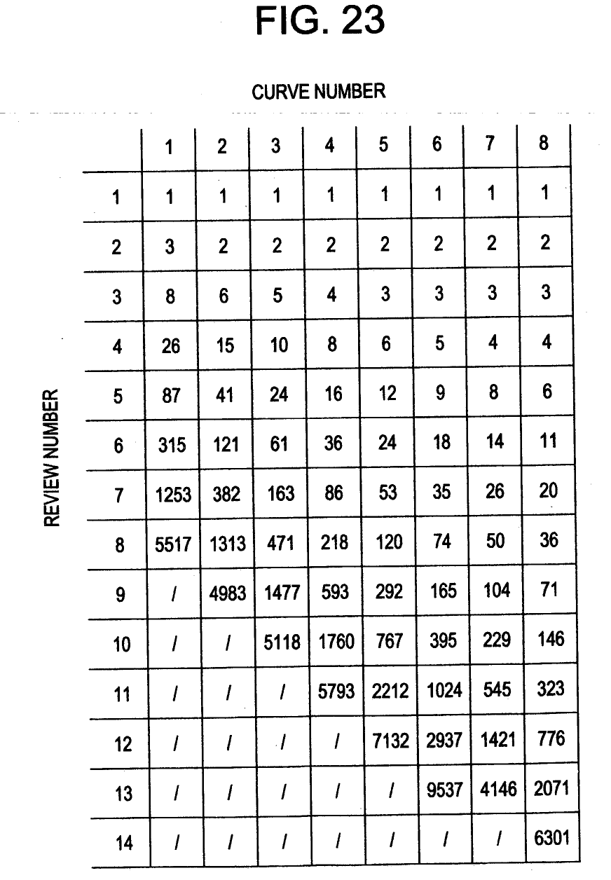

FIG. 23 shows a review curve table preferably used in the preferred embodiments of the Review Module 22. As mentioned in the description of FIG. 3, no single curve can model the forgetting rate of each item learned by each user. In the current preferred embodiment of the system 10, a “family” of curves are preferably modeled to encompass the range of forgetting: from very easy items to very difficult items. The curves shown in FIG. 25 have been sampled to create a table of numeric values. In this example, eight curves have been modeled to represent the total range. The values within the matrix shown in FIG. 23 indicate when a session of the Review Module 22 should occur and are representative of the number of days since an item was initially learned. Those with ordinary skill in the art can create any number of ways to represent the range of forgetting\retention and use the system to calculate the next session of the Review Module, based on input from the user, to maintain any desired level of retention.

FIG. 24 illustrates a review hopping table. As noted above, since no single curve can accurately model the rate of forgetting, a family of curves is used by the system 10 to characterize the range of forgetting. Many variables can change over time however, which affects the rate of forgetting. A curve that accurately models the forgetting rate of a particular item for a particular learner early in the Review schedule may become inaccurate at some later date due to such effects as proactive or retroactive interference and other factors. In order to accurately model the rate of forgetting, the system “hops” the item to be reviewed from one curve to another to more accurately model the forgetting rate. FIG. 24 shows the hopping rules that determine when an item should hop from one forgetting curve to another forgetting curve shown in FIG. 25. During each session of the Review Module 22, the user is presented with items previously learned. A cue is presented and the user attempts to actively recall the appropriate response. After the user has made his best attempts, the user taps the “Show the Answer” button that causes the correct response to be displayed. The user is asked to rate the quality of his response. This rating is called the “score”.

As shown in FIG. 24, scores range from a low of 1 to a high of 5. If a score of 4 is given in the first round, the items changes “0” curves and is dropped from the current Review set. If a score of 5 is given, the item changes “−1” curves and is dropped from the Review set. Changing “−1” means that the item is moved to 1 curve “easier” than the current curve. An easier curve is one where Review sessions occur less frequently. Relating this to FIG. 25, the item may be moved from curve 4 to curve 3—a change of If in the first round of the Review Module 22, the quality of response was scored as a 1, 2, or 3, the item simply moves to the next round of the Review Module. No changes are made to the curve at this point.

The review of each item and scoring and scoring of quality of response occurs round after round until no items are remaining, or until the fourth round of the Review Module 22 is complete. If an item has been seen in four rounds and a quality rating is consistently given as 1, 2, or 3, the item is treated as “unlearned”, and the whole process of Learning, Review, and Testing begins all over again.

This example of determining the appropriate curve to model the rate of forgetting of an item over time based on scoring the quality response during a session of the Review Module 22 represents only one way to monitor and control the ever-changing rate of forgetting. The current system 10 also takes into account latency of response, scores on scheduled and ad hoc tests, the rate of initial learning, the degree of initial learning, and many other factors. Those with ordinary skill in the art can also create other systems based on the present invention that modify the model for the rate of forgetting of each item for each user based on overt and covert feedback taken based on performance in the Learning Module 21, the Review Module 22, and the Test Module 23 as well as data available from other sources such as the rate of forgetting of other users of the system or other factors.

FIG. 25 illustrates a family of review curves with hopping. FIG. 25 graphically represents one family of Review curves with a trace of an item hopping between curves. Many different families of curves can be used by the system 10. Each family of curves is designed to accurately model forgetting for a particular type of information, knowledge or skill learned, retained, and retrieved. The family of curves that best model verbal information may be different than the family of curves for auditory information. These variations in curves may vary from user to user as well. A family of curves which best model auditory information for one user may be ideal for modeling visual information for another user. The system 10 constantly monitor's the users rate of forgetting and rate of timing of “hopping” to minimize the need for hopping. Families of curves that result in less hopping are considered to be better curves than curve families that result in more hopping.

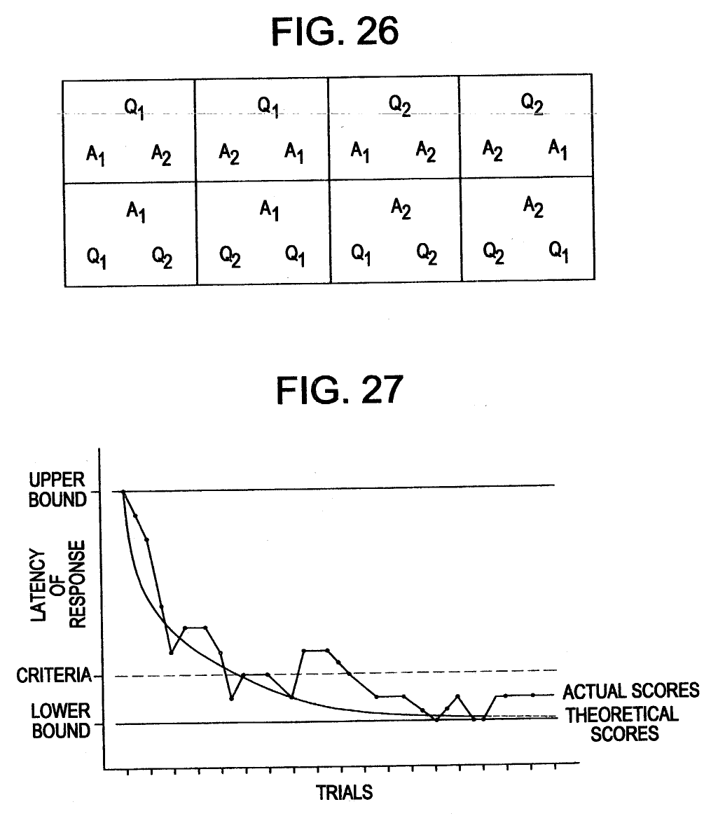

FIG. 26 illustrates forms for the discrimination of two items preferably used in the Discriminator Module 28. FIG. 26 represents the eight separate forms of presenting cues and responses for two confusable items. In the first form, when the cue is presented as Question 1, the user should choose Answer 1 on the left as the correct response. Presenting the cues and responses for the two confusable items in the various formats, the user is trained to discriminate between the items in any possible scenario. Also, by presenting the cues and responses in varying formats, the user does not get bored during the training session because of repetition.

FIG. 27 illustrates the latency of response in discrimination trials according to a preferred embodiment of the Discriminator Module 28. Learning to discriminate between two items is a skill. Skills can be improved through practice. One measure of performance of a skill is latency of response. With practice, scores for latency of response decrease along a negatively accelerated curve, called “theoretical scores” in FIG. 27. At first, the user has a difficult time discriminating between the two confusable items. The user requires a relatively long period of time to perform this function. This time is known as the Upper Bound—it is the slowest the user will ever be performing at this skill. With practice, the user becomes faster at discriminating between the items. There is a Lower Bound to how quickly the user can perform this skill based upon the limitations of perception, cognition, and reporting reflexes. With practice, the latency of response decreases from the Upper Bound asymptotically to the Lower Bound. Because of the laws of diminishing returns, it is not desirable to continue training for too long. The decreasing benefit of the training does not justify the time expended. Therefore, a criteria level is set. When the user reaches this criteria between the Upper Bound and the Lower Bound, the training session is complete. Criteria levels can be set by the user, the system 10, the administrator or other input sources.

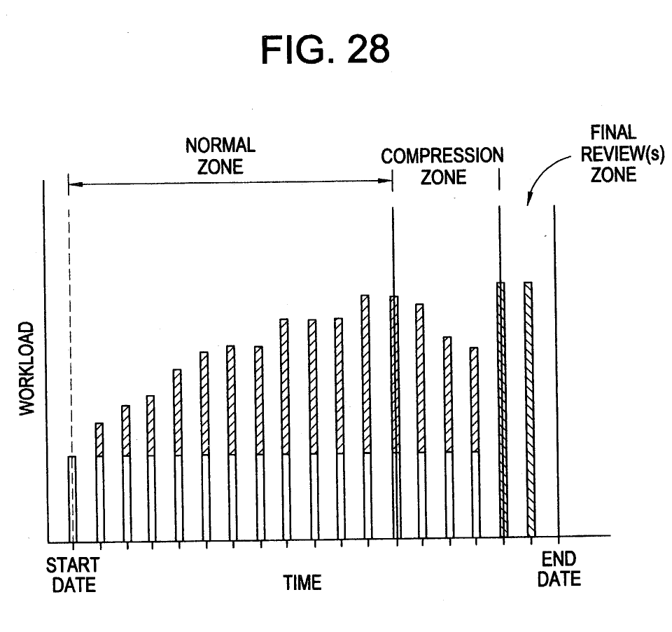

FIG. 28 illustrates various schedule zones and workload for a preferred embodiment of a Schedule Module 25 of the present invention. FIG. 28 illustrates the work zones created by the Schedule Module 25 for the system 10. The user or the administrator defines the start date, the end date, and the items that are desired to be learned. The system 10 automatically determines the most effective and efficient schedule of operation of the Learn Module 21, the Review Module 22 and the Test Module 23 to build the greatest strength and activation for all of the items in the curriculum by the defined end date.

The white areas in FIG. 28 represent the number of items to be learned each day. The cross-hatched areas in FIG. 28 indicate the number of items to be reviewed each day. The black areas indicate the number of items for Final Review each day.

In the Normal Zone, items are learned and reviewed in the normal manner. In the Compression Zone, items are learned in the normal manner but are reviewed as those items are particularly difficult. This creates more opportunities to build strength of the items when very little time remains prior to the end date. In the Final Review Zone, all items have been learned and reviewed to develop the maximum strength possible. One or more Final Review sessions are scheduled to maximize and equalize to the greatest possible extent activation for each item. This presents to the user all of the material just prior to the end date in one or more of the last reviews.

According to one preferred embodiment of the present invention, a system 10, as shown in FIG. 1, is embodied in a processor-based apparatus and method in which information including items to be learned, reviewed and tested is presented to a user graphically, auditorily, kinesthetically, or in some other manner. More specifically, the preferred embodiment shown in FIGS. 29-51 is a processor-based system 10 including a display for showing various window displays described with reference to FIGS. 29-51.

FIG. 29 shows one preferred embodiment of the present invention, in which a Main Window display is provided to allow the user to choose which function he wishes to perform. As seen in FIG. 29, such functions can include viewing lessons, including items to be learned, within a Directory and to organize lessons in any way that the user desires by using any of the Find, New, Move or Delete options. Also, as seen in FIG. 29, the user can select any one of the Learn Module 21, the Review Module 22, the Test Module 23, the Schedule Module 25, the Create Module 200, the Connect Module 300, the Progress Module 26 and the Help Module 28. The operation of these various Modules will be described in more detail below. It should be noted that other types of Modules may also be included in the system and the display shown in FIG. 29.

In this preferred embodiment of the present invention shown in FIGS. 29-51, the display is preferably a touch-screen type display that responds to contact by a pen, stylus, finger or other object. Other types of displays or information presentation apparatuses may also be used in various preferred embodiments of the present invention.

FIG. 30 shows a Preview Window display that is presented in response to a user selecting a Lesson such as Lesson 1. In one preferred embodiment of the present invention, if a user taps twice on the display at the location of the title “Lesson 1” in rapid succession, the display presents information about that lesson including the lesson's title, the author of the lesson, the date of creation of the lesson, and description/instructions for learning that lesson. In addition, the user can tap the Preview button to see the contents of the lesson. Tapping the Close button takes the user back to the Main Window display shown in FIG. 29.

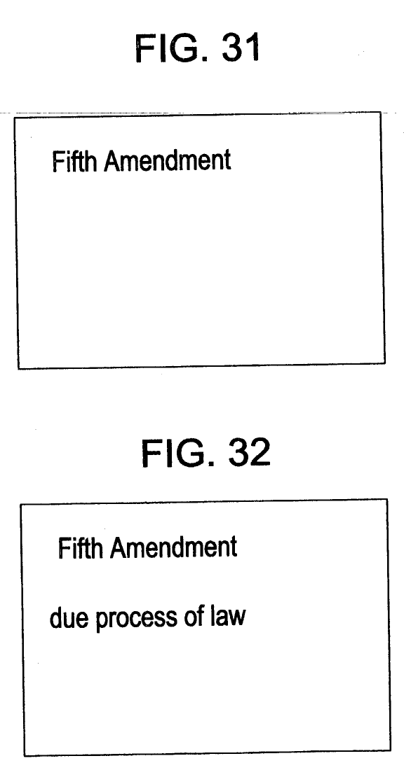

FIG. 31 is a display showing operation of the Learn Module 21 including the presentation of a cue. In this preferred embodiment of the present invention, when a lesson is selected as described above and the Learn button shown in FIG. 29 is tapped, the Learn Module 21 is initiated. FIG. 31 shows the display corresponding to T₃ in FIG. 17.

FIG. 32 is a display showing a further operation of the Learn Module 21 including the presentation of a response to the cue shown in FIG. 31 corresponding to T₄ in FIG. 17.

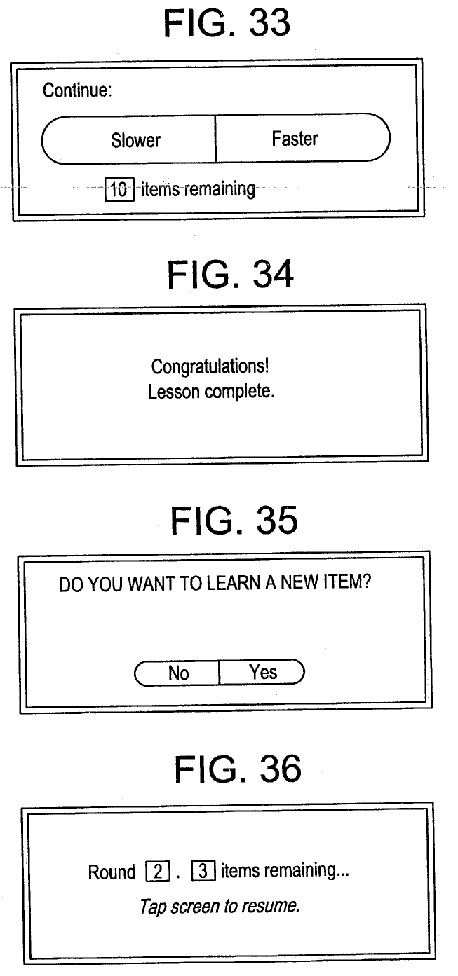

FIG. 33 is a display showing a further operation of the Learn Module 21 including e presentation of a prompt asking the user whether he wants to proceed Faster or Slower. FIG. 33 shows the window displayed after the user has determined that he knows the unknown item being presented and has interrupted the sequence of presentation of this particular unknown item.

FIG. 34 shows the display that is provided after the user has completed the entire process of learning a lesson.

FIG. 35 shows another operation of the Learn Module 21 according to a preferred embodiment of the present invention in which a user is asked if he wants to learn a new item. FIG. 35 shows the window displayed when a user has reached a point in the presentation sequence when no user interrupt is given, but a predetermined time or presentation value has been reached. The user determines whether he wants to learn a new item or continue learning the item that is currently being presented for learning. If the user chooses “Yes,” the next unknown item is presented. If the user chooses “No,” the presentation sequence for the item currently being learned is started over again.

FIG. 36 shows a further operation of the Learn Module 21 including the operation of the Quick Review part of the Learn Module 21. FIG. 36 shows the display presented at the end of each Quick Review round.

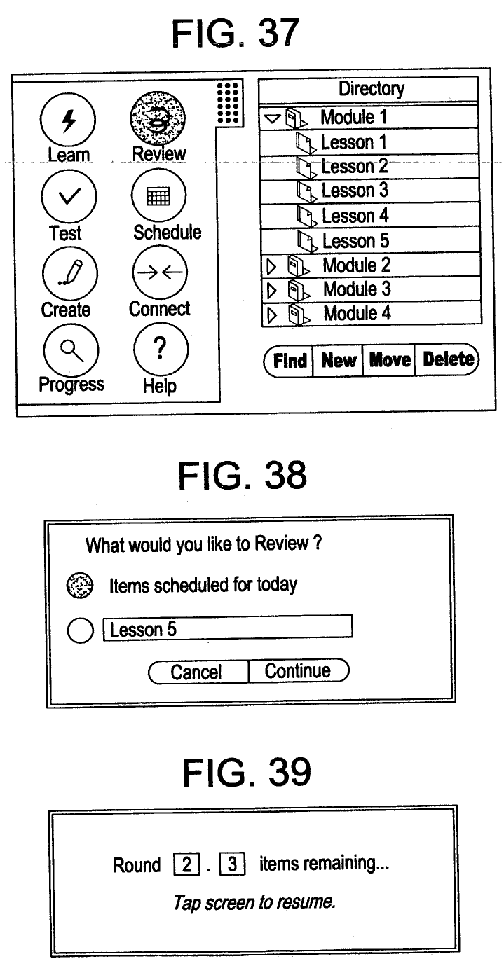

FIG. 37 shows a display including a Main Window with Review Notification included therein. In one preferred embodiment of the present invention, when items previously learned are scheduled for review via the Review Module 22 on the day that the user turns on the device, the Review button on the display is green and blinks to capture the user's attention. Also shown in FIG. 37, the green icon is arranged to move and preferably spiral next to the lesson icon on the display indicating that the lesson has been learned and that such lesson has been put on a schedule of review.

FIG. 38 shows a display illustrating operation of the Review Module 22. According to a preferred embodiment of the present invention, when items previously learned are scheduled for Review on the day that the device is turned on, the Review button on the display is green and blinks to capture the user's attention. If the user has selected a lesson in the Directory, and then taps the Review button, the window shown in FIG. 38 appears and asks the user what they would like to Review, for example, items scheduled for review today or the lesson selected in the Directory Window. The default is the Scheduled Review. The user selects one of the two and taps Continue to review his choice or taps Cancel to return to the Main Window.

FIG. 39 shows a further operation of the Review Module 22. According to a preferred embodiment of the present invention, after the user has completed a round of Review, and the round is not Round 4, the display shown in FIG. 39 is presented.

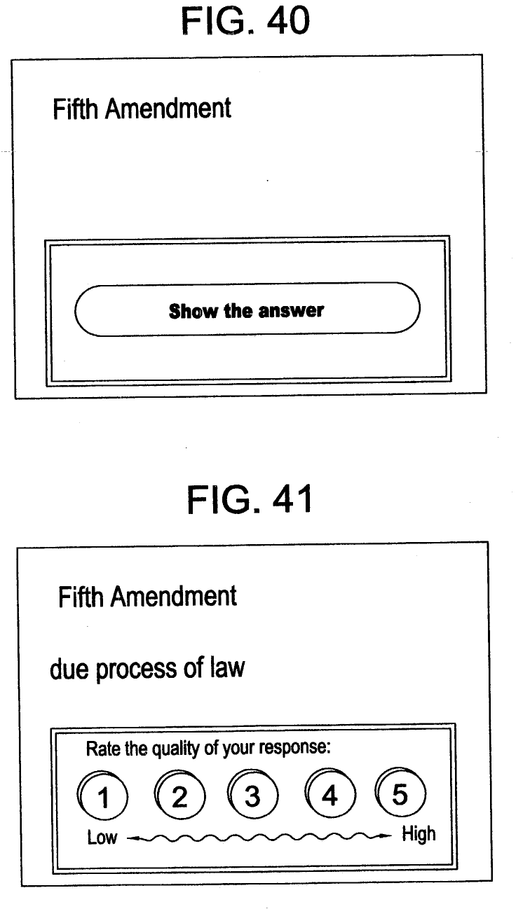

FIG. 40 shows another operation of the Review Module 22 including presentation of a cue. According to a preferred embodiment of the present invention, after the user has selected a lesson to Review or has selected to review items scheduled for Review, he is presented with a cue. At this point, the user attempts to actively recall the answer. When he has performed this task to his satisfaction, the user taps on the “Show the Answer” button shown in FIG. 40.

FIG. 41 shows a further operation of the Review Module 22 including a Rating Quality of Response. In one preferred embodiment of the present invention, after the user has tapped the “Show the Answer” button shown in FIG. 40, the user is presented with the correct response to the cue. The user compares his response to the correct response displayed and rates the quality of his response on a scale of 1 to 5 where 1 is the lowest quality and 5 is the highest quality.

FIG. 42 shows an operation of a Test Module 23 according to a preferred embodiment of the present invention, including the presentation of cue and a rating of the “Feeling of Knowing.” In one preferred embodiment of the present invention, after the user has chosen a lesson he would like to be tested on, or the system or administrator has presented the user with a test via the Test Module 23, the user is presented with a cue. The user must actively recall what he considers to be the correct response. After he has made his attempt at such active recall, the user must determine his “feeling of knowing” on a scale of 1to 5, where 1 is “Don't Know”, 3 is “Not Sure” and 5 is “Know It”, and 2 and 4 are gradations between the other scores.

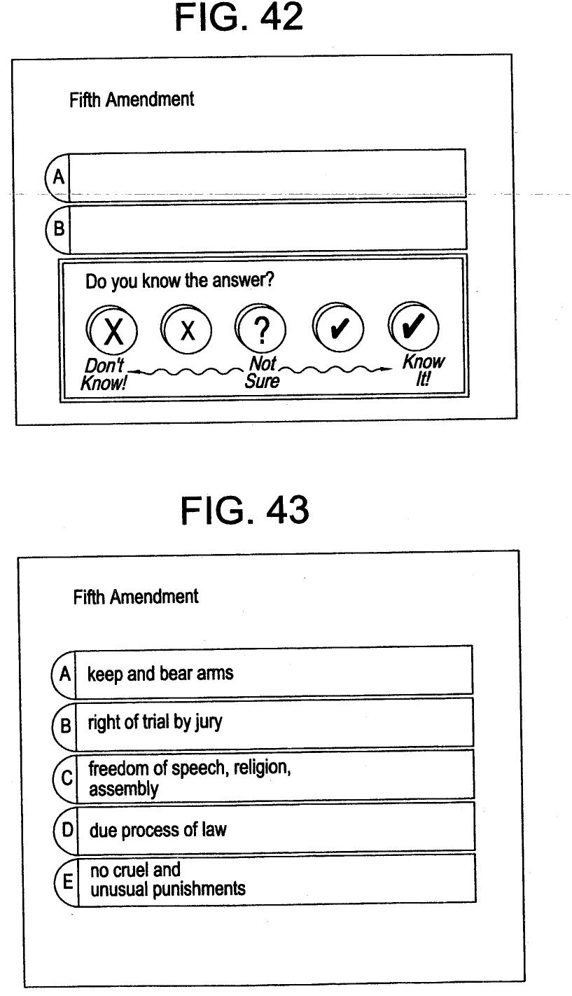

FIG. 43 shows a further operation of the Test Module 23 including the display of a correct response. In one preferred embodiment of the present invention, after the user has chosen a feeling of knowing score as described above, the user is presented with five alternative forced-choices. The user must find his answer among the choices and select the correct answer by tapping on the screen.

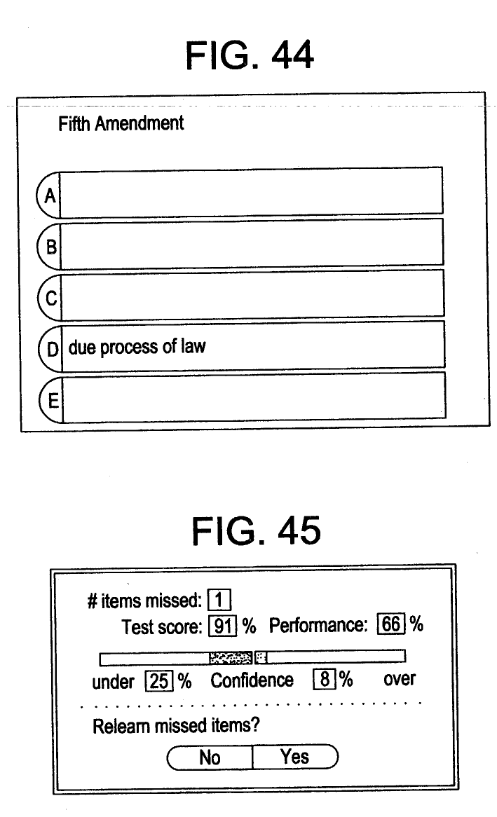

FIG. 44 shows another operation of the Test Module 23 including the display of a correct response. In one preferred embodiment of the present invention, after the user has selected what he considers to be the correct response from among the distracters as described in FIG. 44, the incorrect answers are erased leaving only the correct answer. If this is the answer the user selected in the step described in FIG. 43, the answer remains for a relatively short period of time. If it is not the answer that the user selected, the answer remains for a relatively longer period of time.

FIG. 45 shows an operation of the Test Module 23 including a display of test scores. In one preferred embodiment of the present invention, after the user has completed a test, he is provided with test scores that include the number of items missed, test score, performance score, percent underconfident, and percent overconfident. If the user selected an incorrect response to the cue, the user will be provided with the opportunity to “re-learn” that item. If the user chooses “Yes”, the items will be presented in a similar way as they were the very first time that the user learned these items.

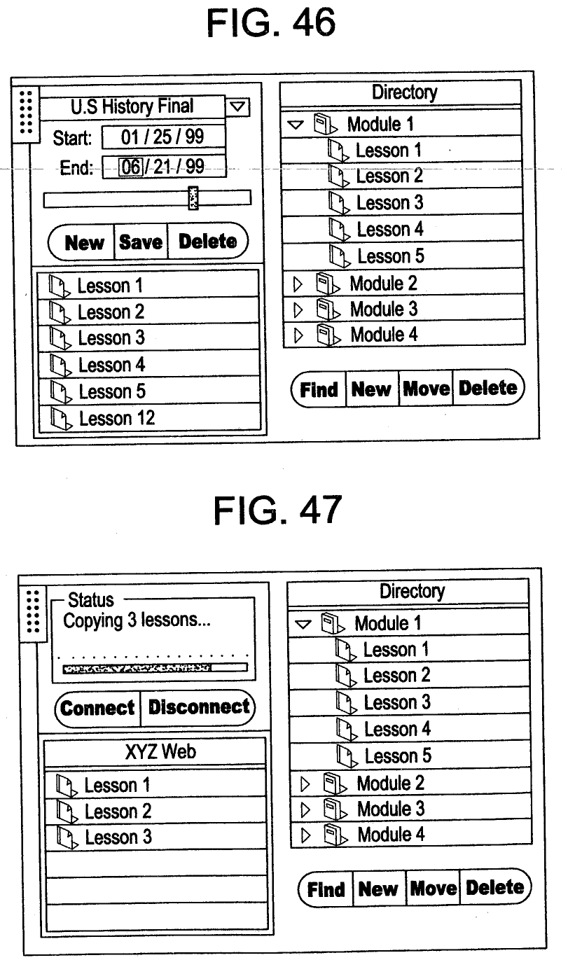

FIG. 46 shows an operation of the Schedule Module 25 including a Schedule Main Window display. In one preferred embodiment of the present invention, the user can request that the system 10 calculate and maintain a schedule for the user via the Schedule Module 25. The user inputs the starting date (defaulted to the current day's date) and the ending date, and identifies the lessons to be learned and the name of the schedule. Other relevant information can be input by the user, the system 10 or other sources. The system 10 then calculates the most effective and efficient schedule of Learning, Reviewing, and Testing so that all items are at the highest state of strength and activation possible on the end date. Also shown in FIG. 46 is a progress bar that shows where the user is in the schedule compared to where he should be (the vertical hash mark) if the user were following the schedule initially prescribed by the system.

FIG. 47 shows an operation of the Connect Module 300 including a Connect Main Window display. In one preferred embodiment of the present invention, the user can connect the system 10 to another similar system, a learning device, a computer including a laptop, palmtop and desktop PC, a telephone, a personal digital assistant or to another system via a network connection such as the Internet. In FIG. 47, the Directory on the right is the user's directory of lessons. The directory on the left in FIG. 47 represents the directory of the machine that the user is connected to. To transfer lessons between the two, the user simply clicks on the lessons in one window and drags them into the other window and drops them. The progress bar and status window on the upper left report the progress of the transfer and connection.

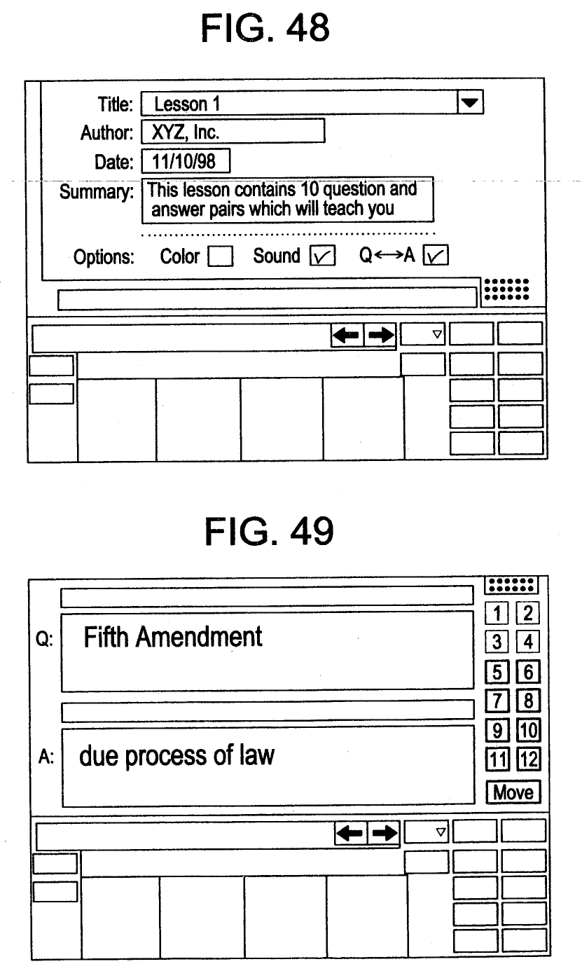

FIG. 48 shows an operation of the Create Module 200 including a Create Control Panel display. In one preferred embodiment of the present invention, the user can create lessons of his own. In FIG. 48, the Create Control Panel is shown. This is the panel where the user enters the title of the lesson, the author, the date of creation, and a summary of the lesson (which also appears in the Preview window described in FIG. 28). The user also sets options which determine whether the lesson will be shown in color, with sound, and whether the questions and answers will be reversed in the Quick Review portion of the Learn Module 21. The user closes (and opens) the panel by tapping on the tab on the bottom right hand corner of the panel. The user can also open up a list of lessons in the Directory by tapping on the down arrow on the Title input window. If a lesson is selected in this manner, the user can review the settings or modify then save the lesson.

FIG. 49 shows a further operation of the Create Module 200 including a Create Main Window display. In a preferred embodiment of the present invention, the user can create lessons on his own. The display shown in FIG. 49 is provided when the Control Panel in FIG. 49 is closed.

The user enters the question and answer as shown in this figure by first tapping on one of the buttons on the right labeled from 1 to 12, and then entering the text in the appropriate window. Two additional input windows are available—one above the question and one above the answer. These windows allow the user to add pronunciation hints or any other information that the user would like to include with each item. The buttons on the right appear in different colors depending on the state of the question and answer fields. If the fields are blank, the button is blue. If the fields have data entered, the button is green. The button that is colored red is the question and answer field currently displayed.

The user can change the ordering of items by tapping on the button that represents item he wishes to move, then tapping on the move button, then tapping on the position where he would like the item moved to. If there was an item already filled in the target location, it is moved to where the first item used to be.

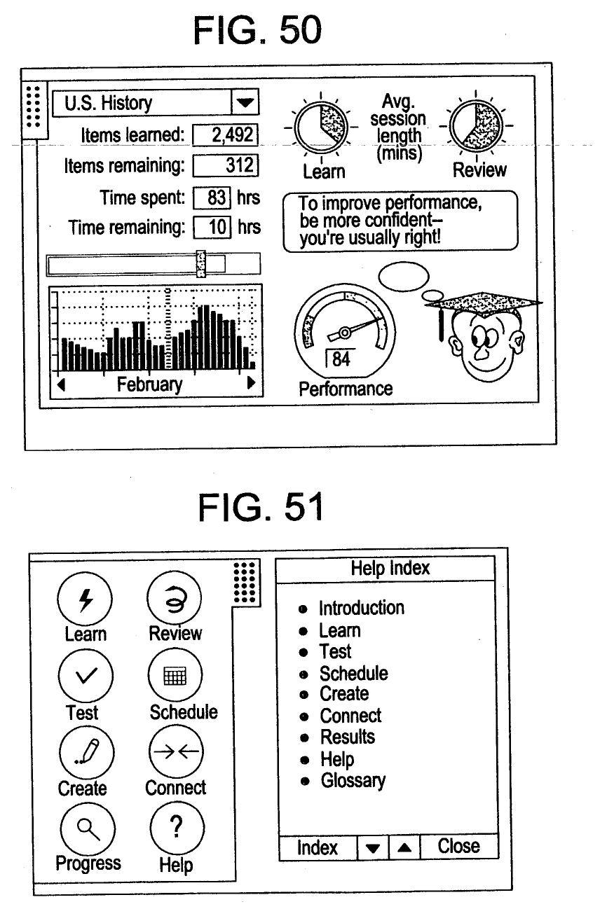

FIG. 50 shows the operation of a Progress Module 26 including a Progress Main Window display. In a preferred embodiment of the present invention, the user is provided with feedback about his use of the system 10 via the Progress Module 26. FIG. 50 shows the various numeric and graphical feedback provided. In addition, the user can tap on any field displayed. The “teacher” character displayed in the bottom right corner of the display will look at the field tapped on, will smile or frown based upon the quality of the score, and will provide advice on how to improve the score in the thought or dialog “bubble” above his head.

FIG. 51 shows the operation of the Help Module 27 including a Help Main Window display. In a preferred embodiment of the present invention, the user will be provided with textual and graphical help to assist with the use and operation of the system's features. The user simply taps on the Help button in the lower right corner of the Main Window Control Panel. The Help Index appears on the right and the user taps on the area of interest to reveal more information. The user taps the Close button when the user is through.

In another preferred embodiment of the present invention, the system 10 is embodied in a paper-based application in the form of a word-a-day calendar shown in FIG. 52. In this preferred embodiment, the user is presented with one new word each day to learn with one set of information. In this case, spelling, part of speech, pronunciation, a full definition, and the use of the word within a sentence is included. The user is also presented two words for review that were very recently learned. The words are presented with a different set of information than a word presented the first time. In this case: spelling, part of speech, pronunciation and a brief definition. The user is also presented several words that were learned further in the past. The words are presented with a different set of information than a word presented the first time or words that were very recently learned. In this case: spelling and brief definition.

In this preferred embodiment of the present invention, responses (definitions of vocabulary words) are to be actively recalled based upon the presentation of cues (vocabulary words). This active recall can be accomplished by shielding the responses with paper or plastic until active recall is attempted, by making invisible responses visible with special pens and printed inks after recall is attempted, or any number of ways known to those skilled in the art.

FIG. 53 shows a table including a review expansion series for the paper-based system. As illustrated in FIG. 53, items learned should be scheduled for Review based upon on an expanding rehearsal series in order to maintain long-term retention. Generally speaking, an adaptive system is desired in order to maximize the effectiveness and efficiency of the user's time. The schedule of review for each word learned is defined by FIG. 53. Words learned on day 0 are reviewed on the first following day, the third day after day 0, one week after day 0, two weeks after day 0, one month after day 0 and so on.

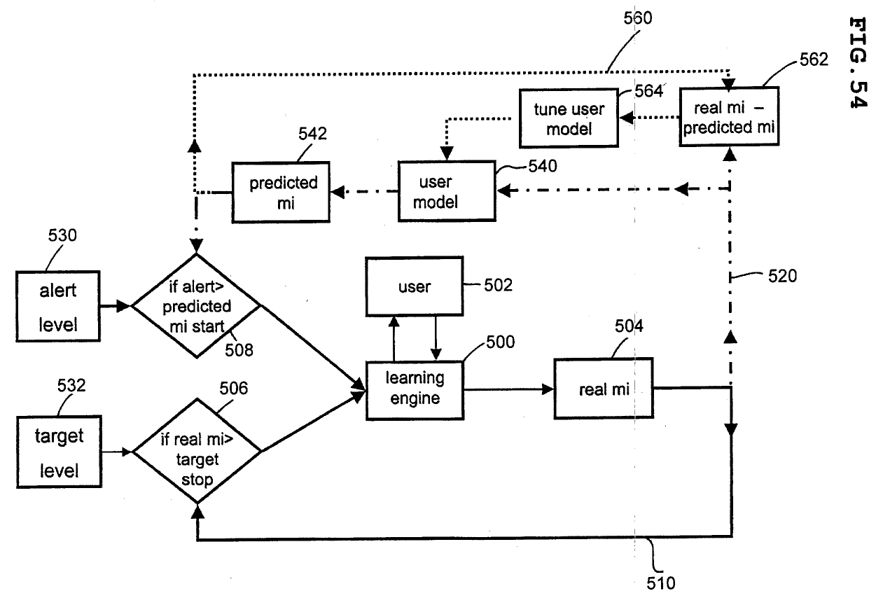

Now an additional preferred embodiment of the present invention will be described with respect to FIGS. 54-60.

The preferred embodiment shown in FIGS. 54-60 is based on the preferred embodiments described above and is similar in many respects to those preferred embodiments described above. However, the preferred embodiment shown in FIGS. 54-60 differs from the above-described preferred embodiments in several respects.

Unlike the preferred embodiments described that include separate modules or processes for Learn, Review and Test, the preferred embodiments shown in FIGS. 54-60 combine Study, Review and Test in a single process or user session. In addition, the preferred embodiments described with reference to FIGS. 54-60 use a new learning model shown in FIG. 54 that enables an accurate estimation of memory strength, referred to as “memory indicator” to be determined during all phases of learning, including the active short-term learning phase and the passive long-term forgetting phase. In addition, the intra-trial spacing effect is achieved in a different way in the preferred embodiments shown in FIGS. 54-60 as compared to the preferred embodiments described with reference to FIGS. 1-53. Furthermore, the manner in which scheduling of presentation of items during a single learning session and the scheduling of presentation of groups of items over time, including items to be reviewed and new items to be studied, is performed differently in the preferred embodiments of FIGS. 54-60 as compared to the preferred embodiments shown in FIGS. 1-53. Also, the manner in which a study/review/test session is ended is different in preferred embodiments shown in FIGS. 54-60 as compared to the preferred embodiments of FIGS. 1-53.

The present preferred embodiment provides a learning engine or learning process that is based on a novel model of the learning shown in FIG. 54. As seen in FIG. 54, there is a learning engine 500, which is preferably a learning engine 500 in accordance with preferred embodiments described herein. The learning engine 500 is used by a student or user 502 to learn various items including knowledge or skills. When the learning engine 500 stops and starts to present items to the user 502 for study or review is based on an alert level 530 and a target level 532 that are input to the learning engine 500. The performance of the user 502 in learning various items by using the learning engine 500 is measured by a measuring process performed by the learning engine 500 to produce an actual measurement of a memory indicator indicated in FIG. 54 as real memory indicator (m.i.) 504. The process for measuring the memory indicator 504 of each item for each user is described in more detail below.

As described above, when a user 502 is rehearsing, reviewing, studying or being presented with an item to be learned or reviewed via the learning engine 500, the memory performance of the user can be measured to determine a real memory indicator 504 because this is the active short-term phase of learning during which it is possible to take an actual measurement of memory performance. This active short-term phase of learning is a loop shown in solid lines and labeled 510. This active short-term phase of learning is also referred to as the learning loop. The learning loop 510 begins when a user 502 begins the active process of learning by interacting with the learning engine 500. For each item of information that is presented to the user 502 by the learning engine 500, the learning engine 500 determines a real memory indicator 504 and then determines at 508 whether the real memory indicator 504 is greater than a target level 532 for the memory indicator, described in more detail below. If the memory indicator 504 is greater than the target level 532, then the active short-term phase of learning 510 stops for the item being presented and the user 502 no longer is presented with this particular item by the learning engine 500 with items to be studied or reviewed.

In previous methods described above, it was assumed that sufficient learning was achieved when the learner was able to actively recall an item once. This provides only one data point for active recall before the learning process was stopped. In the present preferred embodiment of the present invention, before the learning process is stopped, the user is preferably required to achieve the current target level 532, and not just achieve a single active recall as in past methods.

Once the user 502 stops using the learning engine 500 and is no longer in the active short-term learning loop 510 for a particular item, the brain of the user 502 begins to forget the item of information reviewed in the learning loop 510. Thus, the user and learning process now enter into the passive long-term phase of forgetting for that item, which is represented by loop 520 that is shown by long and short dash lines in FIG. 54. In the forgetting loop 520, the learning engine 500 uses a user model 540 to determine a predicted memory indicator 542 for each item being presented to the user 502. The learning engine compares the predicted memory indicator 542 to an alert level 530 for memory indicator at 508 for each item. If the alert level 530 is greater than the predicted memory indicator 542 for an item, then the learning engine 500 begins to present that item for study or review to the user 502, and thus, the active short-term phase of learning 510 begins again for that item.

Based on an initial schedule of presentation of items determined by the learning engine 500, it is assumed that every item has a date after which the item should be studied. Thus, each item has a birth time, which is the date on which each item is to be first presented to the user, based on ideal schedule that is computed in advance and stored in a database of the learning engine 500. An actual time when the item is presented to the user may be different from the intended birth time depending on how much user is using the learning engine 500. The learning engine 500 keeps track of real birth time and intended birth time, as well as a goal time that is defined as time in which a goal (in terms of a level of memory indicator) should be reached. This data is predetermined and stored in the database of the learning engine 500. Each item has a measure of difficulty determined, for example, by how long a user needs to reach minimum level of target level, or other suitable methods.

A first alert level is determined based on average slope that has been predetermined. If a time is before an intended birth time for an item, the alert level is set to 0 so that item cannot be presented before its intended birth time. At or after the goal time, the alert level is set to the goal level.

In between these two times, the alert level 530 is calculated based on goal time, goal memory indicator, intended birth time and a slope which is the measure of item difficulty, which is determined by the time required to reach the first target level. Thus, the alert level 530 can be calculated using a well known equation such as a linear function, a logarithmic function, or other similar function, and using as variables any of the goal time, goal memory indicator, intended birth time and the slope indicating item difficulty.

Then, the first target level 532 is a minimum target that is predetermined as a parameter for a value of the minimum target level. Similar to the alert level, the target level can also be determined using a well known equation such as a linear function, a logarithmic function, or other similar function, and using as variables any of the goal time, goal memory indicator, intended birth time, real birth time and the slope indicating item difficulty.

For example, the equations for the alert level 530 and the target level 532 can be as follows:

Alert=0.1+0.7* min(1, (t−bt)/(gt−bt))

Target=0.5+0.5* min(1, (t−bt)/(gt−bt))

where t is current time, bt is birth time and gt is goal time.

As noted above, many other known mathematical functions using the variables described above can be used to compute the alert level 530 and the target level 532.

Now, the manner in which the real memory indicator 504 is determined will be described. The measurement performed to determine the real memory indicator 504 is indicative of the user's actual memory performance in studying, reviewing or testing of items presented by the learning engine 500.

There are several dependent measures of memory performance including latency of recall, probability of recall, savings in relearning and metacognitive judgments made by the user such as judgment of learning. Any of these factors may be determined as described above, and used to determine a memory indicator 504 for each item of information reviewed by each user. Also, results on tests on each item may be used along with other measures of memory performance to determine a real memory indicator 504.

There are other alternative or additional methods to determine memory performance. For example, each of the above measures of memory performance may be combined together according to a mathematical algorithm that assigns suitable coefficients for each of the three factors and then sums the three factors. Alternatively, separate measures of memory performance could be calculated based on each one of the factors mentioned above, and the separate memory indicators could be used individually as a measure of memory performance.

As noted above, there are many different ways to calculate the memory indicator 504. In the present preferred embodiment, a real memory indicator 504 is preferably determined based on active recall of a particular item and is determined preferably through an analysis of performance on a recall test followed by a confirmation test. The result of the recall test, the latency of response on the recall test and the result of the confirmation tests are preferably used to compute the real memory indicator 504 in the present preferred embodiment. However, as noted above, many other measures of memory performance may be used independently or in combination to determine the value of the memory indicator.

In the present preferred embodiment, when the learning engine 500 provides a user with a recall test as described above, the latency of recall is measured and stored in the learning engine 500. The latency of recall is measured by measuring the time from when the cue was presented to the user until the time that the user provided a response indicating that the user could actively recall the correct response to the cue. If no recall occurred or if the user failed to answer a test to confirm recall, the measured latency is assumed to be long and assigned a value that indicates no recall occurred.

The latency of response is preferably then re-scaled to extract meaningful information. Then, since short latencies correspond to high memory strength and long latencies correspond to low memory strength, the latency is inverted.

The result of this inverse transformation is then is preferably averaged between successive trials to reduce noise from latency measure. Finally, the result is normalized between 0 and 1. All of these steps are done via algorithm performed by the learning engine 500. The normalized memory indicator is then designated to be the memory indicator for the item.

More specifically, the process for measuring the real memory indicator 504 first involves determining a working latency L to be used in the following step. When an item is presented to a user 502 by the learning engine 500 during a “study mode”, the working latency L is calculated as the time difference between the beginning of the study mode presentation and the moment that the user indicates he has studied enough and knows the item being presented, and is thus ready to study the next item. When the item is presented to the user during a “recall mode” of the learning engine 500, the working latency L is:

a fixed long latency Lₘₐₓ if the user failed to recall the item.

a fixed long latency Lₘₐₓ if the user failed to provide a correct answer during a confirmation test.

the time difference between the presentation of the cue and the user indicating to the learning engine 500 completion of recall (if the user did so and provided the correct answer to the confirmation test).

The next step involves determining a value for an Instantaneous Memory Indicator (IMI), which is a function of L determined in the previous step. It should be noted that the working latency L cannot be used as if to measure ability to recall because:

(a) The working latency is an inverse representation of the memory strength. A high L reveals a low memory strength that contradicts the definition of the memory indicator (which increases with memory strength).

(b) The working latency is not a linear representation of the memory strength. That is the difference in knowledge between L=8s and L=9s is very different from the difference in knowledge between L=1 s and L=2s.

Consequently, the IMI function is used to transform the working latency L determined in the previous step 1 into some meaningful information. The IMI function depends on 3 parameters: Lₘᵢₙ, Lₘₐₓ, and Lₚ.

| | |
|---|---|
| If L > Lₘₐₓ | IMI = 0 |
| If L < Lₘᵢₙ | IMI = (Lₘᵢₙ/Lₘₐₓ)^{-L}ₚ |
| Else | IMI = (L/Lₘₐₓ)^{-L}ₚ |

Mathematically, this function verifies the assumptions (a) and (b) described above, and exhibit a correct behavior when used in conjunction with power functions.

Next, it is necessary to determine a Score that is a stable representation of the current memory strength based on the latest n measurements of working latency. To remove noise from latency measures, an averaging process is preferably performed. Yet, because the latest measure is more likely to represent the current memory strength, the averaging method should not be uniform among consecutive latency samples. Assuming that n latency samples Lᵢ are used to compute the current memory indicator. The current score is defined as follows:

score=Σi*IMI(Lᵢ)

That is, the later that a sample is measured, the greater its weight is in the computation.

Finally, the memory indicator is determined as a value that is correctly scaled between 0 and 1.

Indeed, after the previous step is completed, the process for computing real memory indicator 504 produces a stable, correctly oriented representation of the memory strength. But the value of this representation does not belong to [0,1] as the memory indicator is preferred to be. To normalize the score, the score is compared to the worst score possible (that is the score obtained for Lᵢ=Lₘₐₓ for the n latest samples) and is also compared to the best score possible (that is the score obtained for Lᵢ=Lₘᵢₙ for the n latest samples). The memory indicator is then preferably defined as:

MI=(score−score_{worst})/(score_{best}−score_{worst})

Obviously, the minimal memory indicator will be 0 (when score=score_{worst}) and will be 1 (when score=score_{best}).

The above-described process is just one example of a process for accurately determining a real memory indicator 504.

It is important to note that if the user 502 indicated that the user could recall the item but failed the confirmation test, the memory indicator is set to 0 because the method assumes the learner is not able to recall the item.

As seen in FIG. 54, the real memory indicator 504, computed as described above, is used in both the active short-term learning loop 510 and the passive long-term forgetting loop 520. In the active short-term learning loop 510, the real memory indicator 504 is used to determine when the active short-term learning process should be stopped. In the passive long-term forgetting loop 520, the real memory indicator 504 is used in the user model 540 to determine the predicted memory indicator 542 since it determines the initial point from which decay begins.

More specifically, since the decline of human memory can be mathematically modeled using various functions such as a power function, the memory indicator for each item can be modeled in the user model 540 during the forgetting loop 520 to make an accurate prediction of memory indicator during the forgetting loop 520, which is output as the predicted memory indicator 542. In the present preferred embodiment, the decline of human memory of the user 502 for each item is determined by the learning engine 500 based on a power function and is modeled in the user model 540. It should be noted that although the decay of human memory can also be modeled with exponential functions or other types of monotonically decreasing negatively accelerated functions, the power function used to predict the memory indicator in the present preferred embodiment is At^{-b}.

This power function At^{-b} has two degrees of freedom: A, which is the virtual initial amount of memory indicator that can be greater than 1, and b, which is the memory indicator decay rate.

Applicants have developed several possible models that can be used with the above noted power function in the user model 540 to determine the predicted memory indicator 542.

In the first model, A and b are assumed to remain constant. To fulfill the constraint created by the measure at the end of the learning, a new degree of freedom is introduced. This new degree of freedom A is assumed to be simple in that it remains constant between two reviews. The resulting formula is as follows:

memory indicator=A*t^{-b}+Δ

A serious assumption of this model is that reviewing the item again does not affect factors A and b. A certain amount of knowledge is added to compensate for the forgetting and to fulfill the constraint.

Another way of explaining this model is to imagine that the method takes a section of the decay curve, and fits the section in between the current target point and the next alert point, which is done each time that an item is reviewed. Thus, this first model involves changing the forgetting curve between two successive reviews so that the memory indicator prediction curve becomes At^{-b}+Δ.

Note also that although the rate of decay b does not change as time goes by, the model creates an expanded rehearsal series because as time goes by, the decay of the memory indicator becomes slower and slower, (indeed Δ is constant between two reviews). Note that adaptation for this model is complicated since both A and b have to be adapted to the user.

In the second possible model, it is assumed that A is constant, and b changes. The second model is defined by the following equations:

Aₙ₊₁=Aₙ

Bₙ₊₁=ƒ(bₙ)

The method uses a set of power functions that are prepared based on different values of b. Contrary to the first model described above, the engine changes the function of the forgetting curve in the second model. For example, before the first review, the method uses a first power function At^{-b}. After the first review, the method selects a second power function for the second review by using a power function having a different b. The method determines which of the various power function curves passes through the point T (target) and uses that power function curve. In this algorithm, because the value of b is becoming smaller and smaller, an expanded rehearsal series is easily created.

Note that this model is difficult to initialize since when t=1, the memory indicator equals A for all values of b. Consequently, an additional parameter has to be introduced or the first review has to be set to a predetermined value.

In the third possible model, A is changing and b is constant. However, because the number of review increases as A increases, the speed of forgetting decreases as time goes by. This model also effectively produces an expanded rehearsal series. This third model is defined by the following equations:

Aₙ₊₁=ƒ(Aₙ)

Bₙ₊₁=bₙ

In the fourth possible model, A is changing and b is changing. The possible decay curves include all possible power functions. There are two times infinity numbers of functions that are possible. So there is a question as to how to choose from all of these available curves. Mathematically, A and b are correlated series generated by real functions f and g as following:

Aₙ₊₁=ƒ(Aₙ, bₙ)

Bₙ₊₁=g(Aₙ, bₙ)

In the fifth possible model, a power function is used but the time origin is set to an arbitrary value G before the last review was given. In this case, after a review is given a t=t₀, the memory indicator is believed to decay according to:

memory indicator=A*(t−t₀+G)^{-b}

A is computed using the constraints on the end of learning while b is assumed not to vary from a review to another. The main advantage of this model is that it allows a wide range of adaptation. However, it does not force an expanded rehearsal series. When coupled with an appropriate adaptation process, this model does produce an expanded rehearsal series by following the user's progress with active recall.

No matter which of the above five models is used with the preferred power function to determine memory indicator, it is necessary to determine an initial decay rate. After the first learning session ever conducted by the learning engine 500, the method does not have any knowledge about the speed of decay. In the present preferred embodiment, a judgment of learning or JOL is preferably used to determine an initial rate of decay.

To initiate the rate of decay for new items, the user is requested to perform a Judgment of Learning test. In the Judgment of Learning test, the user is requested to rate how difficult each of the items reviewed is to remember.

More preferably, a delayed JOL test is used to determine the initial rate of decay. It has been determined that when delayed by more than a predetermined period of time, such as several minutes, the JOL test is a very good indication of future performance. Thus, the rating on the Judgment of Learning test may be a numerical value, such as 1 to 4, or a subjective scale such as very hard to very easy, and is correlated using a look-up table or other preferably non-linear correlation function that matches an answer on the JOL test to a predetermined initial decay rate. Thus, after an initial session of operation of the learning engine 500, the learning engine 500 computes the first decay rate for the forgetting curve that extends from the first point on the memory indicator graph down below the alert level.

There are several other possible methods that can be used by the learning engine 500 to predict the first forgetting rate, including using a fixed initialization parameter that has been predetermined to be effective for the adaptation process, using the measure of item difficulty based on the amount of time required to move from a value of 0 of the memory indicator to some desired value, or some other measurement of item difficulty, and using a statistical linear model of memory decay based on analysis of previous user data. Other suitable methods for initializing the first decay rate may also be used.

Since power functions, such as the one used in the user model 540 of the present preferred embodiment, have two degrees of freedom, an adaptation process is needed to compensate for the free degree of freedom. The adaptation process is carried out by comparing the predicted value of the memory indicator to the first available measure of the memory indicator in an error correction loop 560 shown in FIG. 54. Thus, the learning engine 500, using the model shown in FIG. 54, continuously adapts via the error correction loop 560 so that the error between the predicted memory indicator 542 and the real memory indicator 504 is minimized.

As seen in FIG. 54, the real memory indicator 504 is also used to tune the user model in the error correction loop 560. As with any prediction based on mathematical modeling, there may be some error. Accordingly, the learning model of FIG. 54 includes an error correction loop 560 in which errors in previously determined predicted memory indicator 542 during the forgetting loop 520 are corrected. This results in much more accurate values for the predicted memory indicator 542 in the future, and thus, much more optimal scheduling of presentation of items to the user, which achieves a much more efficient and effective learning process. More specifically, the real memory indicator 504 is used by the learning engine 500 to determine the difference between the real memory indicator 504 and the predicted memory indicator 542 at 562. Then, the difference between the real memory indicator 504 and the predicted memory indicator 542 is used by the learning engine 500 at 564 to tune the user model 540. Then, the learning engine 500 modifies the user model 540 based on the adjustment for the user model determined at 564. As a result, errors in the user model 540 are continuously corrected and the user model is constantly improved to provide more and more accurate values for the predicted memory indicator 542.

Prior to the development of the present invention, it was not possible to accurately determine an estimation of the memory strength for each item of information for each user during the passive long-term phase of learning or during the forgetting loop 520.

In order to overcome this inability to accurately determine the estimation of memory strength, the unique learning model shown in FIG. 54 accurately determines an estimate of the memory strength, referred to as the memory indicator, and then controls the memory indicator using an alert level 530 and a target level 532 for each item of information and for each user. The memory indicator is controlled by constraining the value of the memory indicator to be between the alert level 530 and the target level 532 for each item. The alert level 530 is the highest minimum value before studying or reviewing an item using the learning engine 500 and the target level 532 is the lower maximum value after studying or reviewing an item using the learning engine 500. The values for the alert level 530 and the target level 532 are determined as follows.

The initial and subsequent values for the alert level 530 and the target level 532 are determined in a unique way. In the methods according to preferred embodiments described above, it was thought that a user should reach a level of automaticity (very fast or “automatic” recall) in a single learning session. It was discovered that this is virtually impossible to do because if the user is required to reach a level of automaticity in one learning session, the user is forced to experience a very long learning cycle in which the item to be learned is presented many, many times. This leads to boredom and non-attentiveness of the user. It is not realistic to expect that the user can go from a memory indicator level of 0 (inability to recall) to a level of automaticity for any particular item. Reaching automaticity may require a few days of regular study and cannot usually be achieved in a single learning session.

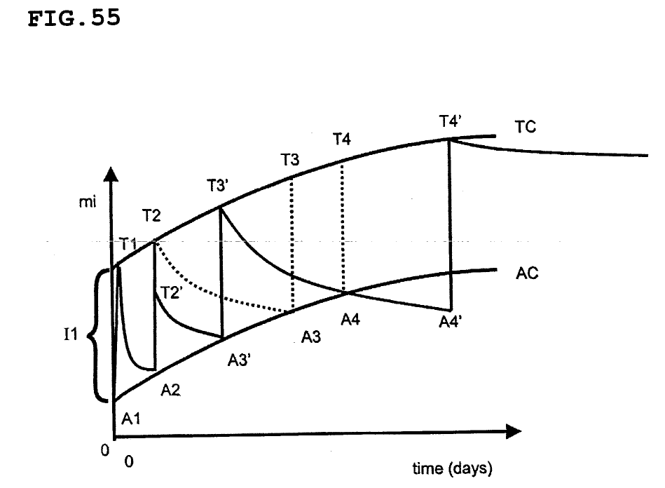

In order to solve this problem, the present preferred embodiment modifies the target level and the alert level so that they do not start from a maximum level but change over time according to a learning curve rather than progressing along a straight line that is parallel to the X-axis of the graph of memory performance over time (See FIG. 55). So in the present preferred embodiment, the first target point for any item may be below the goal level of learning, which may be a level of recognition, recall, or automaticity as described above, but the first target point is selected such that the user must recall correctly at least once. This reduces the time of the short learning phase, reduces the number of times the user sees an item in one learning session and eliminates the problems of boredom and inattentiveness.

As seen in FIG. 55, the lines for the alert level 530 and the target level 532 are graphically illustrated by curves AC and TC, respectively.

Thus, the alert level 530 and the target level 532 preferably do not follow straight lines but are preferably substantially parallel curves that progressively move the memory performance of the user for each item from a level of recognition to recall to automaticity. The alert level 530 preferably starts at a small value A1 (greater than zero so that learning can start). Indeed, before any learning takes place, the memory indicator is determined to be 0, thus any alert level greater than 0 will lead to starting presenting the item. When the item is introduced, the target level 532 is preferably set at T1 to be above the alert level and spaced from the first alert point A1 by an amount of increase in memory performance I1. It is preferred that the shape of the curves for determining the alert level 530 and the target level 532 as seen in FIG. 55 are determined based on one or more of the following factors:

1. The performance expected at the end of the course, such as probability of recognition or probability of recall, which is referred to as the goal.

2. The difficulty of learning, which is preferably determined based on the time needed to increase the memory indicator from 0 to the minimum target value, or other suitable methods.

3. The time given to reach the goal which is referred to as the study period.

Note that because each of the three conditions described above can vary, target level 532 and the alert level 530 are different for each item and for each individual.

As noted above, the first target level 532 T1 is preferably set well below the level of automaticity and such that the user will not become bored or frustrated because of too many presentations of that particular item during the first learning session. Once the memory performance as determined by the memory indicator for a particular item reaches the target level 532, such as T1, the short-term learning loop 510 stops. Then the long-term forgetting process of forgetting loop 520 occurs and the memory performance for that item decays over time. However, since the alert level 530 and target level 532 are gradually increasing curves, and because the initial target level was not set at the automaticity level, the decay progresses such that the memory performance falls below the next alert level A2 fairly quickly and a review is quickly scheduled. During the review process, the item is presented by the learning engine 500 enough times to the user so that the memory performance increases to the next target point T2 along the target level curve. This process continues so that the performance of the user for every item is maintained above the alert level 530. Eventually, permastore is reached for each item.

It should be noted that the distance between the alert curve AC and the target curve TC in FIG. 55 can be changed based on the time that the user has to use the learning engine 500 or based on what is best for long-term retention. Note that if the curves AC and TC are close together there are many more reviews than if the curves AC and TC are spaced father apart. However, when the curves AC and TC are close together, the time per review and the required increase in memory indicator per review is much less than when the curves AC and TC are spaced further apart.

As can be seen in FIG. 54, the learning loop 510 begins when a memory indicator for an item is below the alert level 530 and stops when the memory indicator for that item is above the target level 532. The forgetting loop 520 begins when active short-term phase of learning stops, or when the memory indicator for that item is above the target level 532, and stops when the memory indicator for that item is below the alert level 530.

Thus, with the learning model and related processes shown in FIG. 54, the present preferred embodiment determines memory performance during all phases of learning including the active short-term learning phase and the passive long-term forgetting phase. As a result, the value of a memory indicator is known at all times, which enables optimal scheduling of presentation and reviewing of items by the user 502, as described in more detail below.

In a learning engine or process such as those described in preferred embodiments above, it is desirable to schedule enough reviews to enable to user to perform fast active recall at the end of the schedule for all items. However, it is also desirable that the user does not waste his time and that the learning engine or process does not schedule too many reviews because extra presentations of an item often produce only negligible increases in memory performance and may cause decreased efficiency of learning.

To solve these problems, items scheduled for review are presented using the novel learning model shown in FIG. 54. More specifically, as seen in FIG. 54, the target level 532 and the alert level 530 are input to the learning engine 500. When the memory performance of an item is predicted to be below the alert level 530, the learning begins in the form of a review of that item. The learning engine 500 repetitively presents the item to be learned to the user 502. The memory indicator of the item is measured during the learning 510 and the determined memory indicator is continuously compared to the target level 532. When the measured memory indicator is greater than the target level 532, the learning engine 500 stops the learning process performed in the learning loop 510 and stops the review for that item. Then the learning process enters the forgetting loop 520 during which the memory indicator for each item is predicted using a function described below. The predicted memory indicator determined during the passive long-term phase of learning is compared to the alert level and once the predicted memory indicator falls below the alert level 530, the learn engine 500 enters into the learning loop 510 and begins to present the item to the user 502 again for review and to increase the memory indicator of that item to a level at or above the target level 532. Thus, by using this learning model to schedule items for presentation to the user 502, the learning engine 500 is able to optimally schedule items for presentation to the user based on values of memory indicator that are determined during all phases of learning. This results in an optimum number of reviews for each item so that the forgetting rate or decline of human memory for that item becomes slower and slower due to the increase in the user's knowledge of that item. Thus, future reviews are spaced out over time based on an expanded rehearsal series to achieve maximum ability to recall an item without being presented with an item too many times. This is shown in more detail in FIG. 55.

Using the learning model shown in FIG. 54 to schedule presentation of items to users, changes in a user's learning schedule with the learning engine 500 are compensated for automatically, which is referred to as automatic graceful degradation. That is, the user can stop and start the learning process at any time and the learning performance will not be overly degraded as seen in FIG. 55. The dotted lines in FIG. 55 shows a situation in which the user 502 uses the learning engine 500 for enough time that each of the target level 532 and alert level 530 are met and the schedule of presentation of each item occurs as planned. However, as is well known, a user will not always be able to use the learning engine 500 for enough time or in the right manner to achieve the target level 532 and alert level 530 set by the learning engine 500.

However, unlike previous learning methods or learning engines, the present preferred embodiment easily handles this problem and prevents any negative effects from the user diverging from the schedule set by the learning engine 500. This advantage achieved by the present preferred embodiment is the automatic graceful degradation described above and as is shown graphically in FIG. 55.

As seen in FIG. 55, the user stops learning at a point T2′ that is below the scheduled target level T2. Thus, the user has stopped learning early and has not achieved a memory indicator level that is equal to or above the target level T2. This will result in the user's actual memory for that item reaching the alert level 530 faster than if the user had used the learning engine 500 long enough to achieve the target level T2.

Because the learning model shown in FIG. 54 actively measures the target level 532 achieved during the active short-term phase of learning, the learning engine 500 will schedule the next review for that item not based on the scheduled target level T2 but based on the actual measured target level T2′ (real memory indicator 504) achieved by the user. That is, the learning engine 500 will determine that the next review should occur earlier at alert level A3′ instead of at the planned alert level A3. The user then reviews that item based on the new alert level A3′ until the new target level T3′ is reached.

Next, a situation in which the user 502 does not use the learning engine 500 until a time after the next scheduled alert level A4 occurs. That is, the user 502 uses the learning engine 500 late and thus, the memory indicator has dropped below the alert level A4 to a new alert level A4′. The learning engine 500 presents this item for review to the user 502 and determines a new target level T4′ to be achieved during this review session, instead of the previously scheduled target level T4. In this manner, the learning engine 500, using the novel learning model shown in FIG. 54, automatically gracefully degrades or compensates for any change in scheduled usage of the learning engine 500 by the user 502.

This can explained in that, since the review process of an item starts whenever a memory indicator value is below the alert level 530 for that item, there is no problem with a user 502 starting to use the learning engine 500 later than scheduled. In this case however, the review will last longer than that the one scheduled since the memory strength in the brain of the user 502 for that item has had more time to decay. Similarly, since the review process of an item stops whenever a real memory indicator 504 is above a target level 532 for that item, there is no problem with a user stopping the learning or reviewing process at any time. However, if a user does stop before the memory indicator 504 for that item reaches the target level 532, that item will then be scheduled for review earlier than should have been the case if the value of the memory indicator for that item reached its target level 532 during the scheduled learning session.

In addition to achieving graceful degradation, the present preferred embodiment also achieves accurate error minimization through adaptation of the model for estimating memory strength.

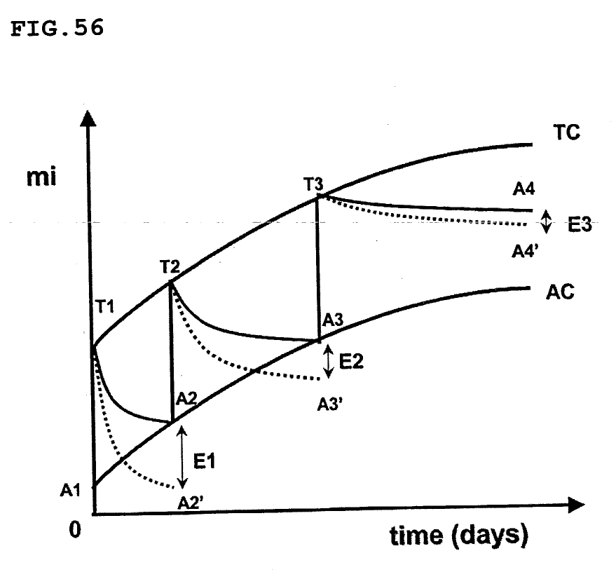

In one example shown in FIG. 56, the user model 540 shown in FIG. 54 has a slower predicted decay rate (shown by dotted lines) than the actual decay rate (shown by solid lines) of the user's brain, so there is an error between the modeled decay rate and actual brain's decay rate. These errors are shown by E1, E2 and E3 in FIG. 56. At the beginning of the learning process in the learning loop 510, the error between the predicted and actual decay rate is used to tune the model of human learning. That is, the real memory indicator 504 is compared to the predicted memory indicator 542 at 562 to tune the user model 540. In order to tune the user model 540 of the brain's forgetting, the variables of the power function used to model human learning are changed to achieve a much more precise modeling of memory performance of the brain for each item.

Such adaptation is preferably performed with the well-known Newton method, but can be performed with other well-known adaptation methods such as the gradient descent method.

New variables (A′ and b′) of the forgetting power function are determined so that the next decay error is smaller. This is seen in FIG. 56 where the error E1 is much larger than error E2 and the error E2 is much larger than the error E3. The error correction loop 560 is continuously performed so that the user model 540 used to determine the predicted memory indicator 542 is continuously tuned in this manner to achieve a smaller and smaller error, so that the model 540 eventually converges to the actual brain's performance.

It should be noted that the modeled decay rate is different for each item and for each person, and the learning engine 500 performs tuning for each item and for each person to achieve optimal learning for each person and for each item.

As described above, many of the prior art learning methods and systems failed to adequately adapt the items to be learned, i.e. knowledge and skills, to the particular steps of the learning method or learning engine.

According to another aspect of preferred embodiments of the present invention, items are presented to a user adaptively based on a unique selection and presentation process to eliminate minimum and maximum peaks of item presentations to achieve workload smoothing and optimum learning efficiency and effectiveness.

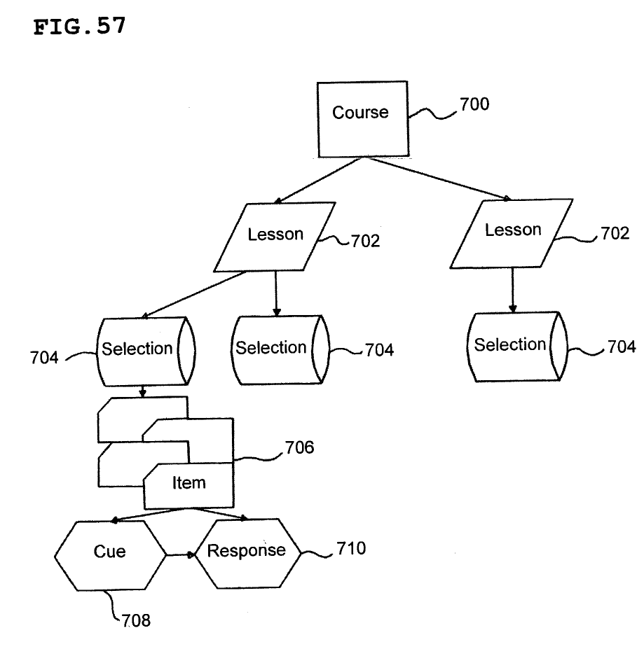

As seen in FIG. 57, the unique method for determining which items to present to a user preferably includes the steps of grouping items in a course 700 into lessons 702 based on at least one of common semantical properties, likelihood of confusion and other suitable factors, dividing lessons into selections 704 that include a smaller subset of items 706 from a lesson 702, determining an appropriate session pool size of items to be presented to a user, selecting a size of a session pool that is defined as a maximum number of items to be presented to a user during a single study session, determining an urgency of presentation of each item based on a current memory indicator, and selecting the items for the session pool based on the determined urgency of each item. The items 706 are preferably presented to the user 502 by the learning engine 500 in the form of a cue 708 and response 710, not necessarily in that order though.

As noted above, items 706 from a lesson 702 compete with each other to be grouped in a session pool and compete with each other to be the next item 706 presented to the user 502. This competition between items 706 is based on the urgency of the items in a lesson 702 for being grouped into a session pool.

This method of determining how to present items to a user is intended to solve a problem inherent in such learning methods. That is, if a given number of items has to be learned by a given date, then the time spent studying cannot be constrained. Indeed, whatever the speed of learning of the user 502, all items have to be introduced before the end date, or more specifically, a short while before the end date so that the last item can be properly reviewed. Introducing new material and reviewing previously introduced material can be performed by separate algorithms. Consequently, the long-term scheduling process can be subdivided into the scheduling of the review material and the introduction of new material. The reviewing process ensures a given item is properly reviewed while the introduction process ensures all items are introduced and mastered before the end date.

As described with respect to preferred embodiments above, the learning engine 500 computes an appropriate initial schedule based on all of the lessons that user is to be presented with during a certain time period (days, weeks, months, etc.). This initial schedule of presentation of items and lessons is stored in the learning engine database and may be modified later on depending on preferably the user's performance or alternatively the user's desire.

Note that on a course basis, the user should work until all items are learned to the desired level of memory performance. The time spent by the user would not be controlled but performance is guaranteed if the user works as much as scheduled by the learning engine 500.

In order to solve the problems described above, the present preferred embodiment includes a method of scheduling of new and reviewed items for presentation to a user that includes three levels of scheduling:

Long-term scheduling of items which were never studied before (new items)

Long-term scheduling of items which were studied before (review items)

Short-term scheduling of items (same for new and review items)

For new items to be presented to a user, the set of items, usually grouped in the form of a course 700, is divided into lessons 702, as seen in FIG. 57. Items 706 from the same lesson 702 preferably share semantical properties and are likely to be confusable. It is desirable to present these similar and confusable items together.

Since the number of items 706 contained in a lesson 702 can be large, lessons 702 are subdivided in selections 704 shown in FIG. 57. Selections 704 are a small subset of items 706 that can be introduced together to a user within a reasonable time or study session. If a lesson 702 was not subdivided in selections 704, introducing a new lesson 702 would be likely to take a lot of time for the user, especially when the lesson 702 features numerous items 706, and may cause the user to become bored or frustrated. The selection level has no semantical significance and is designed to obey constraints on the number of new items that are to be presented, that the present preferred embodiment of the method must accommodate.

The selection level is introduced to control the introduction of new material so new items are introduced to the user in small groups. A selection is a group of items that will be introduced together. However, once they are introduced, each item follows its own review schedule and will compete with all other items to enter a session pool and be presented. A selection is never presented to the user per se. At a given time, items from a given selection start to compete with others items to be presented.

The introduction of new items to be learned is distributed over the course period. Once items are introduced to a user, they will be subsequently reviewed according to the review material algorithms, as described above. Thus as time goes by, as more and more new items are introduced, the number of reviews increases.

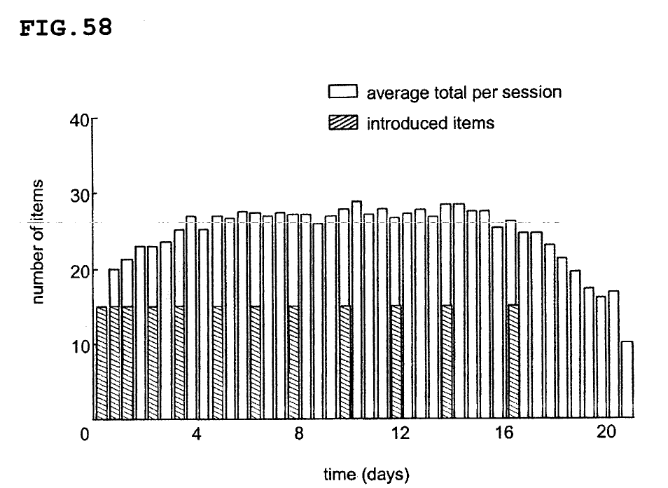

In order to have a total number of items (both new items and reviewed items) about constant everyday along the entire schedule, it is desirable that new material be introduced to a greater degree at the beginning of the course or schedule and then less and less as introduced items are reviewed. Thus, the time difference between two selections of new items should increase with time and this time difference can be a function of a single parameter. FIG. 58 shows that such a non-uniform introduction of new items creates an example of a smooth workload.

However, the ideal schedule of new item introduction shown in FIG. 58 is not often achieved in practice. Often users do not use the learning engine 500 for a day or more, or do not finish the study and review processes for all of the items they have to review on a given day, or conversely want to see more items than was scheduled. Thus, it is desirable to change the dates of the introduction of new material based on the user's actual use of the method and learning engine 500.

Consequently, the learning method and learning engine 500 monitors the user's ability to perform the work scheduled. If the user is willing to work more than what the method scheduled, the introduction rate of new items is increased. In this case, new items are brought forward in the graph of FIG. 58, since they are presented earlier than their scheduled presentation date. In the same manner, when the learner cannot complete the study or review of all items scheduled for study and review on a given day, the learning engine 500 delays the introduction of new material by decreasing the speed of introduction of new items.

With respect to the presentation of items to be reviewed, the learning engine 500 identifies items to be reviewed as items for which the memory indicator is believed to be lower than the alert level 530. Since it is desirable that items from the same lesson are reviewed together, items to be reviewed are grouped in session pools. Two items from different lessons cannot belong to the same session pool. However, new items to be presented for the first time and items to be reviewed can be grouped in the same session pool.

It is preferable that the size of each session pool be limited to provide a reasonable learning experience in terms of time. The number of items in a session pool has to be higher than a minimum threshold and lower than a maximum threshold determined as follows:

Minimum: if there are not enough items to provide a meaningful learning experience, the session pool may not be created or alternatively some items above alert may be added to it so that its size is relevant. Extra items are chosen among items from the same lesson which memory indicator, though above their respective alert level, is low.

Maximum: if there are too many items in the session pool, the studying experience is likely to be long and tiring. In this case, the session pool is split into smaller sessions pool of meaningful size.

Thus, from all of the items 706 to be presented in various session pools, the learning engine 500 must determine which of the session pools to present to the user 502 first. Once a session pool has been determined to be presented to the user, the learning engine 500 must determine in what order to present to the user the items 706 from the chosen session pool.

As described above, the learning engine 500 performs short-term scheduling of presentation of items 706 from a session pool during a learning session to determine the optimal manner in which to present items to the user during that session. Yet, the user may have several session pools to study during a study session. These session pools will be studied sequentially. In order to increase the efficiency of the learning method and maximize the effectiveness of the user's study time, the most important sessions pools are studied according to a determine a hierarchy or order of importance.

The importance of a session pool is preferably determined based on a sum of the urgency measure for all items belonging to a single session pool. For each item, the urgency is defined as the distance between the current memory indicator 504 and the alert level 530:

urgency=max (0; alert−memory indicator)

For each session pool, the urgency of each item is calculated and summed. Then, the total urgency of each session pool is comparatively ordered and the session pool having the highest total urgency is chosen as the session pool to be presented to the user 502.

There are of course other possible methods of determining urgency or determining the importance of the sessions.

Once the particular session to be presented has been identified by the learning engine 500, the order of presentation of items in the session pool, referred to as a session loop, must be determined. This is preferably done via a unique multiple filtering process described below that achieves an optimal presentation of items taking advantage of an ideal intra-trial spacing effect. The three important properties of each item that effect the unique filtering process and ultimately the intra-trial spacing effect include the memory indicator, a number K of correct answers in a row, and the number of times an item was presented during a session.

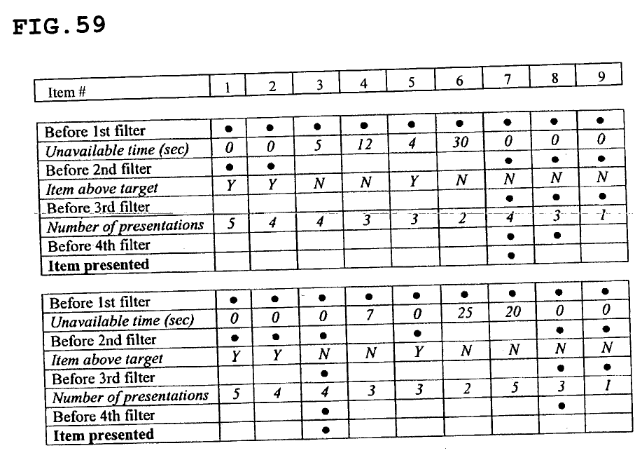

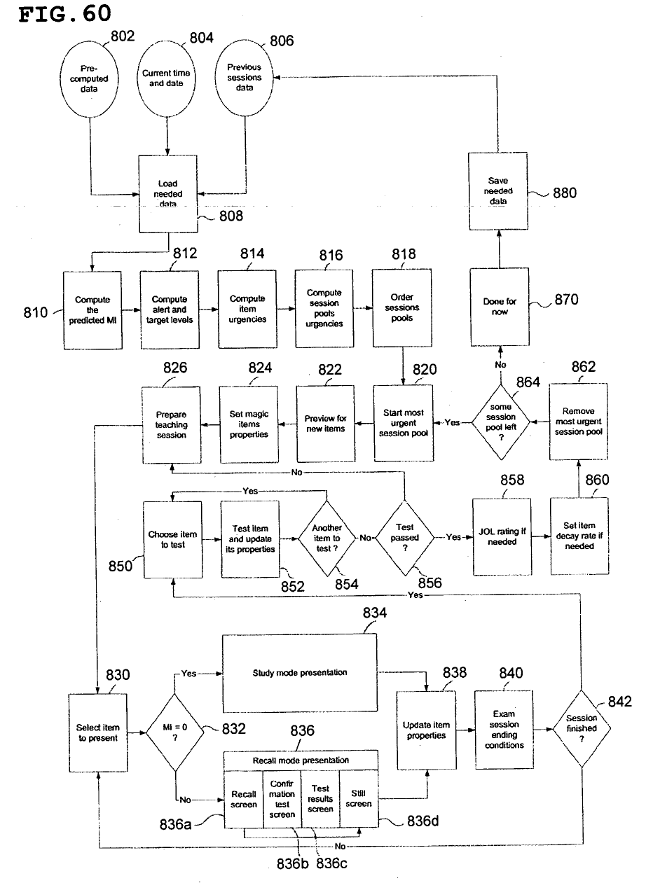

The algorithm in the learning engine 500 that controls the session loop presentation selects the best item to present from the session pool after each item presentation. This choice is performed using a multiple filtering process, an example of which is shown in FIG. 59. The filtering process follows the 4 following principles (by order of importance):

1. Once an item is presented, it should not be presented again for some time. The duration for which an item cannot be presented depends on the difficulty of the item and on the performance the learner produced at recalling this item.

Thus, a first filtering step is applied to all of the items in a session pool in which, after an item has been presented, the item is blocked or prevented from being presented again for a certain period of time that depends on K, the item difficulty (learning slope), pre-set parameters such as the minimum desired blocked time (e.g. 20 seconds) that an item should remain unavailable for presentation to the user, or number of items below target. The period of time should be at least some minimum period of time, for example, 20 seconds, and is based on a geometric progression of K. As is indicated by the presence of dots the first line of FIG. 59, all items are present in the session pool before application of the first filter. The time for which an item is not available for presentation by the learning engine 500 is indicated as “unavailable time” in FIG. 59. As a result of the first filtering process performed by the learning engine, items 3, 4, 5, and 6 are eliminated from contention for presentation.

Thus, the effect of the first filtering process is to make sure that the user does not recall the item from short-term memory or at times when the item is so easily accessible that its retrieval brings no benefit to long-term memory. In addition, the first filtering process makes sure that a user is not presented with the same item too often to prevent boredom and unattended presentations of items.

2. Once an item memory indicator exceeds its target level, it should be only exceptionally presented.

During this second filtering process, all items that have reached their respective target levels are removed from the pool of items so that these items cannot be presented again unless in an exceptional case when more items (filler items) are needed for a later presentation of another item or are needed to wait until another item can go through the first filter. Thus, as seen in FIG. 59, the second filtering process determines whether the real memory indicator 504 for each item is above the target level 532. As a result of the second filtering process, items 1 and 2 are removed from contention for presentation.

3. When numerous items are valid for presentation, items that were presented the most should be preferably chosen.

To avoid flooding users with too many items, the learning engine 500 presents items that have been presented the most frequently. This means that the learning engine selects those items that have a memory indicator that is closest to the target level so as to present items to the user that will reach the target level the fastest. As seen in FIG. 59, as a result of the third filtering step, item 9 is eliminated, leaving only items 7 and 8 available for presentation.

4. The next item to be presented should be unpredictable.

The fourth filtering process is done to increase attention of the users to the items being presented and to remove the serial position effect.

Out of items that are left, i.e. items 7 and 8, the learning engine 500 randomly selects one of the remaining items to make sure the item that is presented to the user is not expected by the user. Thus, the learning engine 500 chooses item 7 for presentation based on a random selection process. Thus, after all four filtering steps are performed, item 7 is presented to the user.

Once item 7 has been presented to the user by the learning engine 500, the learning engine sets an unavailable time for item 7, and then repeats the filtering process including the four filter steps described above.

In this case, item 7, as well as items 4 and 6, are unavailable for presentation. Also, it should be noted that item 3 that was blocked from being presented during the first multiple-filtering process became available for the second iteration of the multiple filtering process. That is, item 3 became available for presentation while item 7 was being presented to the user.

In the next operation of the first filtering step, items 4, 6 and 7 are eliminated. Next, since items 1, 2, and 5 have a real memory indicator 504 above the target level 532, these items are removed from contention for presentation. Also, since items 3 and 8 have been presented the most times, these items are selected for the final filtering step, in which item 3 is randomly chosen from among items 3 and 8.

The filtering process described above preferably continues until all items in a session pool have been sufficiently presented to the user 502 by the learning engine.

That is, the filtering process continues until all of the following conditions are met: (1) the memory indicator for all items in the session pool are above the corresponding alert level; (2) progress achieved as measured by a sum of relative increase in the value of memory performance compared to the item target level for all items; and (3) a difficulty measure based on the time required to increase the memory indicator for each item to the target level was achieved for all items in the session pool.

The condition (1) expresses the fact that an item should not be scheduled for review after being reviewed. The learning engine 500 needs to ensure that after a review process, all items are at least above their respective alert level so as to reliably ensure that their memory indicator is higher than their alert level. The condition (2) ensures that most items are above their target level at the end of the review. It is possible that it is not desirable that all the items are above their respective target level because it may be time consuming for the last item to increase the value of the memory indicator to the target level. The condition (3) counterbalances the condition (2) to ensure that the measure of the item difficulty is the same for all items. Indeed, condition (2) could bias the item difficulty benchmark since the last item would not reach its target and might be evaluated as being easier than it is.

As soon as these 3 conditions are met, studying stops for this particular session pool. Note the method is a mastery learning way of teaching, which means that performance controls time spent studying. On a session pool basis, the user will work until the desired performance is reached during the study process.

Once the three conditions are met, the user is then invited to pass an end-session test. Only when the user can achieve a perfect score on the end-session test, will the user be allowed to proceed to the next session pool. If the end-session test is not passed, the user goes back to the session loop step to re-study items from the session pool.

Note that to confirm that items rated as magic were actually known by the user, the magic items are also tested in the end-session test. Any magic item failed on the end-session test loses its magic properties and is treated as a regular item. In particular, it will be re-studied after the end-session test.

In order to be able to predict the decay of performance for items that have just been introduced, a Judgment of Learning rating is requested from the user after the end-session test if the end-session test was passed. The JOL rating is delayed until the user passes the end-session test.

The user is prompted to rate the difficulty to remember items which where introduced during this particular session. The result of the rating is used to initialize the predictive model for determining memory performance during the passive long-term phase of learning, as described above.

By presenting the items several times within a short period of time during a session loop as described above, each item becomes strongly activated, which is believed to yield to an increase in long-term memory. To produce an intra-trial spacing effect, the duration for which an item cannot be presented twice increases when the user is able to actively recall an item and decreases when the user does not active recall an item. This increase follows a geometric progression. The speed of the increase depends on the item difficulty. Thus, according to the first filtering process, an item is preferably not supposed to be presented twice in less than a certain period of time, e.g. 20 seconds, because any recall achieved before 20 seconds after the last presentation is likely to be a recall based on short-term memory and is therefore not expected to lead to the desirable increase of long-term memory.

When there is no item that matches principles 1 and 2 of the multiple filtering process for selecting items to present to a user, an item that is above its target level is chosen from the session pool and presented until an item having a memory indicator that is below its target level is ready to be presented. When there is no filler item available, the presentation of an item having a memory indicator that is below its target level may be presented out of sequence.

The selection filtering process does not allow magic items to be chosen as a filler item. Thus, when the session pool consists only of magic items and items that cannot be presented because of principle 1, the algorithm chooses the item that has a memory indicator that is below its target level, which will be the first one to be presented. Thus, magic items never appear in the session loop, which is logical since the user identified the magic item as being already known. The magic items are presented in the end-session test to ensure that the user actually knows the magic item.

When new items are introduced to the user by the learning engine 500, a preview process is preferably performed. During the preview process, items that have never been presented to the user are previewed. During the preview, the user is invited by the learning engine 500 to rate items that the users believe they know. Items designated by a user as already known are determined to be “magic” items and are assigned a memory indicator that is equal to their respective target level on any review they will go through so that they are not studied (because of the multiple-filtering process). Magic items are assigned a very slow decay rate and are not rated in a JOL test.

As noted above, it is preferable that the presentation of items to the user can occur in two modes including a study presentation when the user is unlikely to recall an item (when memory indicator is 0) and a recall presentation when the user is likely to recall (when memory indicator is greater than 0).

It is preferable that in the item presentation mode, additional information is presented, including but not limited to audio hints and contexualization that includes information related to the item to be learned. This additional information will assist the user in increasing the memory strength for an item so that the user will be able to actively recall the item in the future.

The study presentation is preferably presented to the user for as long as the user desires and until the user indicates that the item has been learned and the user is able to actively recall the item.

Once the user indicates an ability to recall the item, the memory indicator is higher than a value of 0 and the user is provided with a recall presentation in which the cue for an item is shown and the user must indicate an ability to actively recall the response to the cue within a certain time period. If the user is not able to indicate an ability to recall the proper response for the cue, the user is able to study the item for an additional period of time until the user indicates an ability to actively recall the item.

In order to determine whether the user was actually able to recall an item, a confirmation test is preferably presented to the user to confirm that the user was in fact able to actively recall the item within the time provided. This confirmation test may be a multiple choice test, a jumble test or any other suitable test.

In a jumble test, a cue or response is divided into component parts and the component parts are presented to the user as a multiple choice test in which the user must assemble the component parts into the correct corresponding response or cue. The degree of difficulty of the jumble test may be increased by changing the number of component parts of a cue or response and also presenting distracters that are made to look like the component parts.

These tests may be alternated to maintain the attention of the user and to prevent the user from becoming bored. In addition, it is preferable to adapt the difficulty of the tests to the user's performance and present harder and harder tests based on the user's past performance. Also, it is preferable to adapt the difficulty of each test for each item. The degree of difficulty of a test may be increased by changing the number of possible responses in a multiple choice test, including many interfering or distracting answers in a multiple choice test, including a “none of the above” response in the test, or other suitable ways of increasing the test difficulty.

It is also preferable that the jumble test be used to confirm a reverse recall in which the response to a cue is confirmed and the recognition test is used to confirm a direct recall in which the cue to a response is confirmed.

Once the user has indicated an ability to actively recall an item within a certain time period, the next item to be learned is presented to the user, and the process described above is repeated.

If a mistake is made and an incorrect answer is selected by a user during a confirmation test, that incorrect answer will preferably always be presented as a distracter on future tests. If a user fails a test of an item only a small number of times, e.g. once, then the next item to be presented is the incorrect item that was selected by the user as an answer. However, if the user has been confusing two items many times, e.g. twice or more times, the learning engine 500 presents to the user a particular screen presenting the pair of confusing items using a discriminator or blink comparator as described with respect to preferred embodiments above.

In order to provide adequate feedback in the form of performance data and to determine the presentation of appropriate motivational and reward messages, the method described above preferably includes the step of recording a user's performance data and periodically providing performance reports and various motivational messages to the user. In addition, performance reports and data may also be provided to the user periodically or in response to the demand of the user.

FIG. 60 is a flowchart showing a step-by-step process of operation of the learning method and learning engine 500 according to a preferred embodiment of the present invention.

At a first level, information such as pre-computed data 802, current time and date 804 and previous session data 806, from a database of the learning engine 500 is retrieved. The pre-computed data 802 is data that is created at the beginning of the course and that the user uses the learning engine 500 such as the number items, duration of course, schedule for new items such as data concerning the initial schedule of presentation of the items determined by the learning engine 500, etc. In other words, the data 802 and 806 is any and all data that the learning engine 500 needs or the user has input relating to the use of the learning engine 500. Current time data 804 is needed for scheduling and memory indicator prediction, among other things. The previous sessions data 806 is any data relating to user progress and item properties that has been saved based on past usage of the engine 500 by the user.

The learning engine 500 obtains the data 802, 804, 806 from the database at 808 in level 2. Engine determines what data is needed and loads the data from the database.

At level 3, in a first step 810, the predicted memory indicator is computed for all items in a course for determining which items to present and how to present them, as described above. Then, the learning engine 500 determines the alert level 530 and target level 532 of each item at step 812. Then, the urgency of each of the items is computed at step 814. That is, the urgencies for all items in each lesson are computed at 814, and the items from each lesson are sorted based on the urgency in order to create and order session pool(s) within each lesson based on urgency. This is done at step 816 and is performed based on the principle that the minimum number of items in a session pool should be greater than X and less than Y to avoid frustration and boredom. So one way to do this at step 816 is to recursively analyze the number of items to be reviewed that do not belong to a session pool (designated as N hereinafter) and build session pools until all items belong to one session pool. To do that, the method compares N to 2Y. If N>2Y, a session pool of size Y comprising the most urgent items is created. Otherwise, if N>Y a, a session pool having a size N/2 comprising the most urgent items is created. Otherwise, a session pool of size N is created with all remaining items. The previous algorithm is applied until all items to be reviewed belong to one session pool. Then in step 818, the session pools are ordered by computing overall urgency for each session pool by taking sum of urgencies for all items in a session pool, and then sorting the session pools and ordering them based on the highest total urgency to least total urgency.

Then, in level 4, step 820, the learning engine 500 starts with most urgent session pool based on sorting done in level 3 at step 818.

Next, at step 822, the user is presented with a preview of the new items to be studied. This allows user to see what items will be presented and to determine and indicate any item that the user believes is already known. These items indicated as being already known to the user will be designated as “magic” items and the properties of the magic items will be set at 824. As noted above, a magic item is not presented during study or review because a user has indicated that this item is already known. However, the user is tested on magic items in order to make sure user knows this item.

Next, a teaching session is prepared at step 826 and the process moves to level 6.

At level 6, an item is selected from the session pool at step 830, which is done using the multiple filtering process for item selection described above. Next, the learning engine 500 determines whether the memory indicator for the selected item is 0, at step 832. This would indicate that the system assumes that the user is not able to recall that item.

If the memory indicator is 0, the user is presented with a new item in the study mode presentation at step 834 until the user believes he knows the item and then the user indicates to the learning engine 500 that he knows the item and wants to stop studying that item.

If the memory indicator is greater than 0, a recall mode presentation 836 in which a recall screen 836a is presented to the user requiring the user to actively recall an item. If the user cannot actively recall the item, a still screen is presented at 836d, described below. If the user is able to actively recall the item, the user indicates to the learning engine 500 that he can actively recall. Then the user is given a confirmation test at 836b and the test results are shown to the user at 836c. A still screen including the cue and response for the item just tested is presented to the user at step 836d.

Then, at step 838, the learning engine 500 updates the item properties such as the memory indicator depending on latency and result of test, unavailable time or time that item cannot presented which depends on pattern of success and failure (# of times in a row correct answer provided), the number of times item was presented since beginning of session, etc.

Then, the learning engine checks to determine if the end session conditions are satisfied at step 840. That is, it is determined whether all items are above the target level, a predetermined progress threshold compared to target has been achieved and the difficulty has been measured for each item. If one or more of the three conditions is not met, another item is selected at 830 and the process described above in steps 832-842 continues until all three conditions are met.

If it is determined at step 840 that the session is finished, the learning engine 500 chooses an item to test at step 850. The user is then presented with a test at 852 and the item properties are updated, and the learning engine 500 determines whether an additional item is to be tested at 854. If so, another item is chosen at step 850 and a test for that item is presented to the user until all items have been tested. Then it is determined at step 856 whether the test was passed. If the test was failed (that is at least one item failed) subsequent learning takes place at 826. Otherwise, a judgment of learning is requested from the user at step 858, if needed. Next, the item decay rate is set at 860 if this is necessary.

After that, the most urgent session pool is eliminated or removed at step 862 and the learning engine 500 determines whether any other session pools are scheduled to be presented to the user at step 864. If so, the process goes back to step 820 to determine which item in the next session pool to present to the user. If not, the process is completed at step 870 and all relevant data is saved at step 880 in the database of the learning engine 500.

Numerous additional modifications and variations of the present invention are possible in light of the above teachings. As noted above, the information to be learned, reviewed and tested and the platforms for learning, reviewing and testing items is not limited in any sense and can be modified as desired. Also, various modules of the various preferred embodiments described above can be combined in different combinations to define systems as desired. Further, the various modules can operate independently of each other or can be interactive and adaptive to each other. Many other modifications, combinations and changes may be made to the present invention without departing from the scope of the present invention. It is therefore to be understood that within the scope of the appended claims, the present invention may be practiced other than as specifically described herein.

What is claimed is:

1. A method of learning comprising the steps of:
(a) presenting information to be learned so that the information to be learned becomes learned information;
(b) presenting the learned information for review in a way that is different from the way in which information is presented during learning whether the learned information has actually been learned;
(c) presenting information for testing whether the learned information has actually been learned;
(d) stopping the presenting of information to the user once the learned information has been determined to be actually learned;
(e) determining a predicted memory performance for the learned information during a period in which the learned information is not presented to the user;
(f) comparing the predicted memory performance to a desired memory performance; and
(d) repeating step (b) for the learned information when the predicted memory performance for the learned information is equal to or less than the desired memory performance.

2. A method of learning comprising the steps of:
presenting an item to be learned to a user;
determining a value of a memory indicator for the item being presented to the user;
stopping the presenting of the item to the user after a certain value of the memory indicator has been reached;
determining a predicted value of the memory indicator during the period in which the item is not being presented to the user; and
determining when to present the item to the user again based on the predicted value of the memory indicator that was determined during the period in which the item is not being presented to the user.

3. The method according to claim 2, wherein the step of determining the memory indicator for the item being presented to the user includes measuring the user's memory performance with respect to the item.

4. The method according to claim 3, wherein the user's memory performance is based on at least one of a result on a recall test, latency values on the recall test, and a result on a confirmation test and other suitable measurements.

5. The method according to claims 1 and 2, wherein the memory indicator ranges from a value of 0 to 1.

6. The method according to claim 5, wherein the memory indicator is indicative of a probability of recall of the item to be learned.

7. The method according to claims 1 and 2, wherein the predicted memory indicator is determined using a power function that models the decline of human memory.

8. The method according to claims 1 and 2, further comprising the step of setting a target level of memory indicator and an alert level of memory indicator for the user for each item of information to be learned, wherein the alert level is the highest minimum value before items are presented to the user again and the target level is the lower maximum value after items are stopped from being presented to the user.

9. The method according to claim 7, wherein the target level and the alert level are changed over time.

10. The method according to claim 7, wherein the target level and the alert level are changed based on the memory performance of the user.

11. The method according to claims 1 and 2, further comprising the step of determining an actual memory indicator during the presenting of the items to be learned to the user.

12. The method according to claim 11, further comprising the step of comparing the predicted memory indicator and the determined actual memory indicator and changing a model used to determine the predicted memory indicator based on the difference between the predicted memory indicator and the determined actual memory indicator.

12. The method according to claim 7, wherein the step of presenting the item to be learned to the user begins when the memory indicator for the item is determined to be equal to or less than the alert level and the step of stopping the presenting of the item to the user begins when the memory indicator for that item is determined to be equal to or greater than the target level.

13. The method according to claims 1 and 2, wherein the predicted memory indicator is determined based on one of a power function, an exponential function, and a negatively accelerated function.

14. The method according to claim 7, further comprising the step of adapting the target level and the alert level to the user and to each item of information to be learned by the user.

15. The method according to claim 6, further comprising the step of requiring the user to make a judgment of learning and using the results of the judgment of learning to set an initial value of the power function that is based on the rate of decay of human memory.

16. The method according to claims 1 and 2, further comprising the steps of grouping items to be learned into lessons based on at least one of common semantical properties and likelihood of confusion.

17. The method according to claim 16, further comprising the step of dividing the lessons into selections that include a smaller subset of items from one of the lessons.

18. The method according to claim 17, further comprising the step of determining an appropriate session pool size of items to be presented to the user.

19. The method according to claim 18, further comprising the step of selecting a size of a session pool that is defined as a maximum number of items to be presented to the user during a single study session.

20. The method according to claim 19, further comprising the steps of determining an urgency of presentation of each item to be learned based on a current memory indicator.

21. The method according to claim 20, further comprising the step of setting a target level of memory indicator and an alert level of memory indicator for the user for each item of information to be learned, wherein the alert level is the highest minimum value before items are presented to the user again and the target level is the lower maximum value after items are stopped from being presented to the user, wherein the urgency of presentation an item is determined based on a difference between the current memory indicator and the alert level.

22. The method according to claim 20, further comprising the step of summing the urgency values for each of the session pools.

23. The method according to claim 20, further comprising the step of selecting the items for the session pool based on the determined urgency of each item.

24. The method according to claims 1 and 2, further comprising the step of presenting the user a preview of items that have not yet been presented and asking the user to indicate whether the user already knows each item or does not want to study an item.

25. The method according to claims 1 and 2, wherein the items to be learned are repeatedly presented to the user until an actual memory indicator for all of the items to be learned are above a predetermined memory indicator level, progress achieved as measured by a sum of increase in the value of memory indicator for all items is higher than a predetermined value, and a difficulty measure based on the time required to increase the memory indicator for each item to the predetermined memory indicator level was achieved for all of the items to be learned.

26. A learning system adapted to perform the method of claim 1.

27. A learning system adapted to perform the method of claim 2.

28. A learning apparatus adapted to perform the method of claim 1.

29. A learning apparatus adapted to perform the method of claim 2.
